(19) United States
(12) Patent Application Publication
(10) Pub. No.: US 2011/0280104 A1
(43) Pub. Date: Nov. 17, 2011

(54) Dual top drive systems and methods for wellbore operations

(76) Inventor: Guy L. McClung, III, Rockport, TX (US)

(21) Appl. No.: 12/932,500

(22) Filed: Feb. 25, 2011

Related U.S. Application Data
(60) Provisional application No. 61/339,525, filed on Mar. 5, 2010.

(51) Int. Cl. E21B 47/16; G06G 7/48; E21B 3/00

(52) U.S. Cl. 367/82; 175/170; 703/7

(57) ABSTRACT

Systems and methods for wellbore operations using a dual top drive system with two top drives.

### CROSS REFERENCE TO RELATED APPLICATION

This application claims priority from pending U.S. Application Ser. No. 61/339,525 filed Mar. 5, 2010.

### BACKGROUND OF THE INVENTION

1. Field of the Invention

The present invention is directed, in at least certain embodiments, to top drives and to wellbore operations methods involving top drives.

2. Description of Related Art

There are a wide variety of known top drives and known methods employing a top drive examples of which are found in the U.S. patents and applications cited herein—all of which are incorporated fully herein for all purposes. It is well known to use a top drive drilling unit to rotate the drill stem of an oil and gas well. See, for example, U.S. Pat. Nos. 4,449,596; 3,464,507; and 3,766,991 and U.S. application Ser. No. 050,537, filed Apr. 20, 1993. In many cases, a top drive drilling unit is suspended by a cable from the crown of a mast of a drilling rig above a drill string. The unit rotates the drill string from the top side as opposed to the use of a rotary table and related equipment at the rig floor. A top drive unit often has a track which runs the length of the mast to guide the top drive, to restrain it from lateral movement and to transfer reactive torque and torsional loads originating from the drilling operation into the derrick substructure. Typical torque drive track systems are disclosed in U.S. Pat. Nos. 4,865,135 5,251,709 and pending U.S. patent application Ser. No. 217,689, filed Mar. 24, 1994. In the process of drilling a well, it may be advantageous to disconnect the drill string from the top drive unit and handle sections of drill pipe without the top drive unit in place. In these instances, the top drive unit is disconnected from the draw works and moved away from immediately above the drill string. See, for example, U.S. Pat. Nos. 4,421,179; 4,437,524 and 4,458,768.

U.S. Pat. No. 4,437,524 discloses a well drilling apparatus designed to eliminate the need for a rotary table, kelly and kelly bushing, and includes a drilling unit which is shiftable between a drilling position in vertical alignment with a mousehole, and an inactive position.

U.S. Pat. No. 4,449,596 discloses a top drive well drilling system that includes pipe handling equipment that facilitates the making and breaking of connections to the drill string during the drilling cycle.

U.S. Pat. No. 4,458,768 discloses a top drive well drilling system having a drilling unit shiftable to various positions, wherein the shifting movement is accomplished by means of a structure that guides the unit for movement along predetermined paths.

U.S. Pat. No. 4,605,077 discloses a top drive drilling system having a motor which is connected to the upper end of the drill string and moves upwardly and downwardly therewith.

U.S. Pat. No. 4,625,796 discloses an apparatus comprising a stabbing guide and a back-up tool, wherein the apparatus can function in aligning an additional length of pipe with the upper end of the drill string and thereby facilitates the controlled stabbing of pipe length for addition into the top of a drill string.

U.S. Pat. No. 4,667,752 discloses a top head drive well drilling apparatus with a wrench assembly and a stabbing guide, wherein the wrench assembly is mounted on the drive unit and the stabbing guide is mounted on the wrench assembly.

U.S. Pat. No. 5,501,286 discloses and apparatus and method for displacing the lower end of a top drive torque track suspended from a derrick wherein a drive unit is disconnected from the drill string and suspended from the torque track. The top drive suspended from the torque track can then be moved away so as not to interfere with the addition or removal of drill string sections.

U.S. Pat. No. 5,755,296 discloses a portable top drive comprising a self-contained assembly of components necessary to quickly install and remove a torque guide and attendant top drive unit in a drilling rig mast.

### BRIEF SUMMARY OF THE INVENTION

The present invention, in certain aspects, discloses systems with dual top drives and wellbore operations methods which use dual top drives.

Accordingly, the present invention includes features and advantages which are believed to enable it to advance top drive technology. Characteristics and advantages of the present invention described above and additional features and benefits will be readily apparent to those skilled in the art upon consideration of the following detailed description of preferred embodiments and referring to the accompanying drawings.

What follows are some of, but not all, the objects of this invention. In addition to the specific objects stated below for at least certain preferred embodiments of the invention, there are other objects and purposes which will be readily apparent to one of skill in this art who has the benefit of this invention's teachings and disclosures. It is, therefore, an object of at least certain preferred embodiments of the present invention to provide:

New, useful unique, efficient, nonobvious methods for wellbore operations which use dual top drives;

New, useful unique, efficient, nonobvious top drive systems with dual top drives;

Such systems and methods in which two top drives, one above the other, move independently of one another with respect to a derrick;

Such systems and methods in which two top drives, one above the other, move in unison with respect to a derrick;

Such systems and methods in which two top drives, one above the other, each simultaneously rotate a tubular apparatus (e.g. a tubular member or a tubular string);

Such systems and methods in which two top drives, one above the other, alternately rotate a tubular apparatus (e.g. a tubular member or a tubular string);

Such systems and methods with two top drives, a first top drive above a second top drive, the first top drive for rotating a first tubular in a first direction and the second top drive for holding or for rotating a second tubular in a second direction opposite to the first direction, e.g. in joint make-up or in joint breakout operations;

Such systems and methods with two top drives, a first top drive above a second top drive, the two top drives movable with respect to each other during operation of both top drives;

Such systems and methods with two top drives, a first top drive above a second top drive, the first top drive on a first carriage movably connected to a derrick and the second top drive on a second carriage movably connected to the derrick; in one aspect, the first carriage on a first side of the derrick and the second carriage on the first side of the derrick; and in another aspect, the first carriage on a first side of the derrick and the second carriage on a second side of the derrick opposite the first side;

Such systems and methods with two top drives, a first top drive above a second top drive, one of or each of the top drives pivotably connected to the derrick for movement out of the way of the other top drive;

Such systems and methods in which two top drives, one above the other, are controlled by one control system or each top drive has its own dedicated control system;

Such methods for wellbore operations using two top drives including, but no limited to, drilling, casing operations, joint make-up, joint breakout, drilling with casing, casing while drilling, reaming, milling, manage pressure drilling, underbalanced drilling, tubular running, tubular running with continuous circulation, controlling bit face orientation during operations with a bit, conducting well operations based on mechanical specific energy considerations, and automatic drilling;

Such systems and methods with two top drives, one above the other, wherein rotation of a tubular member, of a tubular multiple, or of a tubular string is relatively more stable during rotation due to the use of the two top drives;

Such systems and methods with two top drives, one above the other, each on separate opposite supports, wherein during rotation of a tubular member, of a tubular multiple, or of a tubular string using two top drives results in the cancellation—in whole or in part—of torque reaction produced by each top drive by the torque reaction of the other top drive;

Such systems and methods with two top drives, one above the other, wherein the first top drive rotates a first tubular member during joint make-up and the second top drive holds or rotates a second tubular member to be made up with the first tubular member; and, in one aspect, one of the top drives making up the joint to shouldering of the joint, or to a point near shouldering, and the other top drive then making up the joint either to the point of shouldering and then past it or past shouldering (if the first top drive makes up the joint to shouldering);

Such systems and methods with two top drives, one above the other, with a control system and sensors so that—upon sensing a need for added torque in a rotation operation by one of the top drives—the other top drive is selectively activated to provide additional torque; and, in another aspect in which both top drives are operating, sensors indicate less torque is needed and one of the top drives is deactivated; and

Such systems and methods with two top drives, one above the other, wherein during rotation of a tubular member or members, of a tubular multiple, or of a tubular string the top drives are activated alternately so that torque is applied above, then below, then above, or vice-versa in a rotation operation, in joint make-up or in joint breakout; and, in one aspect, with the top drives relatively close together and, in another aspect, with the top drives spaced-apart a selected distance.

Certain embodiments of this invention are not limited to any particular individual feature disclosed here, but include combinations of them distinguished from the prior art in their structures, functions, and/or results achieved. Features of the invention have been broadly described so that the detailed descriptions that follow may be better understood, and in order that the contributions of this invention to the arts may be better appreciated. There are, of course, additional aspects of the invention described below and which may be included in the subject matter of the claims to this invention. Those skilled in the art who have the benefit of this invention, its teachings, and suggestions will appreciate that the conceptions of this disclosure may be used as a creative basis for designing other structures, methods and systems for carrying out and practicing the present invention. The claims of this invention are to be read to include any legally equivalent devices or methods which do not depart from the spirit and scope of the present invention.

The present invention recognizes and addresses the previously-mentioned problems and long-felt needs and provides a solution to those problems and a satisfactory meeting of those needs in its various possible embodiments and equivalents thereof. To one of skill in this art who has the benefits of this invention's realizations, teachings, disclosures, and suggestions, other purposes and advantages will be appreciated from the following description of certain preferred embodiments, given for the purpose of disclosure, when taken in conjunction with the accompanying drawings. The detail in these descriptions is not intended to thwart this patent's object to claim this invention no matter how others may later disguise it by variations in form, changes, or additions of further improvements.

The Abstract that is part hereof is to enable the U.S. Patent and Trademark Office and the public generally, and scientists, engineers, researchers, and practitioners in the art who are not familiar with patent terms or legal terms of phraseology to determine quickly from a cursory inspection or review the nature and general area of the disclosure of this invention. The Abstract is neither intended to define the invention, which is done by the claims, nor is it intended to be limiting of the scope of the invention in any way.

It will be understood that the various embodiments of the present invention may include one, some, or all of the disclosed, described, and/or enumerated improvements and/or technical advantages and/or elements in claims to this invention.

### BRIEF DESCRIPTION OF THE SEVERAL VIEWS OF THE DRAWING

A more particular description of embodiments of the invention briefly summarized above may be had by references to the embodiments which are shown in the drawings which form a part of this specification. These drawings illustrate embodiments preferred at the time of filing for this patent and are not to be used to improperly limit the scope of the invention which may have other equally effective or legally equivalent embodiments.

FIG. 1A is a front view of a system according to the present invention.

FIG. 1B is a front view of a system according to the present invention.

FIG. 1C is a side view of a system according to the present invention.

FIG. 2 is a side view of a system according to the present invention.

FIG. 3 is a side view of a system according to the present invention.

FIG. 3A is a side view of a system according to the present invention.

FIG. 4 is a side view of a system according to the present invention.

FIG. 5 is a schematic view of a system according to the present invention.

FIG. 6 is a side schematic view of a system according to the present invention.

FIG. 7 is a side schematic view of a system according to the present invention.

FIG. 8 is a side schematic view of a system according to the present invention.

FIG. 9 is a side schematic of the system according to the present invention.

FIG. 10 is a schematic view of a system according to the present invention.

FIG. 11 is a schematic view of a system according to the present invention.

FIG. 12 is a schematic view of a system according to the present invention.

FIG. 13 is a schematic view of a system according to the present invention.

FIG. 14 is a schematic view of a system according to the present invention.

FIG. 15 is a schematic view of a system according to the present invention.

FIG. 16 is a side view of use of a system according to the present invention with a person.

FIG. 17 is a side view of use of a system according to the present invention.

FIG. 18 is a side view of use of a system according to the present invention.

FIG. 19 is a schematic view, partially in cross-section, of a system according to the present invention.

FIG. 20 is a perspective view of a system according to the present invention.

FIG. 21 is a side cross-section view of a system according to the present invention.

FIG. 22 is a perspective view of a system according to the present invention.

FIG. 22A is a perspective view of the system of FIG. 22.

FIG. 23A is a schematic view of a system according to the present invention.

FIG. 23B is a schematic view of a system according to the present invention.

FIG. 23C is a schematic view of a system according to the present invention.

FIG. 24 is a perspective view of a system according to the present invention.

FIG. 25 is a perspective view of a system according to the present invention.

FIG. 26A is a schematic view of a system according to the present invention.

FIG. 26B is a partial cross-section view of the system of FIG. 26A.

FIG. 27 is a schematic view of a system according to the present invention.

FIG. 28 is a schematic view of a system according to the present invention.

FIG. 29 is a schematic view of a system according to the present invention.

FIG. 30 is a schematic view of a system according to the present invention.

FIG. 31A is a schematic view of a system according to the present invention.

FIG. 31B is a schematic view of a system according to the present invention.

FIG. 32 is a schematic view of a system according to the present invention.

FIG. 33 is a schematic view of a system according to the present invention.

FIG. 34 is a schematic view of a system according to the present invention.

FIG. 35 is a schematic view of a system according to the present invention.

FIG. 36 is a schematic view of a system according to the present invention.

FIG. 37 is a schematic view of a system according to the present invention.

FIG. 38 is a schematic view of a system according to the present invention.

FIG. 39 is a schematic view of a system according to the present invention.

FIG. 40 is a schematic view of a system according to the present invention.

FIG. 41A is a schematic view of a system according to the present invention.

FIG. 41B is a schematic view of a system according to the present invention.

FIG. 42A is a perspective view of a system according to the present invention.

FIG. 42B is an explodes view of the system of FIG. 42A.

Certain embodiments of the invention are shown in the above-identified figures and described in detail below. Various aspects and features of embodiments of the invention are described below and some are set out in the dependent claims. Any combination of aspects and/or features described below or shown in the dependent claims can be used except where such aspects and/or features are mutually exclusive. It should be understood that the appended drawings and description herein are of certain embodiments and are not intended to limit the invention or the appended claims. On the contrary, the intention is to cover all modifications, equivalents and alternatives falling within the spirit and scope of the invention as defined by the appended claims. In showing and describing these embodiments, like or identical reference numerals are used to identify common or similar elements. The figures are not necessarily to scale and certain features and certain views of the figures may be shown exaggerated in scale or in schematic in the interest of clarity and conciseness.

As used herein and throughout all the various portions (and headings) of this patent, the terms “invention”, “present invention” and variations thereof mean one or more embodiments, and are not intended to mean the claimed invention of any particular appended claim(s) or all of the appended claims. Accordingly, the subject or topic of each such reference is not automatically or necessarily part of, or required by, any particular claim(s) merely because of such reference. So long as they are not mutually exclusive or contradictory any aspect or feature or combination of aspects or features of any embodiment disclosed herein may be used in any other embodiment disclosed herein.

### DETAILED DESCRIPTION OF THE INVENTION

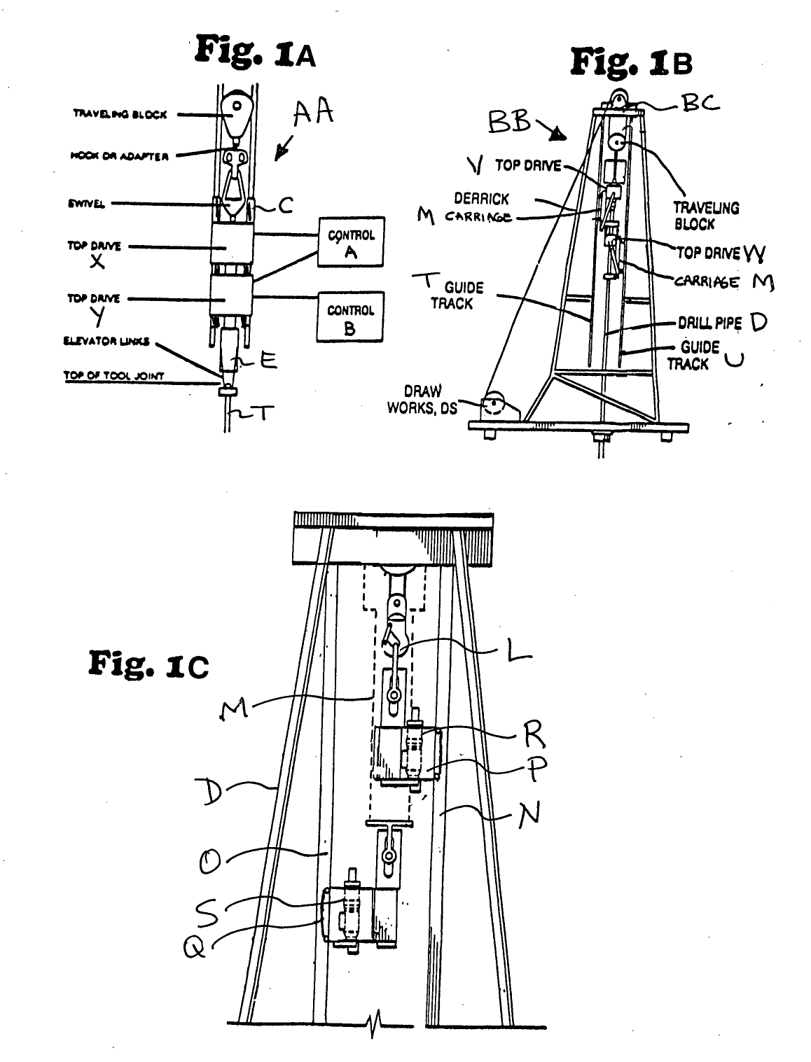

FIG. 1A shows a system AA according to the present invention which has two top drives X and Y on a carriage C which is movably connected to tracks T on a derrick (not shown). A typical traveling block, hook or adapter, and swivel support the top drives in their movement on the carriage. An elevator system E with elevator links supports a tool joint T.

A control system A controls the top drive X and/or top drive Y. A control system B controls the top drive Y (when it is not controlled by the control system A). Optionally, the control system B controls the top drive X or both top drives X and Y. These control systems may include any known control system used in wellbore operations and, without limitation, may be any control system referred to or disclosed herein. Any top drive in any system according to the present invention may have any of these control systems; and any system herein may have one or two top drive control systems.

The two top drives X and Y move in unison on the carriage C. Optionally, the two top drives may be spaced apart as desired any desired space or distance on the carriage C.

FIG. 1B shows a system BB according to the present invention which has two top drives V and W each on its own dedicated movable support M (e.g., carriage, dolly, etc.). The top drives V and W are diametrically opposed to each other and torque from each is reacted to its own dedicated carriage, to its own dedicated guide track (T for top drive V; U for top drive W), and to a derrick structure. A traveling block and crown block arrangement BC supports the top drives and a drawworks system D raises and lowers the block and the top drives.

The top drives V, W are connected together, move in unison, and either singly or in unison rotate a drill pipe D. Optionally, the top drives are not connected together.

FIG. 1C shows a system CC according to the present invention which has two top drives R, S each on its own carriage P, Q, respectively which are movably mounted to a torque track N, O, respectively on a derrick D. A support system L supports the top drive R and with movement apparatus (not shown; e.g. like any herein) provides for movement of the top drive R up and down in the derrick D. A support system M (shown schematically in dotted line; like any support system herein) supports the top drive S and with a movement apparatus (not shown) provides for the movement of the top drive S up and down in the derrick D. The system M is positioned and configured so it does not interfere with and is operable independently of the system L.

The top drives R, S may be moved in unison or they may be moved independently of each other. Optionally one or both top drives R, S are pivotably mounted to their respective tracks or to the derrick for movement out of alignment with and/or out of the way of the other top drive and/or away from a well center.

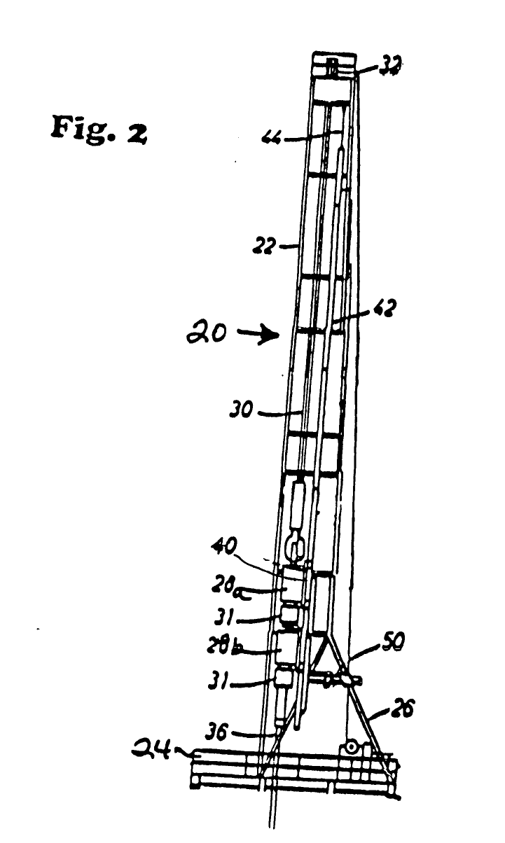

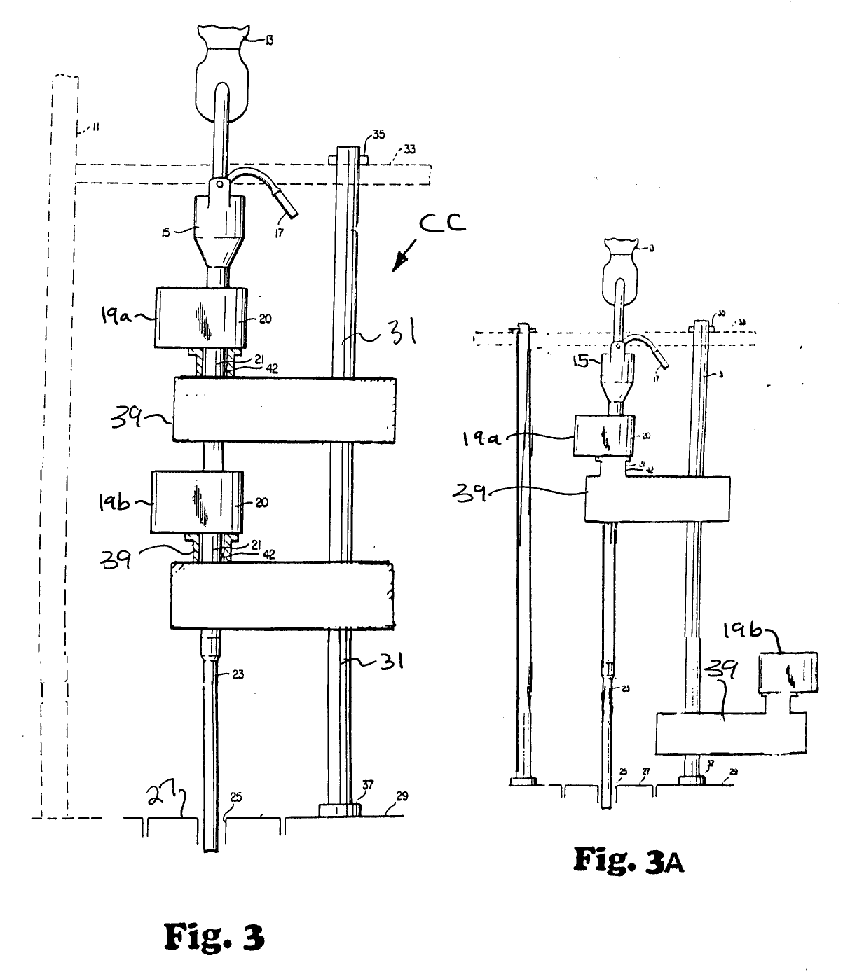

The present invention provides improvements to the subject matter of U.S. Pat. No. 5,501,386. Referring to FIG. 2, a drilling rig or derrick 20 is shown having a mast 22, substructure 24 and an A-frame 26 which supports and stabilizes mast 22 on substructure 24. Top drive drilling units 28a and 28b are suspended from a cable arrangement 30, a portion of which loops around crown block 32, and in turn is tensioned for upward movement by a motor (not shown) supported at the rig floor. A drill string 36 is suspended by the top drive drilling units. The top drive units include a power swivel 31 to rotate drill string 36. Drill string 36 passes through substructure 24 into the ground.

The top drive units are on a carriage assembly 40 which moves along a torque track 42. Torque track 42 can be comprised of a series of track segments. At its upper end, the torque track 42 is suspended by a cable 44 which is attached to the structural framework of mast 22. At its lower end, the torque track 42 is attached by member 50 to A-frame 26. The combination of member 50 is occasionally referred to as a strong back. In this manner, any torsional load which is introduced into the torque track 42 as a result of the rotation of top drive drilling units is resisted by the strong back frame arrangement which transfers most of the torsional loads and forces into substructure 24 rather than mast 22. One possible configuration and assembly for a torque track 42 is disclosed in further detail in U.S. Patent Application Ser. No. 217,689, filed Mar. 24, 1994, which is hereby incorporated by reference and made a part of this detailed description.

Periodically, it is necessary to add or remove a series of sections of drill string 36. For example, during a tripping operation as many as 100 sections (or more) of 30-90 foot lengths (“multiples” or “stands”) of drill string may be removed. Such a tripping operation may be required to replace a drill bit which may be necessary every 12-18 hours of drilling. Thus, it is advantageous to have torque track 42 and the top drive units displaced from a position immediately above the drill string (as is shown in FIG. 2).

The present invention provides improvements to the subject matter of U.S. Pat. No. 4,865,135. Referring to FIG. 3, a system CC according to the present invention has a derrick 11 shown schematically by dotted lines. The derrick 11 supports a set of blocks which move up and down the derrick. The blocks support a swivel 15, which is connected to a mud hose 17. The mud hose 17 will be connected to a source of drilling fluid.

Top drive units 19a and 19b are also supported by the blocks below the swivel 15 in the embodiment shown. Each top drive unit contains an electrical motor within a housing 20 which is supplied with electrical power from the drilling rig. The housings 20 also contain a drive mechanism connected to the electrical motor for rotating a drive stem 21. The drive stem 21 is adapted to be connected to the upper end of the string of drill pipe 23 and rotates relative to housing 20.

The drill pipe 23 extends through a hole 25 in a rotary table 27. The rotary table 27 is rotatably mounted to the rig floor 29. In one aspect, the rotary table 27 does not apply torque to the drill pipe 23 while the top drive units (or one of them) are operating.

Torque shaft 31 is vertically mounted in the derrick 11 at its upper end to a brace 33 in the derrick 11. A nut 35 or other means applies tension to the torque shaft 31 to increase its rigidity. The lower end of the torque shaft 31 is held by a coupling 37. When a top drive unit is operating, coupling 37 will prevent any rotation of the torque shaft 31 relative to the rig floor 29.

Each top drive is connected to the torque shaft 31 by a torque connection apparatus 39 carried in the derrick 11 below each housing 20. Reactive torque on the housings 20 is applied to the apparatuses 39 (e.g. see those disclosed in U.S. Pat. No. 4,865,135).

In operation, the top drive units rotate the drive stem 21. Assuming that the rotation is to the right, looking downward, this will create a reaction torque in the housings 20 in the opposite direction. The rotational force on the housings 20 will be applied to the torque connection apparatuses 39 which transmit the rotational force to the torque shaft 31. The torque shaft 31 will transmit the rotational force to the rig floor 29. The coupling 37 prevents the torque shaft 31 from rotating, and thus prevents the housing 20 from rotating. There will be no lateral forces imposed on the torque shaft 31 by the reaction torque of the top drive units. As the top drive units move downward during drilling, apparatuses 39 move with them on the torque shaft 31. If the drive stem 21 is rotated in the reverse direction, such as during breakout, then the opposite will apply.

As shown in FIG. 3A, the top drive unit 19b, in one aspect is selectively movable on the torque shaft 31 out of the way of the top drive unit 19a.

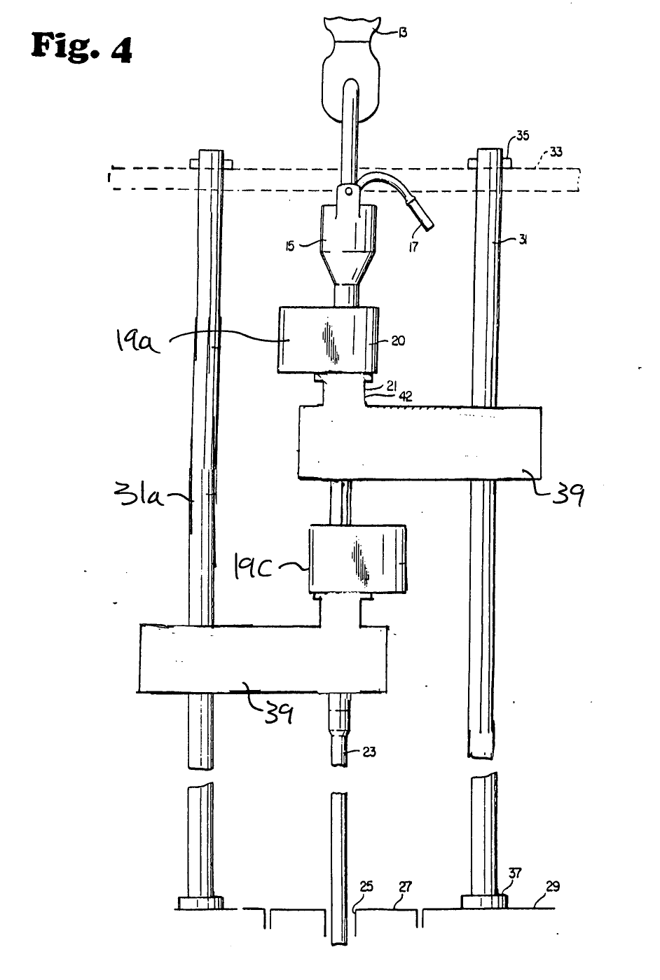

As shown in FIG. 4 in a system according to the present invention (like the system of FIG. 3—like numerals indicate like parts) a top drive unit 19c is connected via a torque connection apparatus to a torque shaft 31a (like the torque shaft 31). It is within the scope of the present invention for the top drive unit 19c to be supported by and moved by the same apparatus associated with the top drive unit 19a; or the top drive unit 19c may have its own dedicated support and movement structure situated and configured so they do not interfere with those of the top drive unit 19a and which permit the top drive unit 19c to move with or independently of the top drive unit 19a. The top drive unit 19c may be moved out of the way of the top drive unit 19a (as may the top drive unit 19a be moved out of the way of the top drive unit 19c—e.g. see FIG. 3A for one method of such movement).

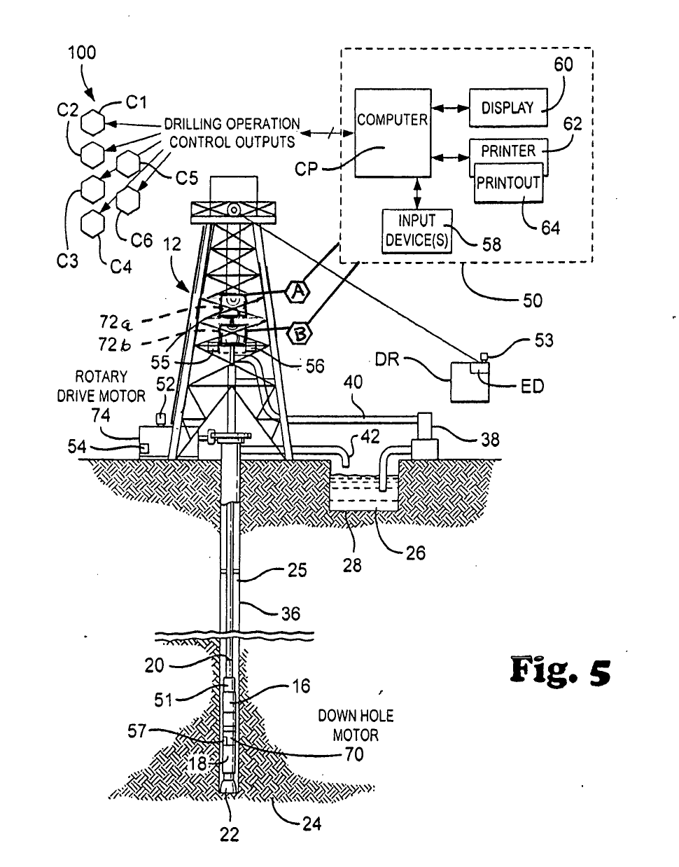

The present invention presents improvements to the subject matter of U.S. Pat. No. 7,243,735. In certain embodiments of systems and methods according to the present invention fluid is pumped down a well by pumps and cuttings flow up an annulus with fluid pumped out of a bit rotated by a system according to the present invention. Sensors provide signals indicative of various parameters, including, e.g., WOB, ROP, torque, bit rotation speed, and bit cross-section area. WOB, ROP, and/or torque can be measured by sensor(s) at the surface and/or downhole. Bit rotational speed (zero at the surface, by definition) is measured downhole. The sensors are in communication with a control system (e.g. a computer system or systems, PLC's, and/or DSP's). This system controls the operation and the top drives and may calculate differentiated mechanical specific energies; e.g. three different mechanical specific energies—drillstring, bit, and surface. Any suitable known downhole sensors can be used (for the system and method of FIG. 5 and/or for any system and method disclosed herein), including, but not limited to, those disclosed in U.S. Pat. Nos. 6,839,000; 6,564,883; 6,429,784; 6,247,542; and in the references cited therein, all incorporated fully herein for all purposes.

In one scenario a driller views a display (screen and/or strip chart) which indicates in real time the value of any significant change in operational parameters, e.g. in drillstring mechanical specific energy, bit mechanical specific energy, and surface mechanical specific energy. The system may provide and the display may also display results post-event, not in real time.

The CONTROL system can be used to control various aspects of a wellbore operation. The system can be programmed to control any drilling parameter or set of parameters (e.g. one or some in any combination, of WOB, ROP, torque and/or bit speed). The computer is programmed to perform one, some, or all of the following actions: control the top drives; provide warnings to the driller and to others on site and/or remote from the rig, e.g. in a remote facility (by any known type of communication) e.g. warnings of increased energy consumption per volume drilled which can lead to a determination of bit failure, bit tooth breakage, bearing failure, bottom hole balling, drillstring vibration, bit whirl, and bit vibration execute control with controls of appropriate equipment and apparatuses to maintain parameters at or below target or not-to-exceed values, e.g. controlling WOB; and controls on the pumps to control fluid flow, conduct diagnostic tests of apparatuses and equipment (and of the wellbore itself) to locate source of a problem and, in one aspect, to choose and/or display possible courses of corrective action, e.g., simultaneously optimizing ROP and mechanical specific energy to optimize drilling performance (optionally) execute control to effect a higher-level strategy, e.g., simultaneously minimizing ROP and mechanical specific energy to optimize drilling.

FIG. 5 illustrates a system 100 according to the present invention and method according to the present invention which has sensors 51-57 for providing data for calculating WOB, ROP, bit speed and torque. As shown, the system 100 has top drives 72a and 72b (shown schematically; may be any suitable dual top drive system disclosed herein as is true for any system herein), a rotary drive 74 and a downhole motor 70 to indicate that any of these drive systems may be used with systems and methods according to the present invention. A drillstring 20 extending down from a rig 12 into a wellbore 36 in an earth formation 24 has a bit 22 on a bottom hole assembly 16 at the wellbore bottom. Drilling fluid 26 flows from a tank or pit 28 pumped by a pump system 38 through a piping system 40 down the drillstring 20 and returning up an annulus 25 flowing in a line 42 back to the tank 28.

A control system 50 includes a computer CP with a display 60, a printer 62 and a printout 64. Input devices 58 receive data signals from the sensors 51-57 which are in communication with the computer via wire, cable and/or wireless communication. For example, sensors may provide signals indicative of the following: top drive operation, WOB, at the surface from a sensor or a drill line anchor or downhole from a sensor 51 of an MWD unit; torque, at the surface from a sensor 52 of the rotary drive 74 or from a sensor 55 of the top drive or drives, or downhole from the sensor 51; ROP, at the surface from a sensor 53 on an encoder ED of a drawworks DR (shown schematically) or from the sensor 51; and bit rotational speed at the surface from a sensor 55 in a top drive or drives or from a sensor 54 in the rotary drive or downhole from the sensor 51; or from a sensor 57 in the motor 70. The computer CP calculates various parameters and then decides whether to provide alarms and/or to execute control programs to control various aspects of top drives and/or of the drilling process.

The drilling operation control outputs from the computer CP are provided to various controllers and control systems C1-C6 which control drill line payout (brake control and/or drawworks motors control); a rotary table (control bit speed); top drives (control bit speed) mud pumps (pump rate control) downhole drilling systems, and/or rotary steerable systems. In one particular method of use of the system 100, a new bit 22 is tripped into the wellbore and the drillstring 20 is run down to the wellbore bottom. The driller enters into the computer CP target ROP, bit rotational speed, drilling fluid pump rate, and WOB. The control system 50 then prepares to collect data related to all the drilling parameters to be measured and monitored and calculates and displays the three mechanical specific energies. The system 50 proceeds to determine a background mechanical specific energy level with drilling at “safest” conditions and determines that the entire allowable operating range for WOB, RPM, torque and ROP is within safe limits. In one aspect WOB and bit RPM are directly controlled by the driller. Torque and ROP are resultants of this control, but can also be controlled, for example, by adjusting WOB and/or rotational speed to alter the resultant torque and ROP's. The driller then starts drilling with the target ROP, WOB, RPM, and pump rate. The system 50 informs the driller that the drilling process in progress is acceptable. In one particular scenario, the system 50 then detects an increase in bit mechanical specific energy, informs the driller that an abnormal event is occurring, and begins a diagnostic process. The system 50 moves all control parameters to a safe (or safest) value (e.g. to values at which bit balling will not occur), e.g. minimum WOB, maximum RPM, and maximum drilling fluid pump rate. The system 50 controls equipment directly or sends set points to individual devices' controllers. In this case, the bit mechanical specific energy then returns to an acceptable or baseline value and the system 50 concludes that bit balling had been occurring when the drilling operation was at the original target values the driller had been using. The system 50 then informs personnel, e.g. the driller and/or the company man, that bit balling has been detected and the system 50 offers two possible course of action: 1. replace the bit; 2. let the system 50 attempt to find a maximum ROP at which balling will not occur. In the event option 2. is chosen, the rig personnel can decide if the calculated ROP is acceptable for further drilling. In the event option 2. is chosen, the control system resumes drilling at the determined safe values of the drilling parameters (e.g. those at which bit balling is least likely to occur) and then manipulates ROP, RPM, WOB and pump rate to achieve maximum ROP while seeing that bit mechanical specific energy is maintained at or below “no balling” values.

FIG. 6 illustrates a wellbore hole-opening operation 100u (or “underreaming”) in which the diameter of an already-drilled hole 102 is increased to a hole 104 with a wider diameter with an assembly 106 including an under-reamer 108 which has expandable arms 110, with cutters 112 on the end, and a drill bit 114 rotated by a dual top drive system DA according to the present invention. The drill bit 114 can remove fill or cave-in material and/or can ream the hole back to gauge.

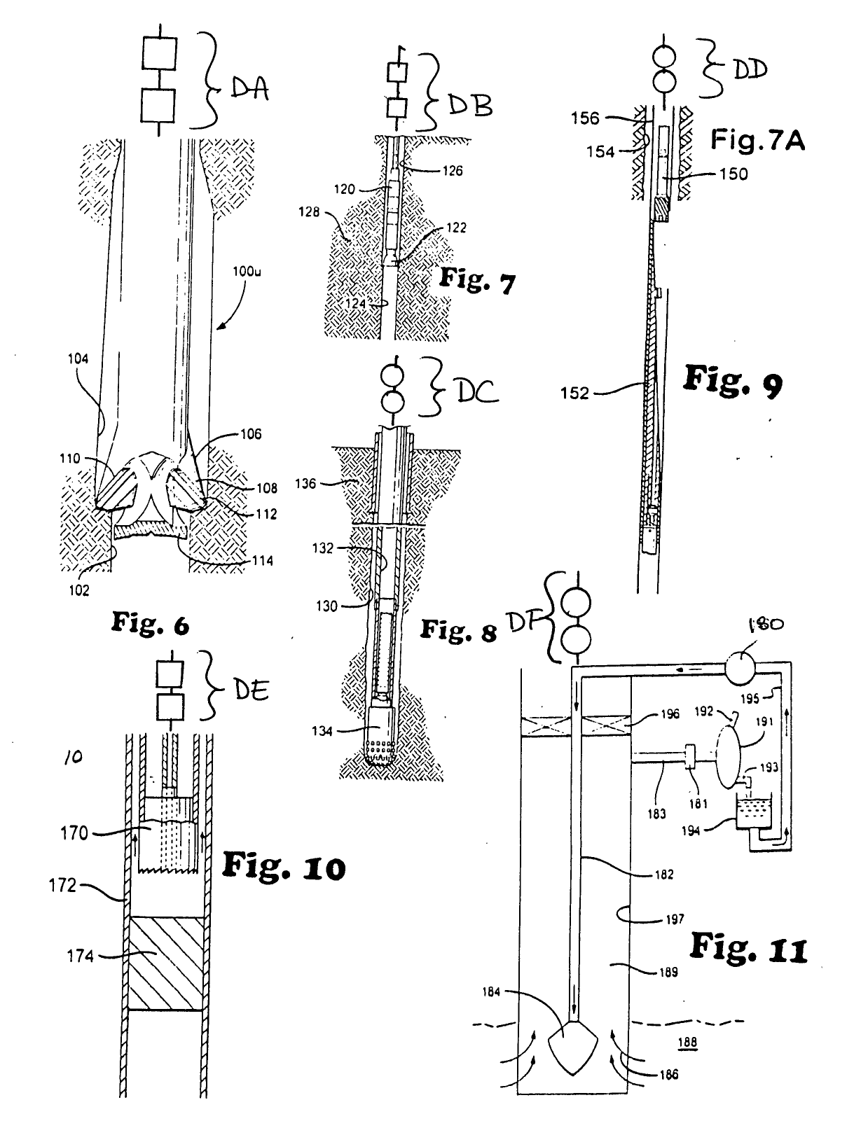

Reaming is a method of “drilling again” an already-drilled hole section; e.g., as shown in FIG. 7, a drilling system 120 with a bit 122 rotated by a dual top drive system DB according to the present invention is reaming a hole 124 in a formation 128 to a reamed hole diameter of a new hole 126. Often, this is pumping and rotating the drill string down through a section to insure that the hole has stayed the desired gauge (i.e. drilled) size. This is often a common practice, where each new section (stand or joint) is reamed before stopping to make a connection. In one case an under-gauge hole is reamed (for example, a previously used bit had gage wear around the outside and did not drill a full size hole), where reaming drills out the outer diameter that was missed the first time.

Casing drilling, see e.g. FIG. 8, is a process whereby a hole 130 is drilled using the casing which will be cemented into the drilled hole 130 in a formation 136 without using a drillstring to drill (in one aspect without any additional trips for casing the hole). A bit 134 rotated by a dual top drive system DC according to the present invention (or other hole maker) used to make the hole may be wireline retrievable inside the casing 132, or it may be a disposable and/or drillable bit or hole maker attached to the end of the casing 132. Systems and methods according to the present invention with dual top drives may be used with casing drilling systems and methods disclosed in U.S. Pat. Nos. 5,197,553; 5,271,472; 5,472,057; 6,443,247; 6,640,903; 6,705,413; 6,722,451; 6,725,919; 6,739,392; 6,758,278; and in references cited in these patents—all incorporated fully herein for all purposes.

Milling is the process of milling away an object in a wellbore or milling out a section of a casing (or tubular) wall and can include drilling a formation, e.g. drilling enough of an adjacent formation so that a conventional drilling assembly can be used to continue drilling into the formation. FIG. 9 illustrates a milling process according to the present invention using systems and methods according to the present invention. A mill 150 either releasably attached to or separate from a whipstock 152 (or other mill diverter, mill guide, or turner) is lowered into a wellbore 154 which is cased with casing 156. The mill 150, rotated by a dual top drive system DD according to the present invention, mills a hole or “window” in the casing 156. As the mill 150 mills through the casing 156 it begins to cut away earth from an earth formation adjacent the casing 156. If it is allowed to proceed the mill 150 mills a hole in the earth formation. The methods of the present invention are useful in milling procedures and in milling/drilling or milling-and-drill procedures, e.g., in the systems and methods of U.S. Pat. Nos. 5,474,126; 5,522,461; 5,531,271; 5,544,704; 5,551,509; 5,584,350; 5,620,051; 5,657,820; 5,725,060; 5,727,629; 5,735,350; 5,887,655; 5,887,668; 6,202,752; 6,612,383; and in the references cited in these patents—all of which are incorporated fully herein for all purposes.

Milling up undesirable material from a wellbore is often done after other extraction methods have been exhausted. “Junk” in drilling operations can include items dropped in the hole, e.g. hand tools, and rock bit cones that have fallen off a drill bit. Examples of junk in workover operations are packers and bridge plugs. FIG. 10 shows a mill 170 rotated by a dual top drive system DE according to the present invention in casing 172 in a wellbore (not shown) milling a piece of junk 174 (shown schematically). Alternatively, the junk 174 may be a packer or other item that is to be milled out. Often in such milling methods, from start to finish, the mill does not drill a homogenous material, but rather an unknown (at the surface) mixture of components (metal, plastic, etc.), cuttings and/or possibly formation fill, such as sand.

Managed pressure drilling (MPD) includes drilling with downhole pressure control provided by dynamic control of the annulus pressure in a wellbore. Underbalanced drilling (UBD) is a subset of managed pressure drilling whereby the downhole pressure is managed so that it is below the formation pressure of a formation through which the wellbore extends and formation fluids are allowed to flow to the surface. FIG. 11 illustrates use of methods according to the present invention with dual top drive systems in an underbalanced drilling operation. Mud pumps 180 provide drilling fluid under pressure down a drillstring 182 to a drill bit 184 (rotated by a dual top drive system DF according to the present invention) at a pressure sufficiently low so that formation fluids 186 can flow from a formation 188 into an annulus 189 around the bit 184 and drillstring 182 up to an exit line 183. A choke system 181 controls flow to a tank or reservoir 191 which has an upper flare 192 for flaring gas and a lower line 193 through which fluid flows to a mud pit 194 which is in fluid communication via a line 195 with the mud pumps 180. Optionally a BOP 196 is used on the wellbore 197. Methods for MPD and UBD according to the present invention use a suitable dual top drive system with either or both top drives operational at any given time; with top drives operating alternately; and/or with top drives operating sequentially.

The present invention presents improvements to the subject matter of U.S. Pat. No. 7,404,454. In certain aspects, the present invention discloses systems and methods using dual top drives for selectively orienting a bit at the end of a drillstring, the system comprising motive apparatus with dual top drives for rotating a drillstring and a bit, the bit connected to an end of the drillstring, the drillstring in a wellbore, the wellbore extending from an earth surface into the earth, the bit at a location beneath the earth surface, a control member apparatus including a control member manually movable by a person to effect a change in orientation of the bit in the wellbore, a control system in communication with the motive apparatus and the control member, the control system for translating a movement signal from the control member apparatus into a command to the motive apparatus, the command commanding the motive apparatus to rotate the drillstring and the bit in correspondence to the movement of the control member, the control system including computing apparatus programmed for receiving a speed limit input and a torque limit input by an operator person, the speed limit input comprising a signal indicative of a limit on speed of movement of the drillstring, the torque limit input comprising a signal indicative of a limit on torque applied to the drillstring, the control system controlling movement by the motive apparatus so that the speed limit is not exceeded and so that the torque limit is not exceeded, wherein the motive apparatus has two top drives, driven by variable frequency drives, variable frequency drive controllers control the variable frequency drive, the control system controls the variable frequency drive controllers, the variable frequency drive controllers provide feedback to the control system indicative of actual speed of a drive shafts of the top drives, the drive shafts connected to the drillstring to rotate the drillstring and the bit, and feedback indicative of the actual torque applied to the drillstring by the top drive shafts, the bit is to be moved to a destination position from a starting position, wherein the control system controls the motive apparatus so that overshooting of the destination position by the bit is eliminated or minimized, and wherein the control system calculates a constant acceleration for initial movement by the motive apparatus of the drillstring and bit, a constant velocity for movement by the motive apparatus of the drillstring and bit following movement at a constant acceleration, and a constant deceleration for movement by the motive apparatus of the drillstring and bit to move the bit to a destination position with no or minimal overshooting of the destination position with either one or both top drives used to rotate the bit at any point in the operation as desired.

The present invention provides a method for selectively orienting a bit at the end of a drillstring, the method including moving a control member of a system to orient the bit, the system including motive apparatus with two top drives according to the present invention for rotating a drillstring and a bit, the bit connected to an end of the drillstring, the drillstring in a wellbore, the wellbore extending from an earth surface into the earth, the bit at a location beneath the earth surface, a control member apparatus including a control member movable to effect a change in orientation of the bit in the wellbore, the control member apparatus including signal apparatus for producing a movement signal indicative of movement of the control member, a control system in communication with the motive apparatus and the control member, the control system for translating a movement signal from the control member apparatus into a command to the motive apparatus, the command commanding the motive apparatus (either or both top drives) to rotate the drillstring and the bit in correspondence to the movement of the control member, controlling the motive apparatus with the control system, and rotating the drillstring and the bit in correspondence to the movement of the control member. In one aspect in such a method the control system controls movement by the motive apparatus of the drillstring and bit to move the bit to a destination position with no or minimal overshooting of the destination position, the method further including moving the drillstring and bit to move the bit to the destination position with no or minimal overshooting of the destination position.

In one aspect, the control system calculates a constant acceleration for initial movement by the top drive(s) of the drillstring and bit, a constant velocity for movement by the top drive(s) of the drillstring and bit following movement at a constant acceleration, and a constant deceleration for movement by the top drive(s) of the drillstring and bit to move the bit to a destination position with no or minimal overshooting of the destination position. In one aspect, the control system stops the top drive(s) whenever the speed of rotation of the drillstring and the bit is within a preselected dead band range, thereby stopping rotation of the drillstring and the bit. In one aspect, in such a method an operator interface for an operator to input to the control system limit values for top drive(s) speed, torque to be applied to the drillstring by the top drive(s), and a desired bit destination position. In one such system the control system provides to the operator interface indications of actual top drive(s) speed, actual torque applied to the drillstring by either or both top drives, and position of the control member. In one aspect the control system continuously uses the position signal from encoder apparatus to control the top drive(s).

In one aspect the system according to the present invention is operable in open-loop mode and wherein each top drive has a top drive shaft and a variable frequency drive provides feedback to the control system regarding speed of the top drive shaft(s), and the control system for calculating a position of the top drive shaft(s) based on speed feedback from the variable frequency controller and based on an indication of cycle time provided by the control system. In one aspect the control system includes computing apparatus programmed for receiving a speed limit input and a torque limit input by an operator person, the speed limit input being a signal indicative of a limit on speed of movement of the drillstring, the torque limit input being a signal indicative of a limit on torque applied to the drillstring by the top drive or top drives, the control system controlling movement by the top drive(s) so that the speed limit is not exceeded and so that the torque limit is not exceeded, and the control system includes computing apparatus for receiving an incremental angular rotation distance input by the operator person and a drillstring rotation direction input by the operator person, the control system for controlling the top drive(s) so that the drillstring is rotated the incremental angular rotation distance in the input drillstring rotation direction.

The present invention provides systems for selectively orienting a bit at the end of a drillstring, the system comprising motive apparatus with dual top drives according to the present invention for rotating a drillstring and a bit, the bit connected to an end of the drillstring, the drillstring in a wellbore, the wellbore extending from an earth surface into the earth, the bit at a location beneath the earth surface, a control member apparatus including a control member movable to effect a change in orientation of the bit in the wellbore, the control member apparatus including signal apparatus for producing a movement signal indicative of movement of the control member, a control system in communication with the motive apparatus and the control member, the control system for translating a movement signal from the control member apparatus into a command to the motive apparatus, the command commanding the motive apparatus (either or both top drives) to rotate the drillstring and the bit in correspondence to the movement of the control member, each top drive driven by a variable frequency drive, a variable frequency drive controller controls the variable frequency drive, and the control system controls the variable frequency drive controllers. In one aspect, the variable frequency drive controllers provide feedback to the control system indicative of actual speed of a drive shaft of a top drive, the drive shaft connected to the drillstring to rotate the drillstring and the bit, and feedback indicative of the actual torque applied to the drillstring by the top drive shaft. In one aspect, the control system calculates a constant acceleration for initial movement by the motive apparatus (either or both top drives) of the drillstring and bit, a constant velocity for movement by the motive apparatus (either or both top( ) drives) of the drillstring and bit following movement at a constant acceleration, and a constant deceleration for movement by the motive apparatus of the drillstring and bit to move the bit to a destination position with no or minimal overshooting of the destination position.

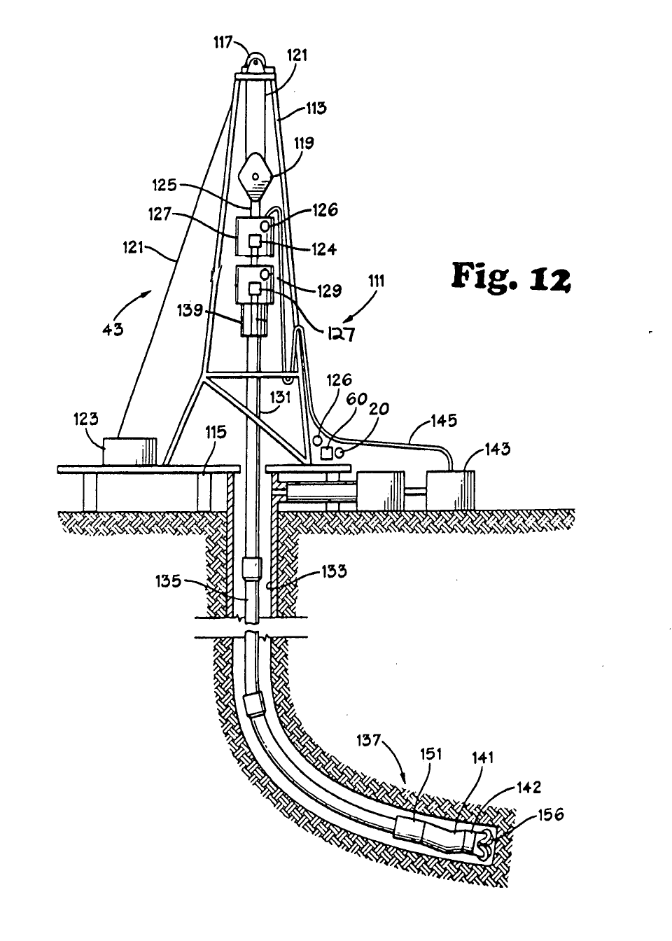

As shown in FIG. 12 a drilling rig 111 is depicted schematically as a land rig, but other rigs (e.g., offshore rigs, jack-up rigs, semisubmersibles, drill ships, and the like) are within the scope of the present invention (as is true for all embodiments herein). In conjunction with an operator interface, e.g. an interface 20, a control system 60 as described below controls certain operations of the rig. The rig 111 includes a derrick 113 that is supported on the ground above a rig floor 115. The rig 111 includes lifting gear, which includes a crown block 117 mounted to derrick 113 and a traveling block 119. A crown block 117 and a traveling block 119 are interconnected by a cable 121 that is driven by drawworks 123 to control the upward and downward movement of the traveling block 119. Traveling block 119 carries a hook 125 from which is suspended a top drive system 127 which includes a variable frequency drive controller 126, a motor (or motors) 124 and a drive shaft 129. Top drive systems 127 (either or both) (may be any suitable dual top drive system disclosed herein according to the present invention) rotate a drillstring 131 to which the drive shaft 129 is connected in a wellbore 133. The top drives 127 can be operated to rotate the drillstring 131 in either direction. According to an embodiment of the present invention, the drillstring 131 is coupled to the top drives 127 through an instrumented sub 139 which includes sensors that provide information, e.g., drillstring torque information.

The drillstring 131 may be any typical drillstring and, in one aspect, includes a plurality of interconnected sections of drill pipe 135 a bottom hole assembly (BHA) 137, which includes stabilizers, drill collars, and/or an apparatus or device, in one aspect, a suite of measurement while drilling (MWD) instruments including a steering tool 151 to provide bit face angle information. Optionally a bent sub 141 is used with a downhole or mud motor 142 and a bit 156, connected to the BHA 137. As is well known, the face angle of the bit 156 is controlled in azimuth and pitch during drilling.

Drilling fluid is delivered to the drillstring 131 by mud pumps 143 through a mud hose 145. During rotary drilling, drillstring 131 is rotated within bore hole 133 by the top drive(s) which, in one aspect, are slidingly mounted on parallel vertically extending rails (not shown) to resist rotation as torque is applied to the drillstring 131. During sliding drilling, the drillstring 131 is held in place by the top drives while the bit 156 is rotated by the mud motor 142, which is supplied with drilling fluid by the mud pumps 143. The driller can operate the top drives to change the face angle of the bit 156. The cuttings produced as the bit drills into the earth are carried out of bore hole 133 by drilling mud supplied by the mud pumps 143.

Control software in a programmable medium of the control system 60, e.g., but not limited to, one, two, three or more on-site, or remote computers, PLC's, single board computer(s), CPU(s), finite state machine(s), microcontroller(s), controls the movement of the main shafts in response to the movement of an adjustable apparatus (e.g. at a driller's console) so that the main shaft is not moved too quickly and so that it and the drillstring and the bit connected thereto are moved smoothly with a smoothly decreasing declaration as a movement end point is approached. “On-site” may include e.g., but is not limited to, in a driller's cabin and/or in a control room or building adjacent a rig.

A motor of the top drives rotates the main shaft (which are connected to the drillstring) with the drill bit at its end. A VFD controller controls the motors. A position encoder (located adjacent the top drive motor) sends a signal indicative of the actual position of the main shaft to the VFD controller and to the control system 60 where it is an input value for the control software 50.

From the operator interface 20, pre-selected limiting values for main shaft speed (“speed limit”); main shaft torque (“torque limit”); and a desired bit position or “Position Set Point” are input to the control system's control software. The control system 60 provides status data to the operator interface 20 which includes speed, torque, shaft orientation, and position of the apparatuses. The control software sends commands to the VFD controllers which include speed commands and torque commands (torque limit). The VFD controllers provide feedback to the control software which includes values for actual speed of the main shaft and the actual torque (the torque applied to the drillstring by the top drives).

The control system 60 can adjust the speed of the top drives motor and controls the torque applied to the drillstring by the top drive(s) so that the main shaft stops at a desired point. The control system conveys to the control software data values (e.g. fifty per second) for the amount of torque actually applied to the string; and, regarding actual speed, the amount of actual rotation of the string (in degrees or radians). The position encoder has provided position information and velocity information to the VFD controller. The control software receives information regarding position from the encoder and/or from the VFD controllers, optionally, through a direct input/output apparatus (e.g. an I/O device in communication with the encoder) controlled by the software. The VFD controllers constantly use the position from the encoder to control outputs of the top drives to achieve the desired commanded speed and to maintain torque within the torque limit imposed by the control software. The operator using the operator controls on the control interface 20 inputs to the VFD controllers 80 a limitation on the torque that is to be applied to the string (“Torque Limit”) and a limitation on the speed at which the main shaft of the top drives is to be rotated (“Speed Limit”).

Using the Speed Limit, the actual position of the main shaft, the last speed at which the main drive shaft was rotating (“Last Speed”), the speed commanded by the control system 60, to the VFD controllers from the previous control iteration), the maximum allowable acceleration (“Max Accel”), and the cycle time for sending speed commands to the VFD controllers (cycle time is provided by a hardware clock, a clock in a CPU, or a clock in the control system 60), the control software calculates a speed command (“Speed Command”) which is sent to the VFD controllers which, in turn, controls the rotation of the main shaft so that the drillstring is rotated at the desired speed by the top drive(s). To re-orient a bit, it is desirable to rotate the string at such a speed that the bit neither overshoots nor undershoots a desired position (orientation) and this is achieved by rotating as quickly as possible; but as the bit approaches the desired position, it is important to decelerate so that overshoot does not occur. Thus, the control software calculates desired speed for the entire period of bit movement and desired speed changes as the bit approaches a desired position. A final speed is such a calculated speed for rotation of the string as the bit nears the desired position.

The present invention discloses improvements to the subject matter of U.S. Pat. No. 7,147,068. In certain embodiments, the present invention discloses methods for making a cased wellbore including at least the steps of: assembling a lower segment of a drill string comprising in sequence from top to bottom a first hollow segment of drill pipe, a latching subassembly apparatus, a directional drilling apparatus, and a rotary drill bit having at least one mud passage for passing drilling mud from the interior of the drill string to the outside of the drill string; drilling by rotating the drill string with a dual top drive system according to the present invention; periodically halting drilling, introducing into the wellbore a directional surveying apparatus to determine the direction of the wellbore being drilled, and thereafter removing said directional surveying apparatus from said wellbore; drilling the well into the earth in a desired direction to a predetermined depth with the drill string by attaching successive lengths of hollow drill pipes to the lower segment of the drill string and by circulating mud from the interior of the drill string to the outside of the drill string during drilling to produce a wellbore; after the predetermined depth is reached, pumping a latching float collar valve apparatus down the interior of the drill string with drilling mud until it seats into place within the latching subassembly; pumping a bottom wiper plug apparatus down the interior of the drill string with cement until the bottom wiper plug apparatus seats on the upper portion of the latching float collar valve apparatus to clean the mud from the interior of the drill string; pumping any required additional amount of cement into the wellbore by forcing it through a portion of the bottom wiper plug apparatus and through at least one mud passage of the drill bit into the wellbore; pumping a top wiper plug apparatus down the interior of the drill string with water until the top wiper plug seats on the upper portion of the bottom wiper plug apparatus thereby cleaning the interior of the drill string and forcing additional cement into the wellbore through at least one mud passage of the drill bit; allowing the cement to cure; thereby cementing into place the drill string to make a cased wellbore.

The present invention provides methods for drilling and casing a wellbore including: providing a drill string and an earth removal member operatively connected to the drill suing, at least a portion of the drill string including casing; drilling the wellbore with a dual top drive system according to the present invention; using the drill string; and using the casing portion to line the wellbore; and pumping cement into place within the wellbore.

The present invention provides apparatus and methods of operation of that apparatus that allow for formation of a wellbore and for cementation of a drill string with attached drill bit into place during one single drilling pass into a geological formation. The method of drilling the well and installing the casing becomes one single process that saves installation time and reduces costs during oil and gas well completion procedures. Apparatus and methods of operation of the apparatus are disclosed herein that use typical mud passages already present in a typical rotary drill bit, including any watercourses in a “regular bit”, or mud jets in a “jet bit”, for the second independent purpose of passing cement into the annulus between the casing and the well while cementing the drill string in place. Slurry materials may be used for completion purposes in extended lateral wellbores. A borehole is drilled though the earth using a dual top drive system according to the present invention. The borehole is drilled, in one aspect, with a milled tooth rotary drill bit having milled steel roller cones or using any suitable drill bit.

In one drilling process according to the present invention, these steps are followed:
Step 1. Install any necessary conductor pipe on the surface for attachment of the blowout preventer and for mechanical support at the wellhead.
Step 2. Install and cement into place any surface casing necessary to prevent washouts and cave-ins near the surface, and to prevent the contamination of freshwater sands as directed by state and federal regulations.
Step 3. Choose the dimensions of the drill bit to result in the desired sized production well. Begin drilling of the production well with a first drill bit on a drill string rotated by a dual top drive system (by either or by both top drives) according to the present invention. Simultaneously circulate drilling mud into the well while drilling. Drilling mud is circulated downhole to carry rock chips to the surface, to prevent blowouts, to prevent excessive mud loss into formation, to cool the bit, and to clean the bit. After the first bit wears out, pull the drill string out using the dual top drive system, change bits, lower the drill string into the well and continue drilling. It should be noted here that each “trip” of the drill bit typically requires hours of rig time to accomplish the disassembly and reassembly of the drill string, pipe segment by pipe segment using the dual top drive system. Here, each pipe segment may consist of several pipe joints.
Step 4. Drill the production well with the dual top drive system (by either or by both top drives) according to the present invention using a succession of rotary drill bits attached to the drill string until the hole is drilled to its final depth.
Step 5. Pull out the drill string and its attached drill bit.
Step 6. Attach a casing shoe into the bottom male pipe threads of the first length of casing and assemble and lower the production casing into the well while back filling each section of casing with mud as it enters the well to overcome the buoyancy effects of the air filled casing (caused by the presence of the float collar valve), to help avoid sticking problems with the casing, and to prevent the possible collapse of the casing due to accumulated build-up of hydrostatic pressure.
Step 7. Cure the cement.
Step 8. Follow normal final completion operations that include installing the tubing with packers and perforating the casing near the producing zones.

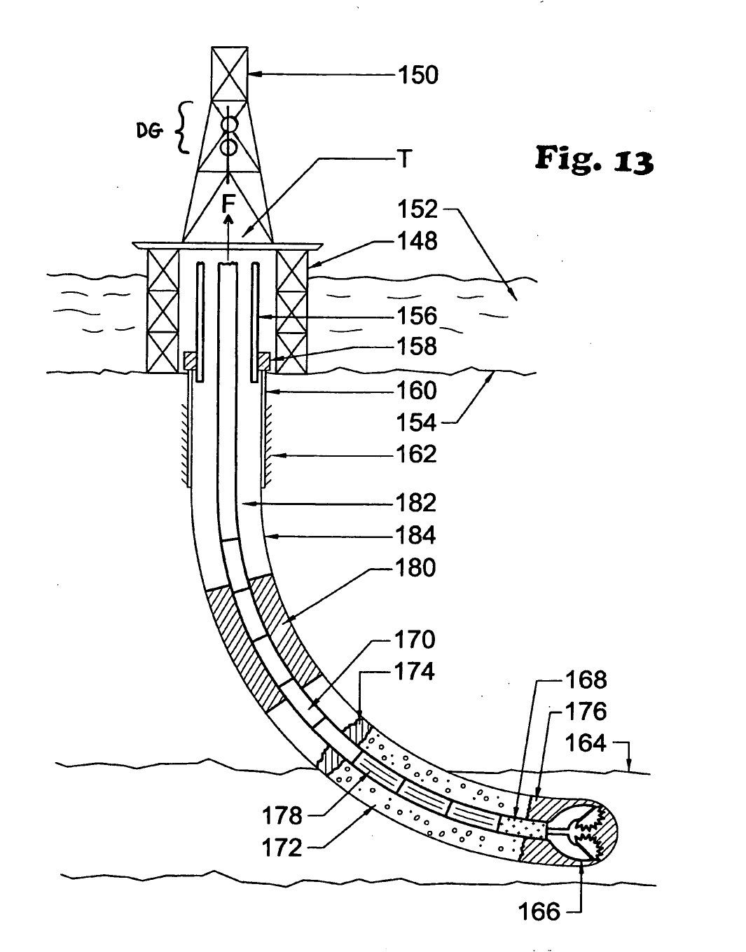

In one system according to the present invention (see FIG. 13) an offshore platform 148 has a rotary drilling rig 150 surrounded by ocean 152 that is attached to the bottom of the sea 154. Riser 156 is attached to blowout preventer 158. Surface casing 160 is cemented into place with cement 162. Other conductor pipe, surface casing, intermediate casings, liner strings, or other pipes may be present, but are not shown for simplicity. The drilling rig 150 has typical components of a normal drilling rig as defined in the figure entitled “The Rig and its Components” opposite of page 1 of the book entitled “The Rotary Rig and Its Components”, Third Edition, Unit I, Lesson 1, that is part of the “Rotary Drilling Series” published by the Petroleum Extension Service, Division of Continuing Education, The University of Texas at Austin, Austin, Tex., 1980, 39 pages, except that the rig 150 includes a dual top drive system DG according to the present invention.

An oil bearing formation 164 has been drilled using the dual top drive system DE rotating the rotary drill bit 166. The oil bearing formation is in the earth below the ocean bottom. Drill bit 166 is attached to a completion sub having the appropriate float collar valve assembly, or other suitable float collar device, or which has one or more suitable latch recessions as in U.S. Pat. No. 7,147,068 and which has other suitable completion devices as required. The completion sub is in turn attached to many lengths of drill pipe, or casing as appropriate. The drill pipe is supported by usual drilling apparatus provided by the drilling rig. Such drilling apparatus provides an upward force at the surface labeled with legend “F”, and the drill string is turned with torque provided by the dual top drive drilling apparatus, and that torque is figuratively labeled with the legend “T”.

One embodiment of the present invention is a method of drilling a borehole from an offshore platform with a rotary drill bit having at least one mud passage for passing mud into the borehole from within a steel drill string including at least steps of: (a) attaching a drill bit to the drill string; (b) drilling the well from the offshore platform by rotating the rotary drill bit with a dual top drive system according to the present invention to a desired depth; and (c) completing the well with the drill bit attached to the drill string to make a steel cased well. Such a method applies wherein the borehole is an extended reach wellbore and wherein the borehole is an extended reach lateral wellbore.

A computer system has typical components in the industry including one or more processors, one or more non-volatile memories, one or more volatile memories, many software programs that can run concurrently or alternatively as the situation requires, etc., and all other features as necessary to provide computer control of the operators. This computer system also has the capability to acquire data from, send commands to, and otherwise properly operate and control all instruments used in the operations. Information obtained downhole is sent to the computer system that is executing a series of programmed steps, whereby those steps may be changed or altered depending upon the information received from the downhole sensor.

Any embodiment of the present invention that pertains to a pipe that is a drill string, also pertains to pipe that is a casing. Put another way, many of the above and below embodiments of the invention will function with any pipe of any material, any metallic pipe, any steel pipe, any drill pipe, any drill string, any casing, any casing string, any suitably sized liner, any suitably sized tubing, or within any means to convey oil and gas to the surface for production, hereinafter defined as “tubulars” or “tubular apparatus.”

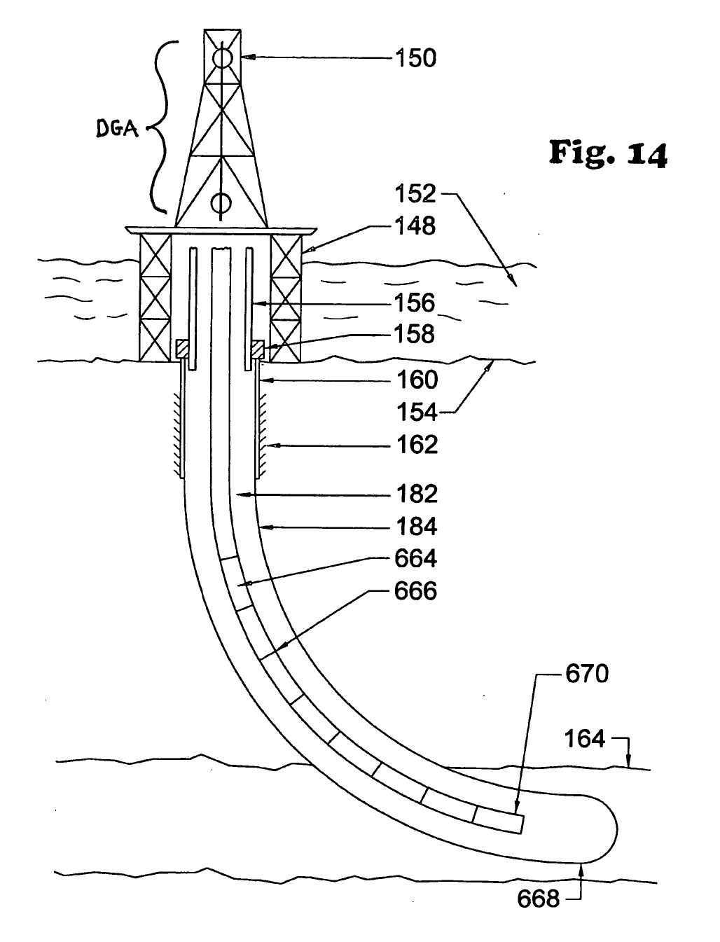

As shown in FIG. 14 (like numerals in FIGS. 13 and 14 indicate like parts) a tubular apparatus is disposed in the open hole 184. A tubular apparatus 664 is deployed in the wellbore that may be a pipe made of any material, a metallic pipe, a steel pipe, a drill pipe, a drill string, a casing, a casing string, a liner, a liner string, tubing, or a tubing string, or any means to convey oil and gas to the surface for production. The pipe may or may not have threaded joints in the event that the pipe is tubing, but if those threaded joints are present, they are labeled with the numeral 666. The end of the wellbore 668 is shown. There is no drill bit attached to the last section 670 of the pipe. If the pipe is a drill pipe, or drill string, then the retractable bit has been removed. If the pipe is a casing, or casing string, then the last section of casing present might also have attached to it a casing shoe. “One pass drilling”, “One-Trip-Drilling” and “One-Trip-Down-Drilling” according to the present invention is the process that results, using a dual top drive system according to the present invention (e.g. the dual top drive system DGA shown in FIG. 14 which is like the system DG, FIG. 13), in the last long piece of pipe put in the wellbore to which a drill bit is attached is left in place after total depth is reached, and is completed in place, and oil and gas is ultimately produced from within the wellbore through that long piece of pipe. Of course, other pipes, including risers, conductor pipes, surface casings, intermediate casings, etc., may be present, but the last very long pipe attached to the drill bit that reaches the final depth is left in place and the well is completed using this first definition.

As many prior patents show, it is possible to drill a well with a “retrievable drill bit” that is otherwise also called a “retractable drill bit”. For the purposes of this invention, a retrievable drill bit may be equivalent to a retractable drill bit in one embodiment. For example, see the following U.S. patents: U.S. Pat. Nos. 3,552,508; 3,603,411; 4,651,837; 4,962,822; and 5,197,553. Some in the industry call this type of drilling technology to be “drilling with casing”. For the purposes herein, the terms “retrievable drill bit”, “retrievable drill bit means”, “retractable drill bit” and “retractable drill bit means” may be used interchangeably.

One embodiment of the present invention is a method of one pass drilling from an offshore platform of a geological formation of interest to produce hydrocarbons including at least the following steps: (a) attaching a retrievable drill bit to a casing string located on an offshore platform; (b) drilling a borehole into the earth from the offshore platform to a geological formation of interest using a dual top drive system according to the present invention; (c) retrieving the retrievable drill bit from the casing string; (d) providing a pathway for fluids to enter into the casing from the geological formation of interest; (e) completing the well adjacent to the formation of interest with at least one of cement, gravel, chemical ingredients, mud; and (f) passing the hydrocarbons through the casing to the surface of the earth. Such a method applies wherein the borehole is an extended reach wellbore and wherein the borehole is an extended reach lateral wellbore.

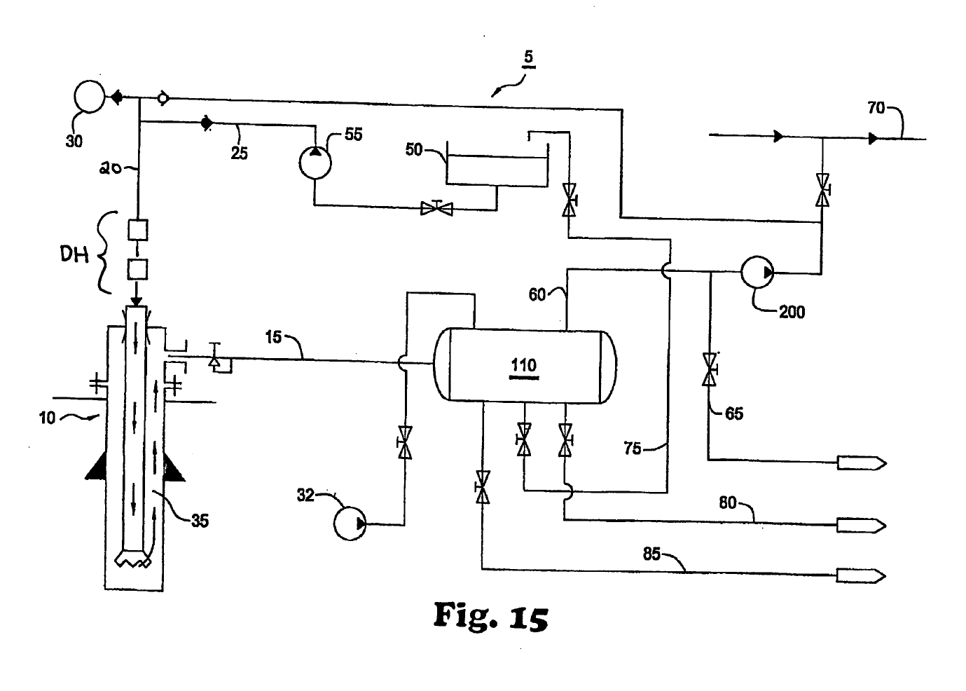

The present invention provides improvements to the subject matter of U.S. patent application Ser. No. 12/027,071 filed Feb. 6, 2008. FIG. 15 shows a fluid handling circuit 5 for a well 10 undergoing underbalanced drilling using a dual top drive system DH according to the present invention. The circuit 5 connects a wellbore outlet 15 to a wellbore inlet 20. A fluid feed line 25 is connected to the well inlet 20 for supplying the liquid portion of the drilling fluid. The drilling fluid is urged down the drill string and out of the drill bit. The wellbore inlet 20 may optionally include a gas supply 30 for providing gas used to lighten the drilling fluid at any desired time during operation, such as in the beginning of the operation, intermittently during operation, or continuously during operation. Fluid returning from the wellbore annulus 35 (“return fluid”) exits the wellbore outlet 15 and is directed to a primary separator 110 e.g. as disclosed in U.S. Pat. No. 5,857,522 which is incorporated herein by reference in its entirety. The wellstream is processed in the separator 110 to produced separate streams of solid, oil, liquid, and gas.

Generally, the return fluid entering into the separator 110 passes to a first stage of the separator 110. Solids (sludge), such as drilled cuttings, present in the return fluid are removed in the first stage by gravity forces that are aided by centrifugal action of a device (not shown) disposed in the separator 110. The device is capable of separating the solids from the return fluid and is known in the art. Because solids are heavier than the remaining fluids, the solids collect at the bottom of the separator 110 and are removed therefrom through line 85. The remaining return fluid is substantially free of solids when it passes to a second stage.

The present invention provides improvements to the subject matter of U.S. Pat. No. 7,270,189. In one aspect systems according to the present invention have two top drives, each with: a quill; a swivel including a swivel housing and a swivel bearing therein in which the quill is supported; a drive system for applying torque to the quill; and with, regarding at least one of the top drives, link arm hangers extending from the swivel housing and formed to accept and retain link arms.

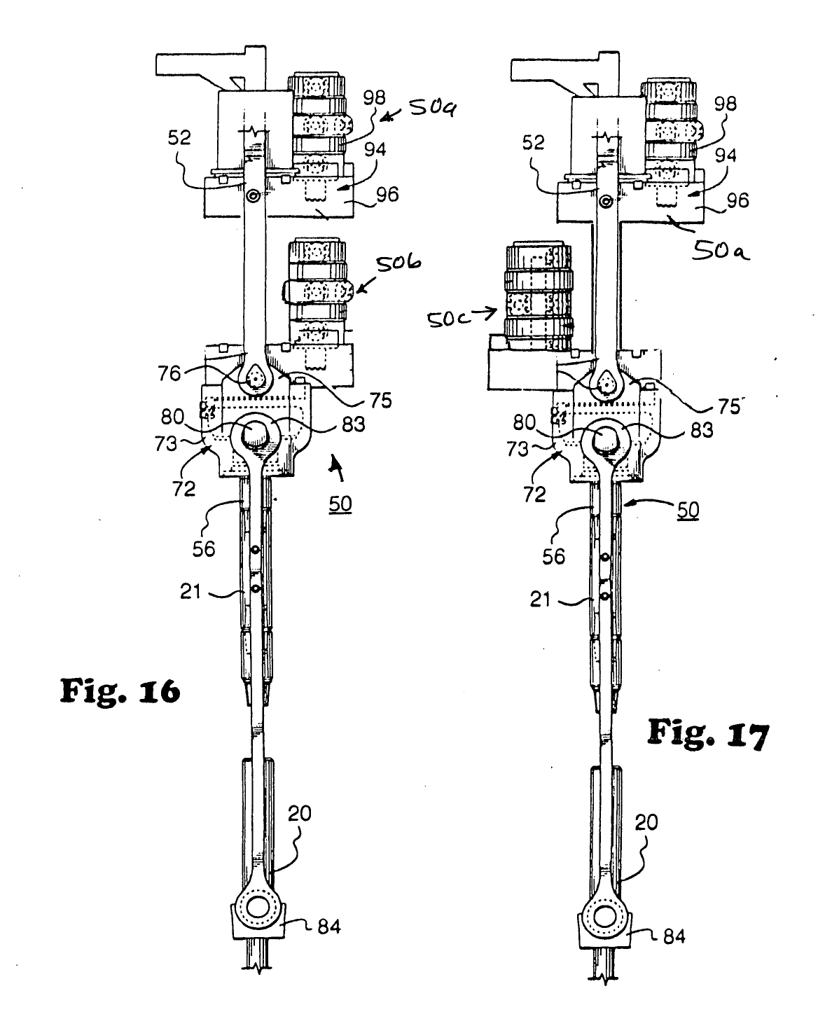

A top drive assembly 50 according to the present invention as shown in FIG. 16 may be supported from a hook in a rig (not shown) by use of a hoisting apparatus such as links 52, a bail, etc. and may be stabilized by a bracket (not shown) for connection to a torque track.

Top drive assembly 50 has two top drives 50a and 50b. For operation to manipulate a wellbore string further parts such as a grabber, link arms 82 and a torque and drive system 94 may be provided and installed. A quill 56 extends from the top drive 50b downwardly for connection directly or indirectly to the wellbore string 20. For example, in the illustrated embodiment, the quill has connected thereto a sub string 21, which in turn connects directly or indirectly to the wellbore string. Of course, other configurations may be possible such as, for example, including casing clamps, actuators, valves, etc. Wellbore string 20 may be one or more joints of pipe such as, for example, any of drill pipe, drill collar, casing or a wellbore liner.

The top drive assembly 50 further includes a swivel 72, including a housing 73 containing a swivel bearing for supporting quill 56 in a manner permitting rotation therein. The swivel also provides connection directly or indirectly to links 52. For example, in the illustrated embodiment, swivel housing 73 has formed thereon devices 75 for accepting pins 76 connecting between the links and the swivel. Of course, other connection arrangements are possible between the top drive hoisting apparatus and the swivel. However, any such connection should be selected with consideration as to the load that must be accommodated therethrough. The top drive assembly 50 also includes link hangers 80 for accepting and retaining link arms 82 and, therethrough, elevators 84. Link hangers 80 form support areas for the link arms. In the illustrated embodiment, the link hangers are hooked extensions over which the eyes 83 of link arms 82 may be hooked. As will be appreciated, a pair of link hangers 80 is usually employed and the link hangers are usually diametrically positioned so that the link arms hang down on either side of the top drive. The swivel 72 and link hangers 80 configuration provide that the link hangers 80 extend from swivel housing 73 rather than from a connection to the quill. Link hangers 71 can be formed or mounted in various ways to extend from the swivel housing. For example, the link hangers can be formed integral with the swivel housing, as shown. Alternately, the link hangers can be connected to the swivel housing by way of welding, bolts or other fasteners, connectors, interlocking arrangements, bearings, etc. Any connection arrangement between the link hangers and the swivel housing, however, must be selected with consideration as to the load that must be accommodated therethrough.

Each top drive 50a, 50b includes a torque and drive system 94 for applying torque to the quill. In the illustrated embodiment, for example, each torque and drive system includes a gear box 96 in a concentric or eccentric configuration and any of various types of motors 98. Torque and drive system 94 may be positioned in various locations on the top drives, for example above or below the swivel, to drive the quill. As such, the torque and drive system is out of the way so that the quill and the link arms do not have to be formed to accommodate the system 94.

Torque and drive system 94 may be connected permanently or detachably into the top drives. For example, the gearbox of the system is detachably connected to a support surface on swivel 72 via a connector and bolts. This detachable connection permits the torque and drive system to be removed from the top drives for repair or replacement, for example, for selection to meet desired operational parameters. In one embodiment, the drive assembly connects to the quill via a spline or another drive interface.

As shown in FIG. 17, the top drive 50b is deleted and a top drive 50c is used which is offset from the top drive 50a for balance and/or for nullifying or reducing reactive torque from the top drive 50a.

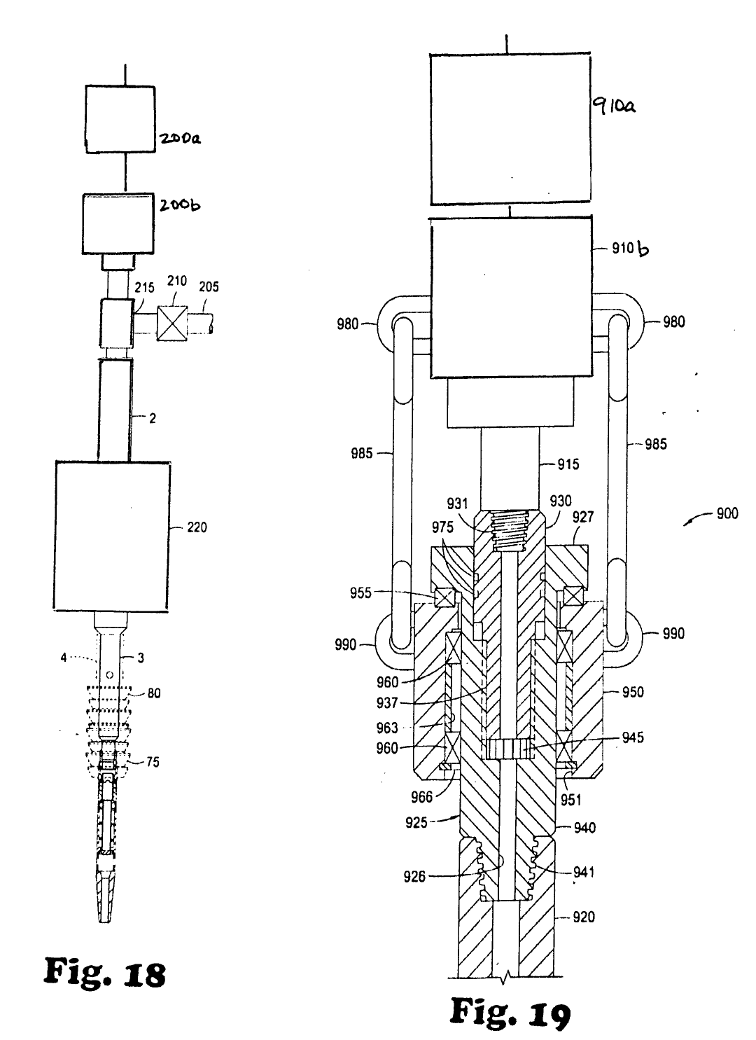

The present invention provides improvements to the subject matter of U.S. patent application Ser. No. 11/932,769 filed Oct. 31, 2007. As shown in FIG. 18 a system according to the present invention using the circulation/cementing tool 2 has two top drives 200a and 200b connected, preferably threadedly connected, to the tool 2. The top drives are typically suspended from a draw works (not shown) with cable bails (not shown) and disposed on tracks (not shown) which allow longitudinal movement of the top drives, and thus, longitudinal movement of the connected tool 2. The top drives perform the function of rotating the tool 2 during the drilling operation; therefore, the tool 2 is rotatable relative to the top drives. The tool 2, however, is preferably axially fixed relative to the top drives so that the draw works (not shown) may be used to lift or lower the top drive 200 longitudinally, thus lifting or lowering the tool 2 therewith.

A cement line 205 extends through a port 215 running through the tool 2. A physically alterable bonding material, preferably a setting fluid such as cement, is selectively introduced through the cement line 205 and into the tool 2 through selective operation of a check valve 210. When it is desired to introduce cement into the tool 2, such as during the cementing operation, the check valve 210 is manipulated into an open position. When it is desired to prevent cement introduction into the tool 2, such as during the drilling operation (using the dual top drives) when circulation fluid rather than cement is circulated through the tool 2, the check valve 210 is closed. Placing the cement line 205 below the top drives allows the cement to bypass the top drives during the cementing operation, thus preventing possible damage to the top drives.

A torque head 220 is rigidly connected to the tool 2. The torque head 220 is used to grippingly and sealingly engage the casing. In the alternative, a spear 6 may be used to grippingly and sealing engage the casing. The torque head 220 imparts torque to the casing from the top drives (or selectively from one of the top drives) by grippingly engaging the casing. The torque head 220 rotates with the tool 2 relative to the top drives. The tool 2 runs through the torque head 220. A lower portion of the tool 2 is shown located below the torque head 220. The solid lines indicate the circulating/cementing tool 2 with a circulating head 3 placed thereon. The dotted lines indicate the tool 2 with the cementing head 4 placed thereon. When drilling with the casing, the circulating head 3 is placed at the lower portion of the tool 2 to circulate drilling fluid. When a cementing operation is to be conducted, the cementing head 4 is placed at the lower portion of the tool 2. The circulating head 3 may be connected, preferably threadedly connected, to a lower portion of a packer mandrel, so that to replace the circulating head 3 with the cementing head 4, the circulating head 3 must merely be unscrewed. The cementing head 4 may then be threadedly connected to the packer mandrel. In the same way, the cementing head 4 may be unscrewed, then the circulating head 3 threaded onto the packer mandrel, depending upon the function which the tool 2 is to perform.

Any gripping mechanism capable of grippingly and sealingly engaging an outer or inner diameter of casing is suitable for use with the tool 2.

As shown in FIG. 19 a system according to the present invention has a dual top drive system according to the present invention with top drives 910a and 910b. An isolator adapter 900 may be coupled to the top drive 910b to isolate tensile load from the quill 915 of the top drives as shown in FIG. 19. The isolator adapter 900 may also transfer torque to a drilling apparatus 920 attached therebelow. It is understood that the drilling apparatus 920 may include any suitable apparatus typically attached to a top drive, including, but not limited to, a torque head, a spear, and a joint compensator, as well as tubulars such as casing and drill pipe, as is known to a person of ordinary skill in the art. A track system (not shown) may be included with the system of FIG. 19 that rides on the rails (or any other non-rotating member) of the top drives (or any other non-rotating body) connected to the isolator body 950 to oppose the reactionary torque transmitted through the bearings 955 and 960. The isolator adapter 900 includes a torque body 925 concentrically disposed in the isolator body 950. The torque body 925 defines an upper body 930 at least partially disposed in a lower body 940. The upper body 930 is coupled to the lower body 940 using a spline and groove connection 937. Any suitable spline and groove assembly known to a person of ordinary skill in the art. A section of the spline and groove on the lower body is shown as 945. An upper portion of the torque body 925 includes a first coupling 931 for connection to the quill 915 and a lower portion includes a second coupling 941 for connection to the drilling apparatus 920. In one embodiment, the first and second couplings 931, 941 are threaded connections. The second coupling 941 may have a larger threaded connection than the first coupling 931. The torque body 925 defines a bore 926 therethrough for fluid communication between the top drives and the drilling apparatus 920. One or more seals 975 may be disposed between the upper body 930 and the torque body 925 to prevent leakage.

The isolator body 950 defines an annular member having a central opening 951 therethrough. The torque body 925 is co-axially disposed through the central opening 951 of the isolator body 950. The isolator body 950 is operatively coupled to the top drives using at least two bails 985. One end of the bails 985 is connected to the hooks or eyes 980 of the top drive 910, while the other end is connected to the attachment members 990 of the isolator body 950.

The isolator adapter 900 may further include one or more bearing assemblies 955, 960 for coupling the torque body 925 to the isolator body 950. As shown in FIG. 19, a thrust bearing assembly 955 may be disposed between a flange 927 of the torque body 925 and the isolator body 950. The thrust bearing assembly 955 is adapted and designed to transfer tensile or thrust load from the torque body 925 to the isolator body 950. The thrust bearing assembly 955 may include any suitable bearing assembly, such as a roller bearing assembly, or load transferring apparatus known to a person of ordinary skill in the art.

One or more radial bearing assemblies 960 may be disposed in the annular area between the torque body 925 and the isolator body 950. The radial bearing assemblies 960 are adapted and designed to facilitate the rotation of the torque body 925 relative to the isolator body 950. As shown, the radial bearing assemblies 960 may be separated by a spacer 963. A snap ring 966 or any other suitable retaining means is used to retain the bearing assemblies 960 in the isolator body 950. It is understood that a bearing assembly acting as both a thrust and radial bearing, such as the bearing assembly described in the above elevator embodiment, may be used without deviating from the aspects of the present invention.

In operation, the isolator adapter 900 is disposed between the top drives and the drilling apparatus 920. The upper body 930 is connected to the quill 915, while the lower body 940 is connected to the drilling apparatus 920. The isolator body 950 is operatively connected to the top drives using the bails 985. Because the bails 985 are a predetermined length, the spline and groove connection 937 allows the upper body 930 to move axially relative to the lower body 940 in order to compensate for the axial distance required to threadedly connect the upper body 930 to the top drive 910. Once connected, the tensile load of the drilling apparatus 920 is transferred to the lower body 940, which, in turn, transfers the load to the isolator body 950 via the thrust bearing assembly 955. The tensile load is ultimately transferred to the bails 985. In this respect, the tensile load is isolated from the quill 915 of the top drives. Optionally, in another aspect, a universal joint (not shown) may be added between the quill thread 931 and the body 930 to allow connection of the pipe to the thread 941 and/or to allow the gripping device (not shown) to grip the casing or pipe when located off the well center.

The isolator adapter 900 may also transmit torque from the top drives to the drilling apparatus 920. The torque is initially transferred from the quill 915 to the upper body 930 through the threaded connection 931. Thereafter, the torque is transferred to the lower body 940 via the spline and groove connection 937. The lower body 940 then transfers the torque to the drilling apparatus 920 by a threaded connection 941, thereby rotating the drilling apparatus 920.

The present invention provides improvements to the subject matter of U.S. Pat. No. 7,617,866. In one aspect, a dual top drive system according to the present invention includes two top drives and a connection apparatus for coupling a lower one of the top drives to a tubular gripping member, the connection apparatus including: a body having a first joint coupled to the lower top drive and a second joint coupled to the tubular gripping member, wherein the body is adapted to allow fluid communication between the lower top drive and the tubular gripping member and to allow relative movement between the lower top drive and the tubular gripping member. In another embodiment, there is provided a method for facilitating the connection of tubulars using a dual top drive system according to the present invention, the method including the steps of attaching a tool to a lower top drive of a dual top drive system using a supporting member and adjusting the supporting member to cause the tool to be displaced horizontally relative to the lower top drive.

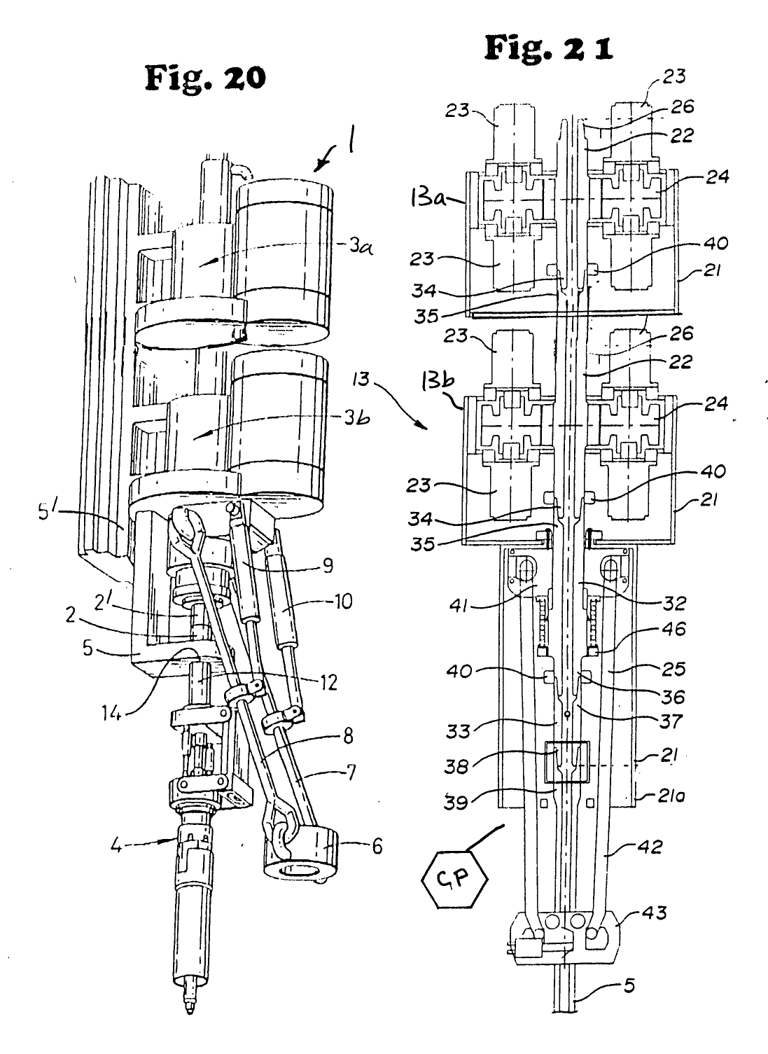

FIG. 20 shows an apparatus according to the present invention which is generally identified by reference numeral 1. The apparatus 1 depends from a rotor 2′ of a lower top drive 3b beneath an upper top drive 3a. A tool 4 for gripping a tubular depends from the lower end of the apparatus 1. A rigid guide member 5 is provided to guide the rotor 2 of the apparatus 1. The rigid guide member 5 is fast with a stator 5′ of the top drive 3. The rotor 2′ of the top drive 3 is coupled by a threaded connection to the rotor 2 of the apparatus 1. The rigid guide member 5 may be provided with a clamp for clamping the rotor 2 of the apparatus 1 so that the threaded connection to the rotor 2′ of the lower top drive 3b can be made, after which the clamp would be released. An elevator 6 is provided on the end of bails 7, 8 which are hung from the lower top drive 3b. Piston and cylinders 9, 10 are arranged between the bails 7, 8 and the lower top drive 3b for moving the elevator 6 from below the lower top drive 3b to an out of the way position.

In use, a tubular may be gripped by the tool 4 and lowered into close proximity with a tubular string held in a spider. The tubular 40 may then be rotated to obtain a partial connection or be held in alignment with an additional tool. The top drives 3a and 3b may then be used to torque the connection up to a predetermined torque to complete the connection.

The present invention provides improvement to the subject matter of U.S. Pat. No. 5,433,279. As shown in FIG. 21, a control panel CP, located, e.g., on the rig floor, provides a combination of hydraulic, air and electric control of top drive rotational speed (rpm), direction of rotation, pipe handling and other features disclosed later in the description. The control panel CP also provides rpm limit and torque limit controls for avoiding situations such as over-speed in case of drill string failure and over-torquing of joints. The control panel may be disconnected from the air, electric and hydraulic lines with quick connectors for shipping.

As shown in FIG. 21 a top drive unit 13 has two top drives 13a and 13b each with a structural housing 21, within which is positioned a tubular drive shaft 22, hydraulic drive motors 23, and an oil bath gearbox 24. A centrally located drive shaft 22 is vertically oriented and is adapted at its upper end 26 to thread into a swivel, typically by threaded means directly or by an adapter shaft (not shown). The hollow drive shaft 22 can transport drilling fluids introduced through a fluid coupling forming part of the swivel. The drive shaft 22 projects through the gearboxes 24 and is fitted with an external main gear. In each top drive four bi-directional rotary hydraulic vane motors 23 are mounted to the gearbox 24, parallel to and offset from the drive shaft 22, to rotationally drive pinion gears which mesh with the main gear, imparting the required rotational torque. Low speed vane motors 23 are used to produce high torque at low speed without the need for large, speed reducing gearboxes and their associated bulk weight; this results in a more compact, lighter top drive unit; but any suitable motors may be used.

The housings 21 employ upper and lower thrust bearings 30, 31 on the drive shaft 22 to transmit the weight of the top drive unit 13, and it's associated, attached components, to the drive shaft 22 and thus to a hoisting apparatus.

The drive shaft 22 supports a drill string 5 through intermediary shafts comprising a load collar sub 32 and a kelly saver sub 33. Together they make up a drive shaft assembly. A kelly cock may be optionally included in combination with the saver sub 33. The lower end connection 38 of the saver sub 33 is adapted to thread into the upper end connection 39 of the drill string 5 in use. The saver sub lower end connection 38 is regularly connected and disconnected from the upper end connection 39 of the drill string 5 during rig operation. The hoisting loads of the drill string 5 are transferred through the saver sub 33, the load collar sub 32 and the drive shaft 22 to the hoisting apparatus, avoiding loading of the top drive housing 21. To prevent the drive shaft-to-load collar sub threaded connections 34, 35 and the load collar sub-to-saver sub threaded connections 36, 37 from unthreading during operation of the top drive, locking clamps 40 are used.

The present invention provides improvements to the subject matter of U.S. Pat. No. 6,412,576.

In certain embodiments the present invention provides dual top drive systems including: a vertically extending tower supporting two top drive main bodies, each main body defining a main body passage extending therethrough, each top drive for driving a drill string and each top drive having driving mechanism rotatably positioned within a main body passage, mechanism passage adapted to allow travel of drill pipe therethrough; the drill string drive mechanisms rotatable in relation to a main body and adapted to drive a drill string; and a hollow core stem positioned in each drive mechanism passage and having a connecting member connecting the hollow core stem to the drill string drive mechanism, a first end extending into a mechanism passage and positioned for connection to the drill string, and a second end adapted for connection to a mud line assembly. Such systems may include: a drawworks positioned to provide vertical movement of said main body; and/or a pipe stand.

The present invention provides a top drive system with two top drive assemblies, each top drive assembly having a main body defining a main body passage extending therethrough, and a drive mechanism defining a drive mechanism passage through the main body passage; with each drive mechanism rotatably positioned within a main body passage, and each drive mechanism passage adapted to allow travel of drill pipe therethrough; a drilling fluid line assembly with a drilling fluid line connector; and a core stem defining a core stem passage therethrough, the core stem having a first end extending into a drive mechanism passage and a second end, the core stem removably positioned within the drive mechanism passage, with the first end adapted for connection to a drill string and the second end adapted for connection to the drilling fluid line connector, the core stem adapted to be rotated by the drive mechanisms, and the core stem adapted to drive rotation of said drill string.

The present invention provides a method for drilling a well, the method including: passing a drill pipe through a mechanism passage of drilling apparatus which includes two top drives each with part of the mechanism passage, the apparatus having a main body defining a main body passage extending therethrough, a drill string drive mechanism rotatably positioned within the main body passage, the mechanism defines a mechanism passage through the main body passage, and the mechanism passage is adapted to allow travel of drill pipe therethrough, the mechanism adapted to rotate in relation to the main body, the mechanism adapted to be driven by a motor, and the mechanism adapted to drive a drill string; connecting drill pipe to the drill string; connecting the drill string to the drive mechanism; rotating the drill string using both top drives or using the top drives alternately into the well hole; and disconnecting the drill string and the drive mechanism.

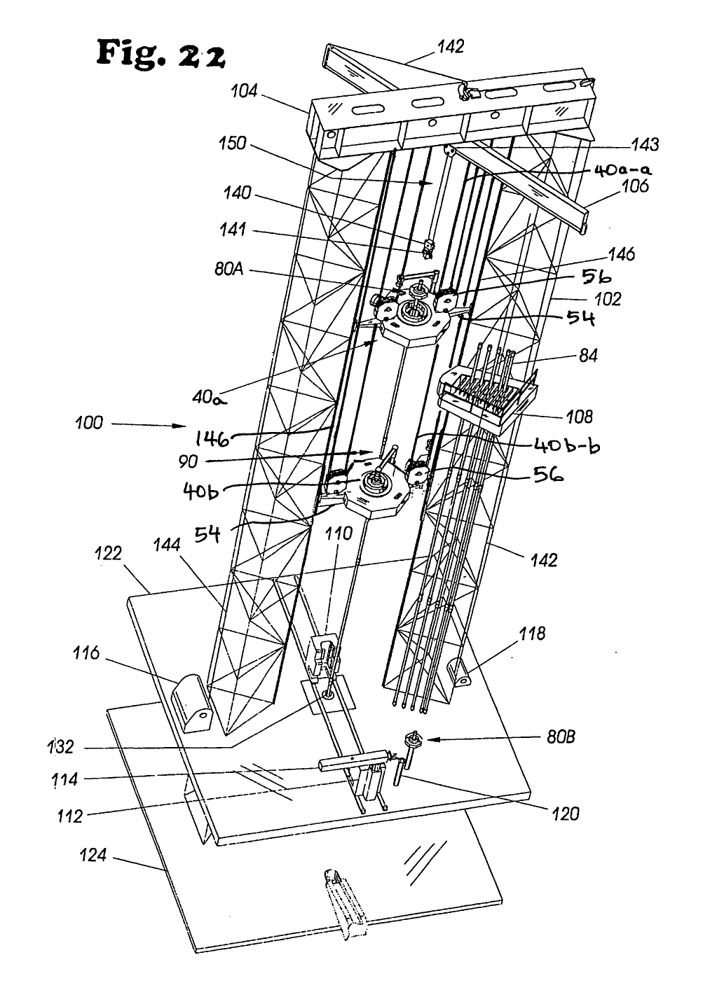

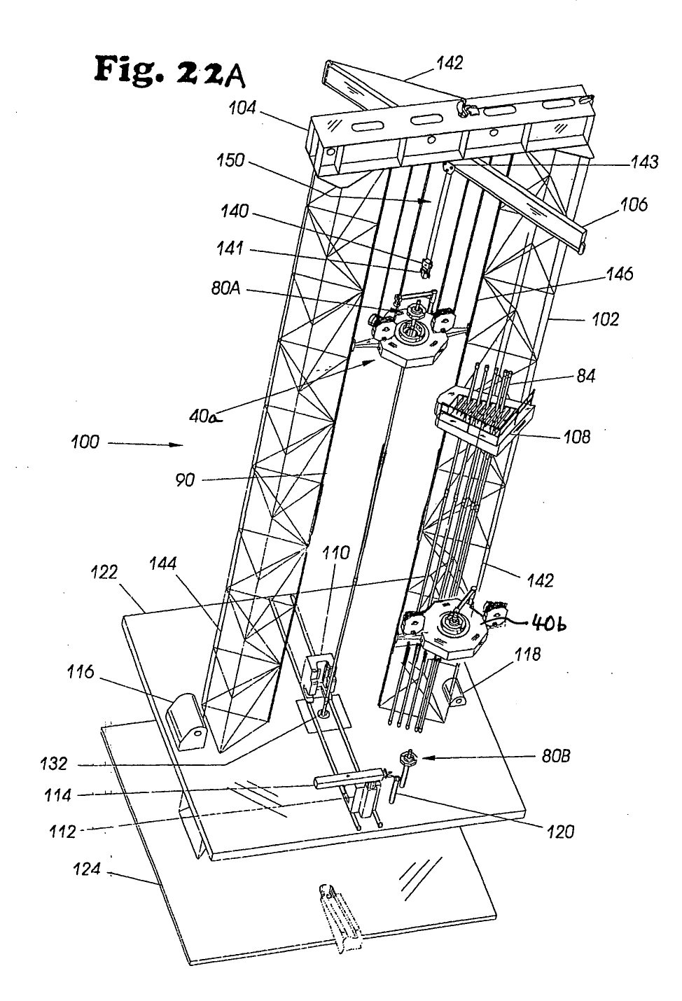

Referring now to FIG. 22, there is shown a view, of one embodiment of the present invention. While the top drives depicted in FIG. 22 are O-shaped or ring-shaped, this is not intended to exclude embodiments having other shapes. It should also be understood the passage or channel for passing drilling tubulars therethrough, may or may not be fully enclosed. For example, non-limiting examples of top drive shapes defining open channels include C-shaped or U-shaped embodiments, which operate in a similar manner to the O-shaped embodiment.

Referring now to FIG. 22, top drives 40a and 40b have a main body structure defining a main body passage extending therethough. These main body structures have a drive mechanism positioned within a main body passage. A drive mechanism in each top drive has a drive mechanism passage extending therethrough and a motor by which each drive mechanism is powered (see U.S. Pat. No. 6,412,576 for such structures and components). Motors are known to those in the art and the present invention is not limited to a specific type of motor known now or in the future. This invention is also not limited to a single motor, as a plurality of motors may also be used. The motors are connected to drive mechanism by a transmission means such as, for example, gearing, chain, or belts. The transmissions may be located within the main body structures. It should be noted that transmissions or means to couple and connect motors to drive mechanisms to provide torque and rotation are known to those in the art and the present invention is not limited to a specific type of transmission.

The top drives 40a and 40b have mud line connection piping. Mud is a drilling fluid that is pumped into the well bore to aid in removal of cuttings. Mud line connection piping may receive mud or drilling fluid from a mud pump by means, such as, for example, through the standpipe and rotary hose). Mud line piping can be mounted at any location so long as drilling fluid can be properly supplied for the drilling process.

Each top drive 40a and 40b has two guide and counter-torque arms 54 and guide trolleys 56. The purpose of guide and counter-torque arms 54 and guide trolleys 56 are for positioning and guiding the top drives during vertical movement, and also for resisting the counter-torque produced when the top drives are rotating and drilling. While this embodiment depicts two arms, it is possible for the top drives to have one or any number of arms or extensions and guide trolleys to guide and resist the counter-torque of top drives. Guide and counter-torque arms or methods for positioning, guiding, and resisting counter-torque for top drives are known to those in the art and the present invention is not limited to a specific type of positioning, guiding, and resisting counter-torque known now or in the future.

Each top drive 40a and 40b has a means 40a-a, 40b-b, respectively, for raising and lowering it in a derrick or mast structure. This may be accomplished by use of two sheave blocks. Conventional terminology refers to this two sheave block arrangement as a split traveling block. However, the methods and apparatus for raising and lowering an object such as a top drive in a derrick or mast type structure are known to those in the art, such as, for example, hydraulic cylinders or single wirelines. The present invention is not limited to a specific apparatus or method for raising and lowering the top drive, and requires only that the space directly above the drill string is not obstructed.

As shown in FIG. 22, a drilling rig 100 has two towers 102 which may be smaller (in width and depth) in comparison to the single, large tower of a conventional derrick. It should be understood that the present invention is not limited to the twin-tower type of derrick structure shown and can utilize all types of derrick and mast structures, including the conventional single tower structure. Also, although towers 102 are depicted as having a triangular cross sectional shape, other tower shapes are possible such as, for example, X-shaped, I-shaped, H-shaped, cylindrical shaped, square-shaped, polygon-shaped, or any combination thereof. The towers 102 are connected at the top by a crossover beam 104. In this embodiment crossover beam 104 also functions as the structural framework for the split crown block. The crown block sheaves are located within crossover beam 104.

The drilling system of the present invention has a pipe handling system 150. Pipe handling systems handle, move, rack, and make up: joints and stands of drill pipe and tubulars. Pipe handling systems for existing conventional and non-conventional drilling rigs generally fall within three categories: (1) manual systems, (2) semi-automated, (3) fully automated. Pipe handling systems for the present invention can also fall within the same three categories.

The major components of pipe handling system 150 shown are: auxiliary hoist block 140, auxiliary hoist elevator 141, auxiliary hoist travel beam 106, auxiliary hoist winch 118, and auxiliary hoist wireline 142. Examples of pipe handling operations include, but are not limited to: handling, moving, and racking stands of pipe and drilling tubulars; and, making up and breaking down stands of pipe and drilling tubulars. Auxiliary hoist elevator 141 is connected to auxiliary hoist block 140. Auxiliary hoist block 140 is connected to auxiliary hoist trolley 143 by means of auxiliary hoist wireline 142. Auxiliary hoist trolley 143 is mounted to and travels along the lower flange of auxiliary hoist travel beam 106. Auxiliary hoist travel beam 106 is mounted below crossover beam 104 and is capable of pivoting about the centerline of well, as indicated by dashed lines 30 and 31. Regardless of the angle of rotation of auxiliary hoist travel beam 106, auxiliary hoist block 140 can always be positioned over, or travel to, the centerline of well.

The function of auxiliary hoist elevator 141 is for safely connecting to a joint of pipe, stand of pipe, drilling tubular, or tubulars for the purpose of handling or moving the connected items. It should be understood that auxiliary hoist elevator 141 is not limited to a specific size, style, or type of elevator. It should also be understood that auxiliary hoist elevator 141 is not limited to specific mode of control, such as, manual, remote, semi-automated, or automated. Also elevators (or clamps that grip a joint of casing, tubing, drill collars, or drill pipe) are well known to those in the art and the present invention is not limited to a specific type of elevator known now or in the future.

It should also be understood that the present invention is not limited to the pipe handling system embodiment shown (auxiliary pipe handling system 150). The present invention can work with any type and style of pipe handling system that is able to operate and work in conjunction with the top drive unit of the present invention. Pipe handling systems are well known to those in the art and the present invention is not limited to a specific type of pipe handling system known now or in the future.

At the edge of each tower 102 that is closest to well hole 127 is a guide track 146 that runs from the rig floor 122 to crossover beam 104 located at the top of the towers. A guide trolley 56 for each top drive runs in each track to position, guide, and to resist the re-active counter-torque of the top drives during drilling procedures. Also means to guide, position, and resist the counter-torque of the top drive are known to those in the art and the present invention is not limited to a specific type or means of guiding, positioning, and resisting the counter-torque of the top drive known now or in the future.

Slips 132 are for holding drill string 90 while making and breaking drill string pipe connections. Core stem stands 120 are for holding core stem 80 when it is not in use. Fingerboard stand rack 108 is for holding stands of pipe 84. A lower level 124 is the level below rig floor 122 and on land rigs would generally be the ground level. Mechanical arm 114 is for moving and handling core stem 80. Drawworks 116 is for vertically raising and lowering top drive 40 by means of wireline 144.

With core stem 80 lowered and positioned in the drive mechanisms, and with mud line connection piping connected to core stem 80, the top drives 40a, 40b are able to function and operate. Non-limiting examples of drilling parameters include the type of drill bit, the rotational speed of the drill string, the weight on the drill bit, the drilling fluid or mud composition, mud flow, and mud pressure. Also with the present invention, it should be noted that drilling could be conducted during the entire procedure of making up a stand of pipe 84.

The top drive 40b may be pivotably connected to the derrick or mast and may (see FIG. 22A) be moved out of the way of the top drive 40a.

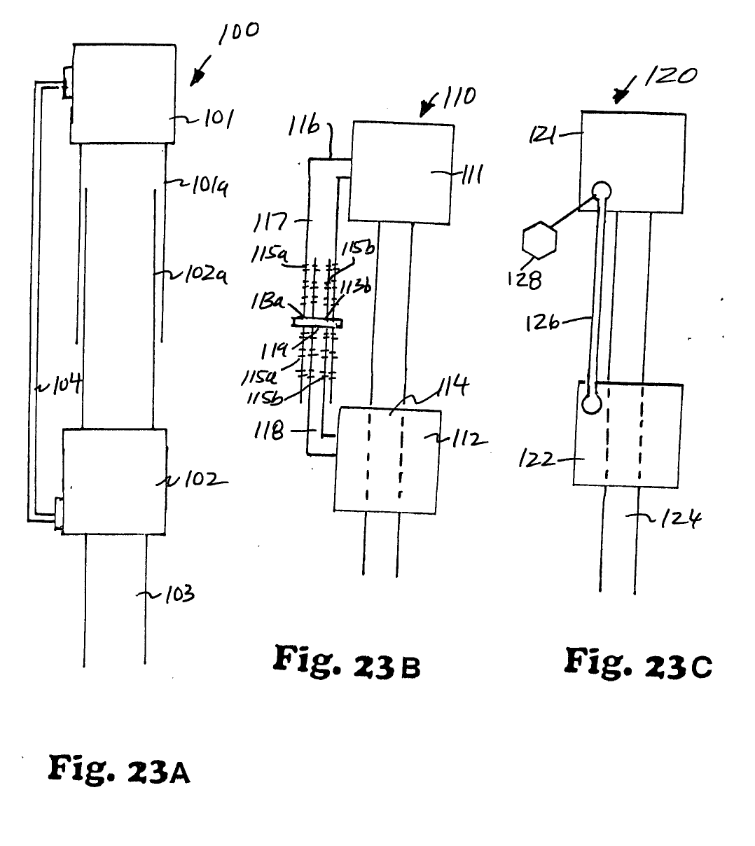

FIG. 23A shows schematically a top drive system 100 according to the present invention which has two top drives 101, 102. An extendable/retractable drive structure between the two top drives includes a part 101a driven by the top drive 101 and a meshing part 102a connected to the top drive 102. The parts 101a, 102a can move vertically with respect to each other while the top drives are rotating a tubular. Optionally releasable holding member 104 holds the top drives at a pre-set distance apart. Removal of the member 104 allows the top drives to move with respect to each other. A drive shaft 103 projects from the top drive 102 and is drivingly connected to the part 102a.

FIG. 23B shows schematically a dual top drive system 110 according to the present invention with two top drives 111, 112, which drive a drive shaft 114. As shown, the two top drives are held apart a pre-selected distance by an adjustable connector 116 which has an upper part 117 connected to the top drive 111 and a lower part 118 connected to the lower top drive 112. A removable pin 119 through appropriate holes 113a, 113b holds the parts 117, 118 together. By removing the pin 119, moving the top drives, and replacing the pin in other pairs of holes 115a, 115b the spacing of the top drives may be adjusted.

FIG. 23C shows schematically a top drive system 120 according to the present invention which has two top drives 121, 122 which drive a drive shaft 124. A controlled releasable connector 126 holds the two top drives spaced-apart by a pre-selected distance. A control system 128 controls the connector 126 and can signal he connector 126 to disconnect thereby freeing the top drives for movement toward or away from each other (as the top drives in FIGS. 23A, 23B can move toward or away from each other when holders or connectors are disengaged).

The present invention provides dual top drive systems which are used with tubular running systems and with continuous circulation systems. The present invention provides improvements to the subject matter of U.S. patent application Ser. No. 12/288,724 filed Oct. 22, 2008.

The present invention provides a tubular running system having a dual top drive system according to the present invention and a running tool system for running wellbore tubulars, a tubular handling system connected to the running tool system, the tubular handling system having two arms comprising two spaced-apart extensible arms extendable in length and movable toward and away from the running tool system, anti-rotation apparatus for selectively preventing the tubular handling system from rotating with respect to the running tool system. In such a system the tubulars may be casing, tubing, drill pipe, or risers.

The present invention provides a method for running tubulars, the method including engaging a tubular with a joint engagement apparatus of a tubular running system, the tubular running system having a running tool system for running wellbore tubulars, a joint handling system connected to the running tool system, and the joint handling system having two spaced-apart extensible arms movable toward and away from the running tool system with the joint engagement apparatus connected to the arms for releasably engaging a tubular to be moved with respect to the running tool system, moving the tubular to the running tool system with the joint handling system, and selectively preventing the tubular handling system from rotating with the running tool system; a drive system connected to and above the running tool system; and the drive system is a top drive system according to the present invention for wellbore operations.

The prior art discloses a wide variety of wellbore tubular running systems, including, but not limited to, those disclosed in U.S. Pat. Nos. 6,443,241; 6,637,526; 6,691,801; 6,688,394; 6,779,599; 3,915,244; 6,588,509; 5,577,566; 6,315,051; and 6,591,916, all incorporated fully herein for all purposes. The prior art discloses a variety of tubular handling apparatuses, e.g., those disclosed in U.S. Pat. Nos. 6,527,493; 6,920,926; 4,878,546; 4,126,348; 4,458,768; 6,494,273; 6,073,699; 5,755,289; and 7,013,759, all incorporated fully herein.

The present invention discloses, in certain aspects, a tubular running system which includes: a tubular running tool (e.g., but not limited to, a casing running tool and a pipe running tool); a drive system (a dual top drive system according to the present invention); and a joint handling system connected between the running tool and the top drive system. In certain particular aspects the joint handling system is a single joint system located between a running tool and a top drive. In other aspects, multiples (e.g. doubles or triples of tubulars) are handled.

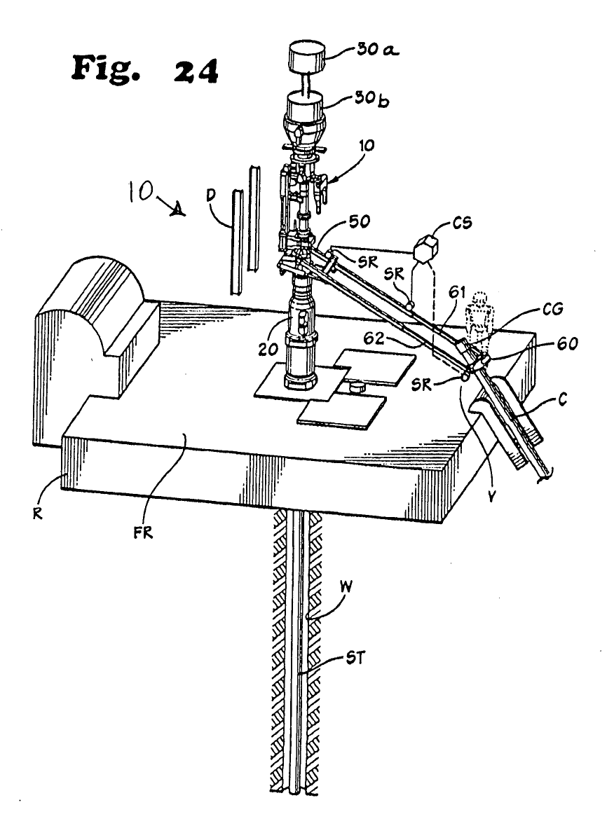

FIG. 24 shows a system 10 according to the present invention which includes a tubular running tool system 20; a dual top drive system 30 (which includes top drives 30a, 30b); and a single joint handling system 50 according to the present invention. The tubular running system 20 may be any suitable known tubular running tool apparatus and, in one particular aspect, is a casing running tool system, e.g., but not limited to, a known casing running tool Model CRT 14 as is commercially available from National Oilwell Varco. Optionally a drive system is used with an upper IBOP and a lower IBOP.

FIG. 24 illustrates a method according to the present invention using a system 10 according to the present invention to move casing on a rig R (e.g. a typical drilling rig system) above a wellbore W. As shown the drive system 30 has been lowered and the arms 61, 62 have been extended toward a piece or joint of casing C in the V-door area V of the rig R having a rig floor FR. The elevator 60 is latched onto the piece or joint of casing C below a coupling CG of the casing C. Such a step is used in adding a joint of casing to a casing string either during the typical casing of an already-drilled bore or in a casing-drilling operations. Sensors SR (shown schematically) indicate to a control system CS (e.g. as described in U.S. application Ser. No. 12/288,724 filed Oct. 22, 2008) the extent of extension of the arms 61, 62; the angle of beams of the system 50 with respect to the system 20; and the latch status of an elevator 60. The top drives 30a, 30b are connected to and movable with respect to the derrick D.

The present invention provides improvements to the subject matter of U.S. patent application Ser. No. 11/176,976 filed Jul. 7, 2005.

Certain known continuous circulation systems are proposed in U.S. Pat. No. 6,412,554 which attempt continuous fluid circulation during the drilling operation, and in which rotation of the drill string is stopped and re-started in order to make and break tubular connections. U.S. Published Patent Application No. 0030221519 published Dec. 4, 2003 (U.S. Ser. No. 38/2,080, filed: Mar. 5, 2003) discloses an apparatus that permits sections of tubulars to be connected to or disconnected from a string of pipe during a drilling operation.

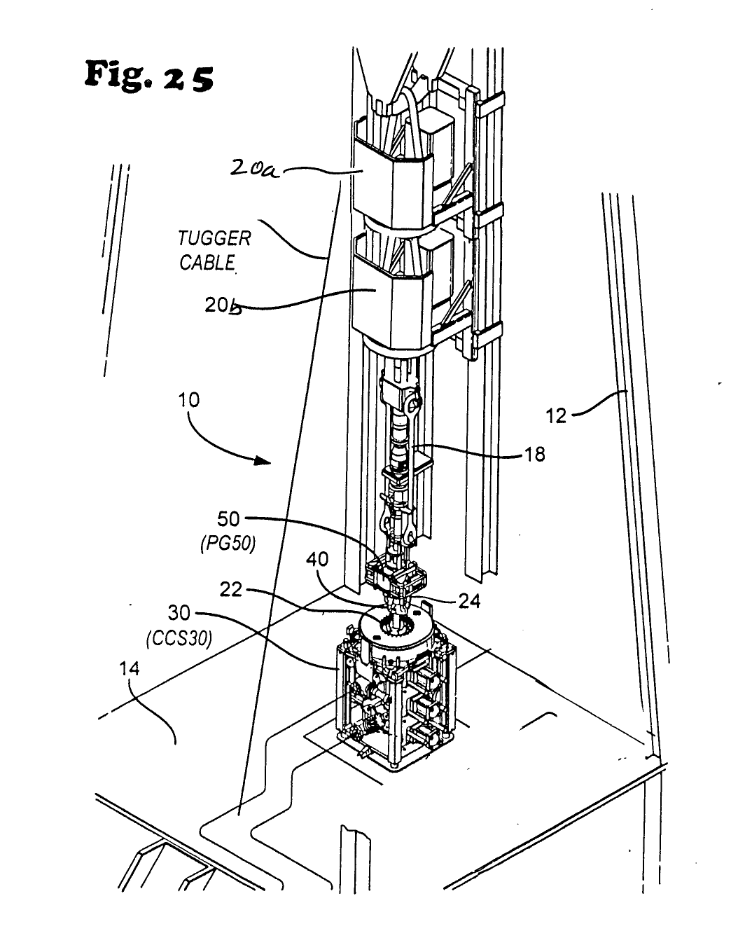

FIG. 25 shows a top drive drilling system 10 according to the present invention which includes two top drive drilling units 20a, 20b suspended in a derrick 12 with a floor 14. A continuous circulation system 30 (“CCS 30”) rests on a rig floor 14 and part of a saver sub 22 projects up from the CCS 30. The saver sub 22 is connected to and rotated by the top drives. The CCS 30 is any known continuous circulation system.

An elevator 40 is suspended below the top drives. Optionally, a pipe gripper 50 (“PG 50”) is suspended from the top drives and the elevator 40 is suspended from the PG 50. Any suitable known pipe gripper may be used for the pipe gripper 50 e.g. one as disclosed in the U.S. patent application Ser. No. 10/999,815 filed Nov. 30, 2004. The PG 50 is suspended from the top drives with links 18 and the elevator 40 is suspended from the PG 50 with links 24.

With respect to any of the systems according to the present invention disclosed above or below as improvements of a patent referenced by patent number, the full disclosures of those patents are incorporated herein by reference for all purposes and like numerals and items in these drawings and in this text like the numerals of items in those patents designate like parts or structures. It is to be understood that any dual top drive system according to the present invention shown schematically in the drawings herein may be any suitable dual top drive system according to the present invention disclosed herein; and that any system according to the present invention in any embodiment hereof may be used with any suitable control system disclosed herein.

FIG. 26A illustrates schematically a dual top drive system 150 according to the present invention which has an upper top drive 151 above a lower top drive 152. As shown to the right of the upper top drive 151, when this top drive is rotating a tubular T to the right, clockwise as seen in FIG. 26B, a reaction torque in the opposite direction is created as indicated by the arrow A. The generated rotational force is applied to the tubular T. A torque reactor 151R reacts the reaction torque through the torque shaft 151T to the rig floor RF of a rig (not shown).

As shown to the right of the lower top drive 152, when this top drive is rotating the tubular T to the right, clockwise as seen in FIG. 26B, a reaction torque in the opposite direction is created as indicated by the arrow B. The generated rotational force is applied to the tubular T. A torque reactor 152R reacts the reaction torque through the torque shaft 152T to the rig floor RF of a rig (not shown).

As shown in FIG. 26B, the reaction torques generated by the two top drives are opposite to each other and reduce or eliminate the reaction torque total effect. Such reduction or elimination occurs with or without the torque reactors 151R, 152R (which is within the scope of the present invention). A balanced application of rotative force to the tubular T—achievable with such a system according to the present invention—reduces stress and strain to the rig, to rig components, and to equipment.

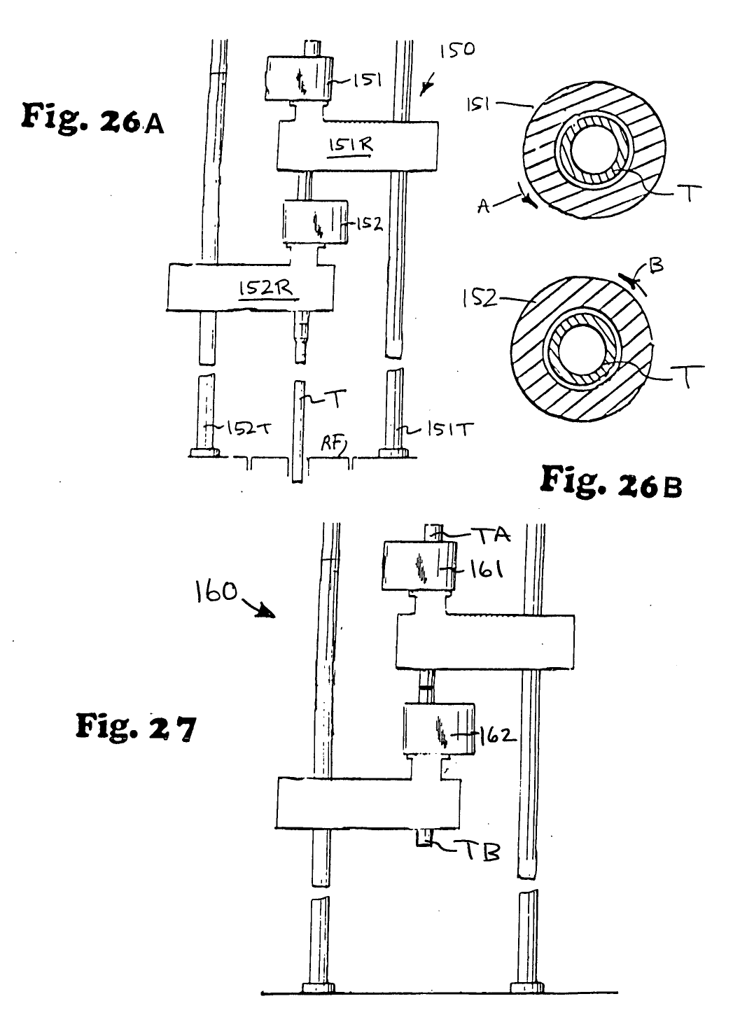

FIG. 27 illustrates a dual top drive system 160 according to the present invention for making-up a joint of two tubulars TA and TB (or for breaking out the joint). An upper top drive 161 rotates the tubular TA in one direction while a lower top drive 162 either holds the tubular TB or rotates it in an opposite direction to that of the rotation of the tubular TA. Although FIG. 27 shows the two top drives opposed to each other, any two top drives of any system according to the present invention may be used to make-up joints or to break out joints. Also, such operations according to the present invention may be at well center or away from well center.

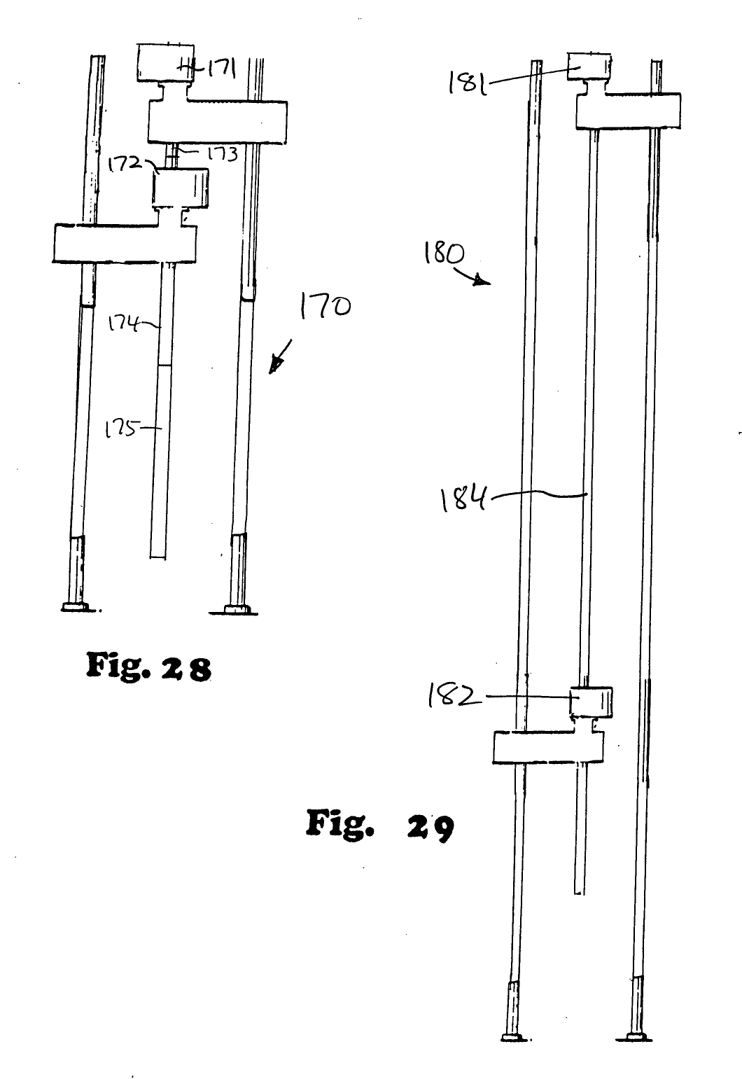

As shown in FIG. 28, a dual top drive system according to the present invention may be used to make up multiples or stands of tubulars. As shown a top drive 171 is rotating a tubular 173 to engage it with an already made-up double which has tubulars 174, 175 (previously threadedly connected together). Such formation of multiples according to the present invention can be done at well center or away from well center and any dual top drive system according to the present invention may be used to accomplish the formation of multiples.

FIG. 29 illustrates a system 180 according to the present invention which has an upper top drive 181 and a lower top drive 182. These top drives are acting on a tubular apparatus 184 which may be a single tubular or a multiple (e.g. two or three tubulars connected together or to be broken out). With a single top drive acting (with other equipment, apparatuses or devices holding the tubular apparatus at some point below the single top drive) the tubular apparatus can tend to move, bend, vibrate, and/or sway laterally more than when, as shown, a lower top drive acting beneath an upper top drive holds and/or also rotates the tubular apparatus. Such reduction in unwanted tubular apparatus movement is desirable.

The present invention provides drilling control for controlling a dual top drive drilling system. In certain aspects, such systems and methods are improvements of the subject matter of U.S. Pat. No. 7,172,037. In one aspect, a drilling control system according to the present invention is provided which produces advisory actions for optimal drilling with a dual top drive system. Such a system or model can utilize downhole dynamics data and surface drilling parameters, to produce drilling models used to provide to a human operator with recommended drilling parameters for optimized performance. In another aspect, the output of the drilling control system is directly linked with rig instrumentation systems so as to provide a closed-loop automated drilling control system that optimizes drilling while taking into account the downhole dynamic behavior and surface parameters. The drilling models can be either static or dynamic. In one embodiment, the simulation of the drilling process uses neural networks to estimate some nonlinear function using the examples of input-output relations produced by the drilling process.

In one aspect, system according to the present invention for forming a wellbore in a subterranean formation includes (a) a dual top drive drilling system including two top drives [as in any dual top drive system disclosed herein], a rig supporting the two top drives and positioned at a surface location, a drill string conveyed into the wellbore by the rig, the drill string having a bottomhole assembly (BHA) attached at an end thereof, and a plurality of sensors associated with the drilling system for measuring surface responses and downhole responses of the drilling system during drilling; and (b) a controller operatively coupled to the drilling system and including at least one model for predicting behavior of the drilling system, the controller utilizing the at least one model, the measured surface and downhole responses and at least one selected control parameter to predict behavior of the drilling system and to determine at least one advice parameter that produces at least one selected optimized drilling parameter while satisfying at least one selected constraint.

In one aspect, system according to the present invention a method for forming a wellbore in a subterranean formation includes: (a) providing a dual top drive drilling system (any as disclosed herein according to the present invention) including a rig supporting the two top drives and positioned at a surface location, a drill string conveyed into the wellbore by the rig, the drill string having a bottomhole assembly (BHA) attached at an end thereof, (b) measuring surface responses and downhole responses of the drilling system during drilling using a plurality of sensors; and (c) determining at least one advice parameter that produces at least one selected optimized drilling parameter while satisfying at least one selected constraint using a controller, the controller making the determination using at least one model for predicting behavior of the drilling system, at least one selected control parameter, and the measured surface and downhole responses, wherein the controller includes a neural network.

This invention provides a control system that in one aspect uses a neural network for predictive control for drilling optimization when using a dual top drive system in which one or both top drives are operationally involved in drilling operations. The system can operate on-line during drilling of wellbores. The system acquires surface and downhole data and generates quantitative advice for drilling parameters (optimal, weight-on-bit, rotary speed, etc.) for the driller or for automated-closed-loop drilling. The system may utilize a real-time telemetry link between an MWD sub and the surface to transfer data or the data may be stored downhole of later use. Data from offset wells can be used successfully to describe the characteristics of the formation being drilled and the upcoming formation. The relationship between these formation parameters and the dynamic measurements may be utilized in real-time or investigated off-line, once the dynamics information is retrieved at the surface. Such a scenario may be likely, when there is substantial time-delay in getting MWD information to surface. The data can be processed downhole with models stored in the MWD and used in real-time, to alter, at least some of the drilling parameters. In another aspect, the present invention, while a dual top drive system is employed, provides advice and/or intelligent control for a drilling system for forming a wellbore in a subterranean formation. An exemplary drilling system includes a rig supporting two top drives and positioned at a surface location and a drill string conveyed into the wellbore by the rig. The drill string has a bottomhole assembly (BHA) attached at an end thereof. A plurality of sensors distributed throughout the drilling system for measure surface responses and downhole responses of the drilling system during drilling. Exemplary surface responses include oscillations of torque, surface torque, hook load, oscillations of hook load, RPM of the drill string, and rate-of-penetration. Exemplary downhole responses include drill string vibration, BHA vibration, weight-on-bit, RPM of the drill bit, drill bit RPM variations, and torque at the drill bit. In some arrangements, the measured downhole responses are preprocessed and decimated by a downhole tool (e.g., MWD tool or downhole processor and transmitted uphole via a suitable telemetry system.

In one aspect, the present invention describes a system with two top drives that provides advisory actions for optimal drilling. Such a system is referred to herein as an “Advisor.” The “Advisor” system utilizes downhole dynamics data and surface drilling parameters, to produce drilling models that provide a human operator (or “Driller”) with recommended drilling parameters for optimized performance. In another aspect, the present invention provided a system and method wherein the output of an “Advisor” system is directly linked with rig instrumentation systems so as to provide a closed-loop automated drilling control system (“DCS”), that optimizes drilling while taking into account the downhole dynamic behavior and surface parameters. The “Advisor” can provide recommendations for drilling simultaneously with both top drives operational; for drilling with only one of the top drives; for alternating the use of the top drives; and for using the top drives in sequence or alternately to reduce torque loadings and/or vibrations of the drillstring. Preferably, the drilling control system has close interaction with a drilling contractor and a rig instrumentation provider (e.g., the development of a “man safe” system with well understood failure behavioral modes). Also, links are provided to hole cleaning and annular pressure calculations so as to ensure an annulus of the well is not overloaded with cuttings. Thus, embodiments made in accordance with the present invention can, in one mode, help an operator or driller optimize the performance of a rig and, in another mode, be self-controlling with an override by the Driller.

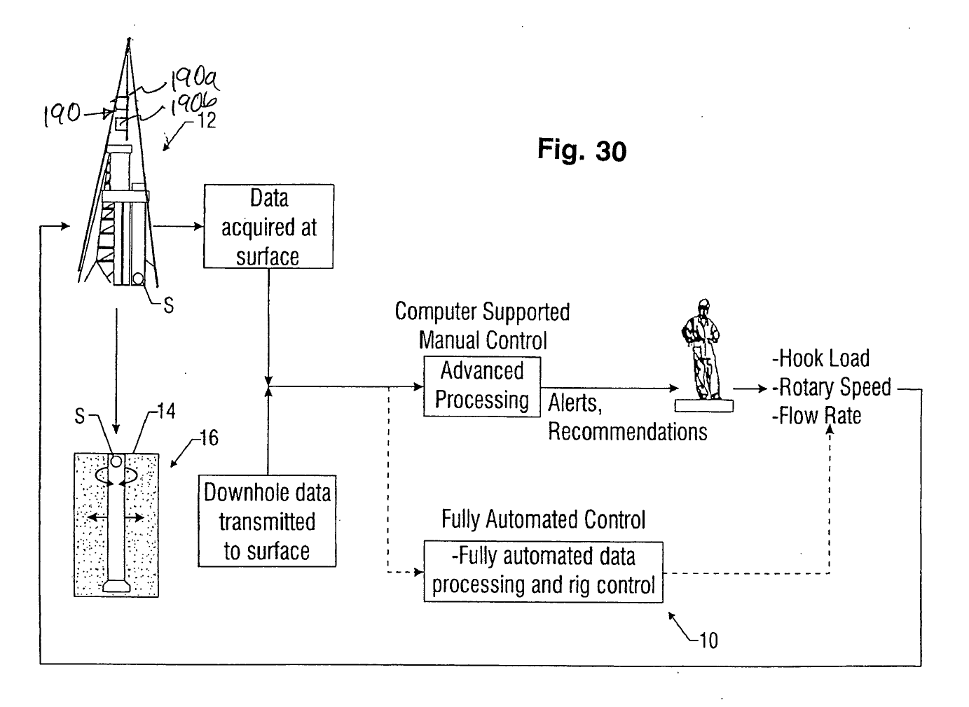

Referring to FIG. 30, there is shown in flow chart for the control and data flow for a drilling control system 10 made in accordance with the present invention. A rig 12 which supports a dual top drive system 190 according to the present invention with two top drives 190a and 190b at the surface and a bottomhole assembly (BHA) 14 in a well 16 are provided with sensors (not shown) that measure selected parameters of interest. These measurements are transmitted via a suitable telemetry system to the drilling control system 10. In an exemplary deployment, a system engineer or a Driller or an operator (“operator”) inputs or dials acceptable vibration levels into the Drilling Control System 10 and requests the system 10 to keep control parameters within optimal ranges that fall within user defined end points (operating norms). Minimum and maximum acceptable values for WOB, RPM and Torque, and for various types of vibration (lateral, axial and torsional) are specified. Tolerance of highly undesirable occurrences, such as whirl, bit bounce, stick-slip and, to some degree, torsional oscillation, are set at a number approaching zero. In one aspect, this invention aims at obtaining the optimum drilling parameters (for example weight-on-bit (WOB), drillbit rotation per minute (RPM), fluid flow rate, fluid density, bottom hole pressure, etc.) to produce the optimum rate-of-penetration while drilling, while using one or both top drives 190a and/or 190b. The optimum rate-of-penetration may be less than the maximum rate-of-penetration when damaging vibrations occur or due to other constraints placed on the system, such as a set MWD logging speed.

The present invention provides systems and methods for controlling drill string frictional forces during drilling using a dual top drive system according to the present invention; and it provides improvements to the subject matter of U.S. Pat. No. 7,588,099; including, but not limited to, systems and methods for horizontal drilling. In certain aspects, a system according to the present invention includes two top drives (as in any system according to the preset invention), each top drive having a motor that transmits a torque to a drill string to rotate the drill string, and an automated controller operably connected to the top drive (one controller for both or a separate controller for each top drive) to send at least one command signal to the top drive(s) to initiate the rotation of the drill string. The controller monitors torque feedback signals, indicating that a torque limit on the drill string is exceeded, and/or a turn feedback signals indicating that the drill string is stalled to control the direction of the torque applied to the drill string (by either or by both top drives) when either the torque limit is exceeded or the drill string stalls.

In certain aspects, the present invention provides a drilling system including: a top drive system with two top drives, each top drive with a motor that transmits a torque to a drill string to rotate the drill string; an automated controller (or controllers) operably connected to the top drives, the automated controller(s) being designed to communicate at least one directional command signal to the top drive(s) to initiate the direction of the rotation of the drill string; wherein the top drive(s) generate at least one of a torque feedback signal indicating that a torque limit on the drill string is exceeded and a turn feedback signal indicating that the drill string is stalled; wherein the controller receives the at least one feedback signal and reverses the direction of the torque applied to the drill string when either the torque limit is exceeded or the drill string stall; and wherein the automated controller(s) are further designed to communicate at least one speed command signal and one torque limit signal to the top drive(s) to control the speed of the motor and the torque applied by the motor. In such a system and method, the motor can be a DC motor with the automated controller(s) operably connected to a power supply such that the automated controller(s) controls the speed of the electric motor by adjusting the voltage applied to the DC motor, and regulates the torque that can be applied by the DC motor by regulating the current supplied to the DC motor; and the motor controller(s) can generate the torque feedback signal by monitoring the current being supplied to the DC motor. In certain such systems and methods, the motor is an AC motor and the automated controller(s) are operably connected to a power supply such that the automated controller(s) controls the speed and torque of the AC motor by regulating the frequency of the power supplied to the AC motor; and optionally the motor controller(s) can generate the torque feedback signal by monitoring the frequency of the power being supplied to the AC motor.

In certain such systems and methods according to the present invention, a turn encoder is included operatively connected to the top drive(s), the turn encoder designed to monitor the rotation of the top drive and generate the turn feedback signal. In certain such systems, a control station is operatively connected to the automated controller and is designed to program the automated controller with the torque limit and the drill string stall limit information; and, in one aspect, the automated controller further includes: a processor having a central processing unit; a memory cache in signal communication with the processor; a bus interface in signal communication with the processor and the top drive(s); and wherein the processor retrieves the at least one command signal from the memory cache and transmits the command signal through the bus interface to the top drive(s), and wherein the top drive(s) generate the torque and turn feedback signals and transmits the feedback signals through the bus interface to the processor which operates on the feedback signals to generate additional command signals in a continuous feedback process.

In certain embodiments of systems and methods according to the present invention, a process is provided for controlling a drilling operation (not limited to horizontal drilling) that includes: commanding a top drive system having two top drives (and as disclosed herein) including a motor to transmit a torque to a drill string to rotate the drill string in a particular direction; generating at least one of a torque feedback signal indicating that a torque limit on the drill string is exceeded and a turn feedback signal indicating that the drill string is stalled; communicating the at least one feedback signal to an automated controller operably connected to the top drive(s), such that the automated controller outputs at least one directional command signal to the top drive(s) to reverse the direction of the torque applied to the drill string when either the torque limit is exceeded or the drill string stalls; and communicating at least one speed command signal and one torque limit signal to the top drive(s) to control the speed of the motor and the torque applied by the motor.

In certain aspects, the present invention provides a dual top drive drilling system having a controller for controlling an oscillation procedure of a drill string, whereby the drill string is rotated in a back and forth motion. In one embodiment, the oscillation is controlled by controlling the top drives (in any mode or manner disclosed herein) reversing the direction of rotation of the drill string each time a torque limit is exceeded and/or when the drilling motor stalls.

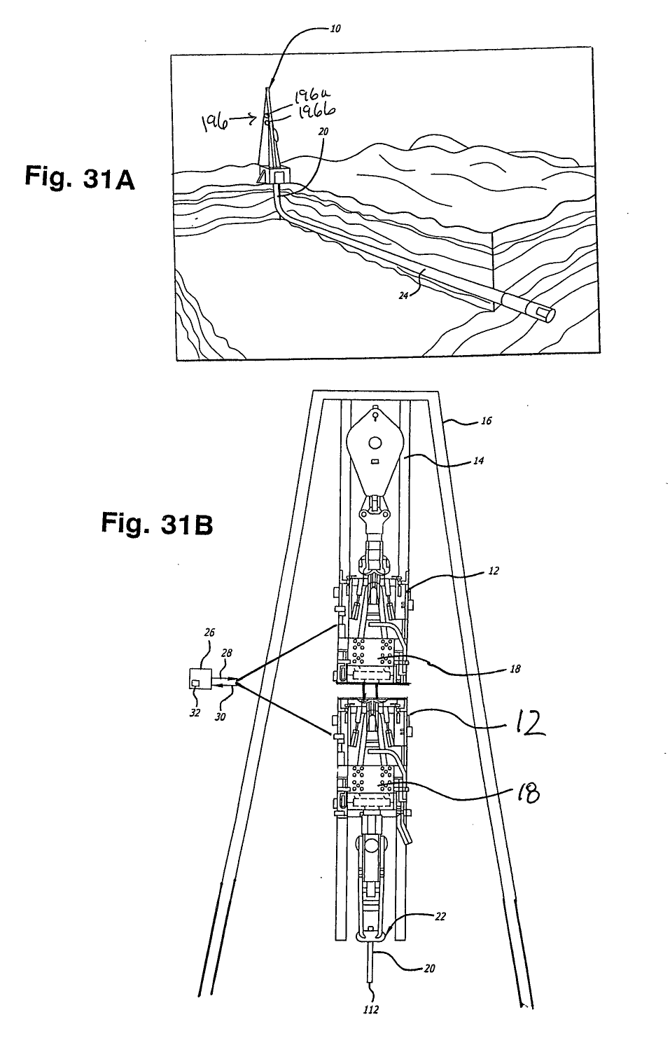

FIG. 31A is a schematic view of a horizontal drilling system 10 in accordance with an exemplary embodiment of the present invention. The system 10 (as shown in FIG. 31A) has a dual top drive system 196 according to the present invention with tip drives 196a and 196b (shown schematically; which may be any two top dives disclosed herein). As shown in FIG. 31B, the drilling system 10 includes a dual top drive system with top drives 12. The top drives 12 are vertically movable along vertical supports 14 of a derrick 16. Each top drive 12 includes a top drive motor 18, which imparts translational and rotational forces to a drill string 20. In one embodiment, the lower top drive 12 is connected to a pipe running tool 22, which in turn is connected to the drill string 20 to transfer the translational and rotational forces from the top drives 12 to the drill string 20. The drill string 20 can include a horizontal segment 24 that produces a horizontal hole during a horizontal drilling operation.

The top drives 12 are operably connected to a controller 26 (optionally, each top drive 12 has its own controller 26). The controller 26 is used to control the top drives 12 during both the drilling phases and the oscillation phases of a horizontal drilling procedure. The top drives 12 receive command signals 28 from the controller 26 and responds to the command signals 28 by generating a torque and a rotational speed that are applied to the drill string 20. During operation, the top drives 12 generate feedback signals 30 that are transmitted to the controller 26. The feedback signals 30 include a torque feed back signal and a rotational feed back signal. The controller 26 uses the feedback signals 30 to monitor the operation of the top drives 12 during both drilling and oscillation procedures. The functions of the controller 26 are specified by a set of programming instructions 32 located in the controller 26.

The drilling system 10 in accordance with an exemplary embodiment of the present invention includes the top drive 12 and the controller 26 as previously described. In addition, the drilling system 10 may include a motor controller 100 operatively connected to each top drive motor 18, which in one embodiment is an electric motor. In one such embodiment, using a DC motor, the motor controller 100 receives high voltage/high current AC power 106 from an AC power supply 108, and transfers the AC power into regulated and controlled DC power for the electric motor 18. The electric motor 18, in turn, receives the DC power and supplies a torque to the top drive(s), which in turn, is transferred to the drill string 20. The motor controller 100 controls the speed of the electric motors 18 by controlling the applied voltage, and regulates the amount of torque that can be applied by the electric motors 18 by regulating the amount of current supplied to the electric motors 18. An AC motor could also be used. In such an embodiment, the controller would regulate the torque and speed of the AC motor by regulating the frequency of the power supplied to the AC motor.

In one embodiment, the electric motors 18 may also be mechanically coupled to a turn encoder which monitors the amount of rotation of the electric motor 18, and sends a rotational feedback signal to the controller(s) 26 when the electric motor 18 has ceased to rotate, or has “stalled.”

The present invention discloses methods and apparatus for MSE-based drilling operation and/or optimization using a dual top drive drilling system according to the present invention. The present invention provided improvements to the subject matter of U.S. patent application Ser. No. 11/952,511 filed on Dec. 7, 2007. Such methods according to the present invention may include detecting MSE parameters, utilizing the MSE parameters to determine MSE, and automatically adjusting drilling operational parameters, including operational parameters of one or of both top drives, as a function of the determined MSE. In one method according to the present invention, an MSE-based dual-top-drive drilling operation includes: drilling through a first interval utilizing a first weight-on-bit (WOB); determining automatically a first MSE corresponding to drilling utilizing the first WOB; drilling through a second interval utilizing a second WOB that is different than the first WOB; determining automatically a second MSE corresponding to drilling utilizing the second WOB; and drilling through a third interval utilizing one of the first WOB and the second WOB which is automatically selected based on an automated comparison of the first MSE and the second MSE.

The present invention provides an apparatus for MSE-based drilling operations using a dual top drive system according to the present invention, including: means for controlling drilling through a first interval utilizing a first weight-on-bit (WOB); means for automatically determining a first MSE corresponding to drilling through the first interval utilizing the first WOB; means for controlling drilling through a second interval utilizing a second WOB that is different than the first WOB; means for automatically determining a second MSE corresponding to drilling through the second interval utilizing the second WOB; means for automatically comparing the first MSE and the second MSE and automatically selecting one of the first WOB and the second WOB as a function of the automated comparison of the first MSE and the second MSE; and means for controlling drilling through a third interval utilizing the automatically selected one of the first WOB and the second WOB.

The present invention provides computer readable media for effecting each method according to the present invention (for all embodiments herein). In one aspect, the present invention provides a program product, including: a computer readable medium; and instructions recorded on the computer readable medium for: controlling drilling with a dual top drive system according to the present invention. For example, in one aspect, drilling with a dual top drive system e.g., through a first interval utilizing a first weight-on-bit (WOB); automatically determining a first MSE corresponding to drilling through the first interval utilizing the first WOB; controlling drilling (by controlling one or both top drives) through a second interval utilizing a second WOB that is different than the first WOB; automatically determining a second MSE corresponding to drilling through the second interval utilizing the second WOB; automatically comparing the first MSE and the second MSE and automatically selecting one of the first WOB and the second WOB as a function of the automated comparison of the first MSE and the second MSE; and controlling drilling (with one or both top drives) through a third interval utilizing the automatically selected one of the first WOB and the second WOB.

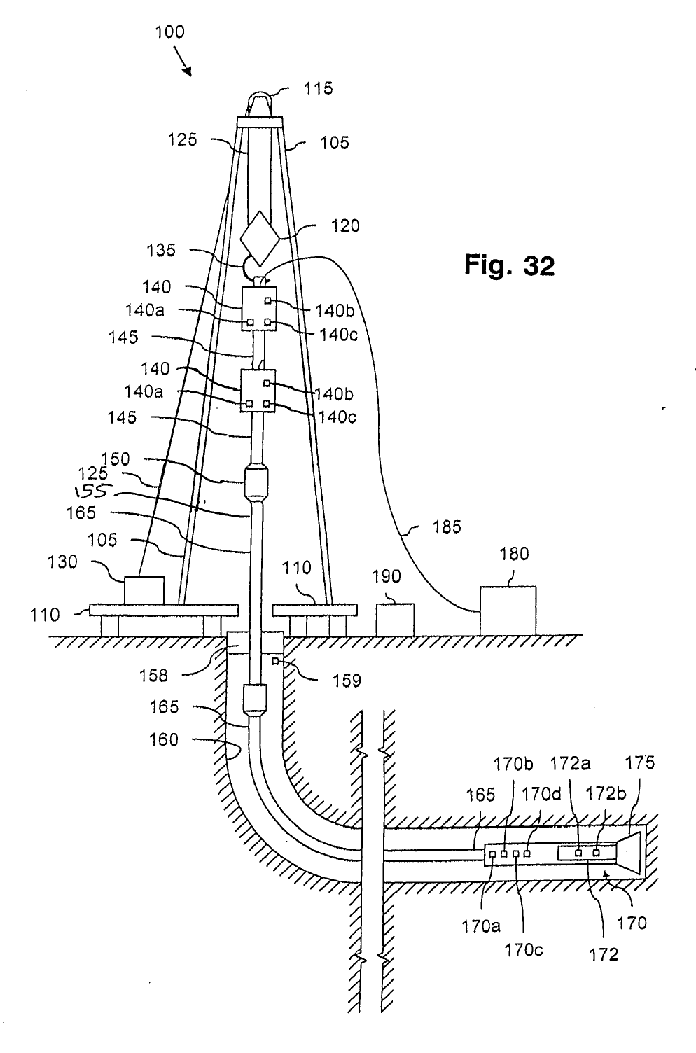

In one aspect, a system according to the present invention is as disclosed in FIG. 32. This disclosure is also related to and incorporates by reference the entirety of U.S. Pat. No. 6,050,348.

FIG. 32 shows illustrated is a schematic view of apparatus 100 according to the present invention. The apparatus 100 is or includes a land-based drilling rig. However, one or more aspects of the present disclosure are applicable or readily adaptable to any type of drilling rig, such as jack-up rigs, semisubmersibles, drill ships, coil tubing rigs, well service rigs adapted for drilling and/or re-entry operations, and casing drilling rigs, among others within the scope of the present disclosure (and any suitable dual top drive system disclosed herein may also be used with these other types of rigs).

The apparatus 100 includes a mast 105 supporting lifting gear above a rig floor 110. The lifting gear includes a crown block 115 and a traveling block 120. The crown block 115 is coupled at or near the top of the mast 105, and the traveling block 120 hangs from the crown block 115 by a drilling line 125. One end of the drilling line 125 extends from the lifting gear to drawworks 130, which is configured to reel out and reel in the drilling line 125 to cause the traveling block 120 to be lowered and raised relative to the rig floor 110. The other end of the drilling line 125, known as a dead line anchor, is anchored to a fixed position, possibly near the drawworks 130 or elsewhere on the rig. A hook 135 is attached to the bottom of the traveling block 120. Two top drives 140 are suspended from the hook 135 (shown schematically; any two suitable top drives disclosed herein may be used). A quill 145 extending from the lower top drive 140 is attached to a saver sub 150, which is attached to a drill string 155 suspended within a wellbore 160. Alternatively, the quill 145 may be attached to the drill string 155 directly. The term “quill” as used herein is not limited to a component which directly extends from a top drive, or which is otherwise conventionally referred to as a quill. For example, within the scope of the present disclosure, the “quill” may additionally or alternatively comprise a main shaft, a drive shaft, an output shaft, and/or another component which transfers torque, position, and/or rotation from a top drive or other rotary driving element to the drill string, at least indirectly (as may be true for any such quill or shaft disclosed or referred to herein). Nonetheless, albeit merely for the sake of clarity and conciseness, these components may be collectively referred to herein as the “quill.”

The drill string 155 includes interconnected sections of drill pipe 165, a bottom hole assembly (BHA) 170, and a drill bit 175. The bottom hole assembly 170 may include stabilizers, drill collars, and/or measurement-while-drilling (MWD) or wireline conveyed instruments, among other components. The drill bit 175, which may also be referred to herein as a tool, is connected to the bottom of the BHA 170 or is otherwise attached to the drill string 155. One or more pumps 180 may deliver drilling fluid to the drill string 155 through a hose or other conduit 185, which may be connected to the top drive 140.

The downhole MWD or wireline conveyed instruments may be configured for the evaluation of physical properties such as pressure, temperature, torque, weight-on-bit (WOB), vibration, inclination, azimuth, toolface orientation in three-dimensional space, and/or other downhole parameters. These measurements may be made downhole, stored in solid-state memory for some time, and downloaded from the instrument(s) at the surface and/or transmitted to the surface. Data transmission methods may include, for example, digitally encoding data and transmitting the encoded data to the surface, possibly as pressure pulses in the drilling fluid or mud system, acoustic transmission through the drill string 155, electronic transmission through a wireline or wired pipe, and/or transmission as electromagnetic pulses. The MWD tools and/or other portions of the BHA 170 may have the ability to store measurements for later retrieval via wireline and/or when the BHA 170 is tripped out of the wellbore 160.

In an exemplary embodiment, the apparatus 100 may also include a rotating blow-out preventer (BOP) 158, such as if the well 160 is being drilled utilizing under-balanced or managed-pressure drilling methods. In such embodiment, the annulus mud and cuttings may be pressurized at the surface, with the actual desired flow and pressure possibly being controlled by a choke system, and the fluid and pressure being retained at the well head and directed down the flow line to the choke by the rotating BOP 158. The apparatus 100 may also include a surface casing annular pressure sensor 159 configured to detect the pressure in the annulus defined between, for example, the wellbore 160 (or casing therein) and the drill string 155.

In the exemplary embodiment depicted in FIG. 32, either or both top drives 140 is/are utilized to impart rotary motion to the drill string 155.

The apparatus 100 also includes a controller 190 configured to control or assist in the control of one or more components of the apparatus 100. For example, the controller 190 may be configured to transmit operational control signals to the drawworks 130, to either or both top drives 140, the BHA 170 and/or the pump 180. The controller 190 may be a stand-alone component installed near the mast 105 and/or other components of the apparatus 100. In an exemplary embodiment, the controller 190 has one or more systems located in a control room proximate the apparatus 100, such as the general purpose shelter often referred to as the “doghouse” serving as a combination tool shed, office, communications center, and general meeting place. The controller 190 may be configured to transmit the operational control signals to the drawworks 130, the top drive s)140, the BHA 170, and/or the pump 180 via wired or wireless transmission means which are not depicted in FIG. 32.

The controller 190 is also configured to receive electronic signals via wired or wireless transmission means from a variety of sensors included in the apparatus 100, where each sensor is configured to detect an operational characteristic or parameter. One such sensor is the surface casing annular pressure sensor 159 described above. The apparatus 100 may include a downhole annular pressure sensor 170a coupled to or otherwise associated with the BHA 170. The downhole annular pressure sensor 170a may be configured to detect a pressure value or range in the annulus-shaped region defined between the external surface of the BHA 170 and the internal diameter of the wellbore 160, which may also be referred to as the casing pressure, downhole casing pressure, MWD casing pressure, or downhole annular pressure.

It is noted that the meaning of the word “detecting,” in the context of all embodiments of the present disclosure, may include detecting, sensing, measuring, calculating, and/or otherwise obtaining data. Similarly, the meaning of the word “detect” in the context of the present disclosure may include detect, sense, measure, calculate, and/or otherwise obtain data.

The apparatus 100 may additionally or alternatively include a shock/vibration sensor 170b that is configured for detecting shock and/or vibration in the BHA 170. The apparatus 100 may additionally or alternatively include a mud motor delta pressure (DELTA P) sensor 172a that is configured to detect a pressure differential value or range across one or more motors 172 of the BHA 170. The one or more motors 172 may each be or include a positive displacement drilling motor that uses hydraulic power of the drilling fluid to drive the bit 175, also known as a mud motor. One or more torque sensors 172b may also be included in the BHA 170 for sending data to the controller 190 that is indicative of the torque applied to the bit 175 by the one or more motors 172.

The apparatus 100 may additionally or alternatively include a toolface sensor 170c configured to detect the current toolface orientation. The toolface sensor 170c may be or include a conventional or future-developed magnetic toolface sensor which detects toolface orientation relative to magnetic north or true north. Alternatively, or additionally, the toolface sensor 170c may be or include a conventional or future-developed gravity toolface sensor which detects toolface orientation relative to the Earth's gravitational field. The toolface sensor 170c may also, or alternatively, be or comprise a conventional or future-developed gyro sensor. The apparatus 100 may additionally or alternatively include a WOB sensor 170d integral to the BHA 170 and configured to detect WOB at or near the BHA 170.

The apparatus 100 may additionally or alternatively include a torque sensor 140a (or two such sensors, one for each top drive) coupled to or otherwise associated with the top drive(s) 140. The torque sensors 140a may alternatively be located in or associated with the BHA 170. The torque sensors 140a may be configured to detect a value or range of the torsion of the quill 145 and/or the drill string 155 (e.g., in response to operational forces acting on the drill string). The top drive(s) 140 may additionally or alternatively include or otherwise be associated with a speed sensor 140b configured to detect a value or range of the rotational speed of the quill 145.

The top drives 140, draw works 130, crown or traveling block, drilling line or dead line anchor may additionally or alternatively include or otherwise be associated with a WOB sensor 140c (e.g., one or more sensors installed somewhere in the load path mechanisms to detect WOB, which can vary from rig-to-rig) different from the WOB sensor 170d. The WOB sensor 140c may be configured to detect a WOB value or range, where such detection may be performed at the top drive 140, draw works 130, or other component of the apparatus 100.

The detection performed by the sensors described herein may be performed once, continuously, periodically, and/or at random intervals. The detection may be manually triggered by an operator or other person accessing a human-machine interface (HMI), or automatically triggered by, for example, a triggering characteristic or parameter satisfying a predetermined condition (e.g., expiration of a time period, drilling progress reaching a predetermined depth, drill bit usage reaching a predetermined amount, etc.). Such sensors and/or other detection means may include one or more interfaces which may be local at the well/rig site or located at another, remote location with a network link to the system.

The present invention provides systems for drilling a cavity in a medium using a dual top drive system according to the present invention. In certain aspects, the present invention provides improvements to the subject matter of U.S. patent application Ser. No. 12/406,528 filed on Mar. 18, 2009. In certain aspects a system according to the present invention may include a drill bit rotated by one or both top drives of a dual top drive system according to the present invention, the top drive(s) operated in any mode or manner described herein, a processor, and a controller. The drill bit may be configured to rotate in the medium and remove at least a portion of the medium. The processor may be configured to receive a first set of data representative of a variable rotational speed of the drill bit during a length of time in the medium, and determine, based at least in part on the first set of data, a first resonant frequency of the variable rotational speed of the drill bit. The controller may be configured to receive a second set of data representative of the first resonant frequency of the variable rotational speed of the drill bit, and vary the force applied to the drill bit, and control either or both top drives, based at least in part on the second set of data.

In certain aspects, the present invention provides a system for drilling a cavity in a medium, wherein the system includes: a drill bit, a dual top drive system for rotating the drill bit, wherein the drill bit is configured to rotate in the medium and remove at least a portion of the medium to at least partially define the cavity; a drillstring coupled with the drill bit and one or both top drives, wherein the drillstring is configured to receive a rotational motion, rotate the drill bit, and apply a force to the drill bit; a processor, wherein the processor is configured to receive a first set of data representative of a variable rotational speed of the drill bit during a length of time in the medium and determine, based at least in part on the first set of data, a first resonant frequency of the variable rotational speed of the drill bit; and a controller, wherein the controller is configured to receive a second set of data representative of the first resonant frequency of the variable rotational speed of the drill bit; and control one or both top drives and to vary the force applied to the drill bit by the drillstring based at least in part on the second set of data.

The present invention provides a method for drilling a cavity in a medium, wherein the method includes: rotating a drill bit in the medium using one or both top drives of a dual top drive system according to the present invention; applying a force to the drill bit; removing at least a portion of the medium to at least partially define the cavity; determining a first set of data based at least in part on the variable rotational speed of the drill bit during a length of time in the medium; determining, based at least in part on the first set of data, a second set of data representative of a first resonant frequency of the variable rotational speed of the drill bit; and controlling either or both top drives and varying the force applied to the drill bit based at least in part on the second set of data.

The present invention provides a system for drilling a cavity in a medium, wherein the system includes: a first means for removing at least a portion of the medium to at least partially define the cavity; a second means for determining a first resonant frequency of a variable rotational speed of the first means; and a third means for varying a force applied to the first means based at least in part on the first resonant frequency (each means as described in U.S. patent application Ser. No. 12/406,527, but with the first means comprising a dual top drive system and a drill bit.

In one embodiment of the invention, a system for drilling a cavity in a medium is provided. The system may include at least one drill bit, a drillstring, a dual top drive system operatively connected to the drillstring for rotating the drill bit, a processor, and a controller. Merely by way of example, the medium into which the cavity may be drilled may be an earthen formation. The cavity may be include vertical, horizontal, straight and/or curved passages with varying cross sectional sizes and possibly shapes. In some embodiments, the drill bit may be configured to rotate in the medium and remove at least a portion of the medium to at least partially define the cavity. Merely by way of example, the drill bit may include differing types of cutters, including solid fixed cutter, a roller-cone cutter, and/or a polycrystalline diamond compact cutter. In some embodiments, snubbers may also be included in the drill bit to alter the characteristics of the drilling process through the medium. Merely by way of example, the drillstring may include a bottomhole assembly and drill pipe or tubing.

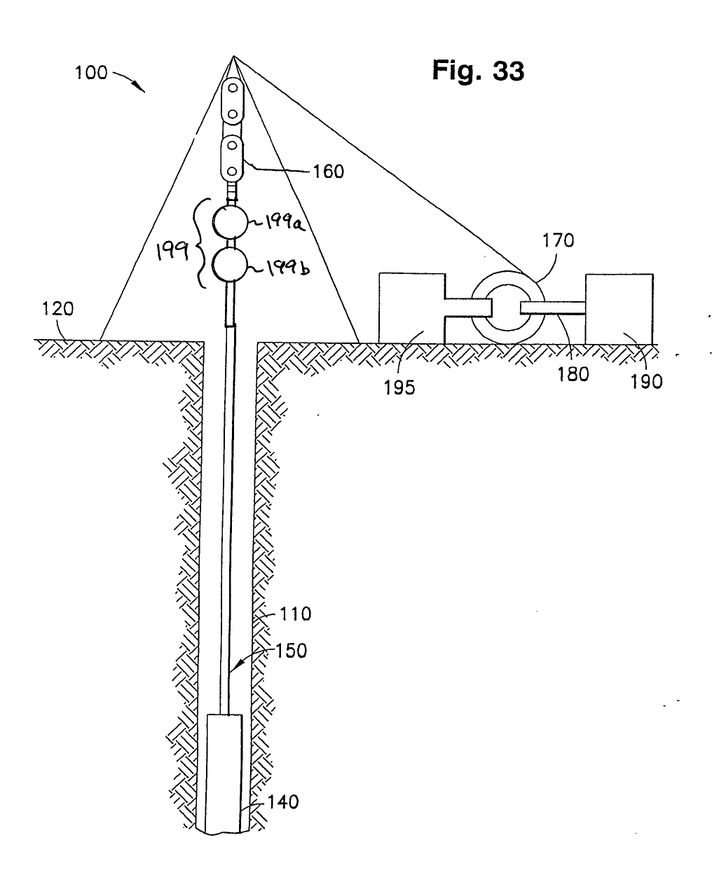

Turning now to FIG. 33, a side view of a system 100 of the invention for drilling a cavity 110 in a medium 120 while preventing torsional resonance, system 100 having a drill bit 130, a bottom hole assembly 140, a drillstring 150, a traveling block 160, a drum 170, a brake 180, and a controller 190. System 100 may also include movement subsystem 195, which may allow for axial movement of drillstring 150 during drilling. In this example, movement subsystem 195 may at least assist in upward and/or downward movement of drillstring 150 during turning of drillstring 150. In some embodiments, movement subsystem 195 may be fully responsible for axial movement (for example, upward and downward movement) of drillstring 150 prior-to, during, and/or after drilling. The drillstring is rotated by one or both top drives 199a, 199b of dual top drive system 199 (any suitable dual top drive system according to the present invention). As the drillstring 150 is rotated, bottomhole assembly 140 and drill bit 130 rotate, removing medium 120 and creating cavity 110. As discussed above, torsional vibration along with stick-slip may occur, causing a reduced rate of drilling depth speed.

Variations in torque may produce rotational oscillations at drill bit 130. Variations in torque may be produced by two primary sources, variations in both the properties of the material, which may be anisotropic, and the amount of weight on the drill bit. The weight on the bit (“WOB”) may be affected by at least the weight of bottomhole assembly 140, the weight of drillstring 150, and the movement of traveling block 160 as controlled by drum 170, brake 180, and controller 190. Because variations in torque may be linear with respect to WOB, variations in WOB may translate proportionally into variations in torque.

The present invention, in certain embodiments, discloses systems and methods for controlling operation of a drilling rig having a control management system, the rig including a dual top drive system according to the present invention, the method including programming the control system with at least one resource module, the at least one resource module having at least one operating model having at least one set of programmed operating rules related to at least one set of operating parameters. In addition, the system and method provide an authenticating hierarchical access to at least one user to the at least one resource module. In certain aspects, the present invention provides improvements to the subject matter of U.S. Pat. No. 6,944,547. In one aspect, a method according to the present invention for controlling operation of a drilling rig having a control system includes: a) for a rig with a dual top drive system, programming a rig control management system with at least one resource module associated with at least one set of operating parameters, said at least one resource module having at least one operating model having at least one set of programmed operating rules related to the at least one set of operating parameters; b) providing an authenticating hierarchical access to at least one user to the at least one resource module; c) allowing said at least one user to input an adjusted value for at least one of the set of operating parameters in the at least one resource module; d) comparing said adjusted value to said at least one set of programmed operating rules and allowing adjustment if said adjusted value is within said operating rules; e) providing an indication if said adjusted value is not within said operating rules; and f) providing a supervisor override to prevent acceptance of said adjusted value.

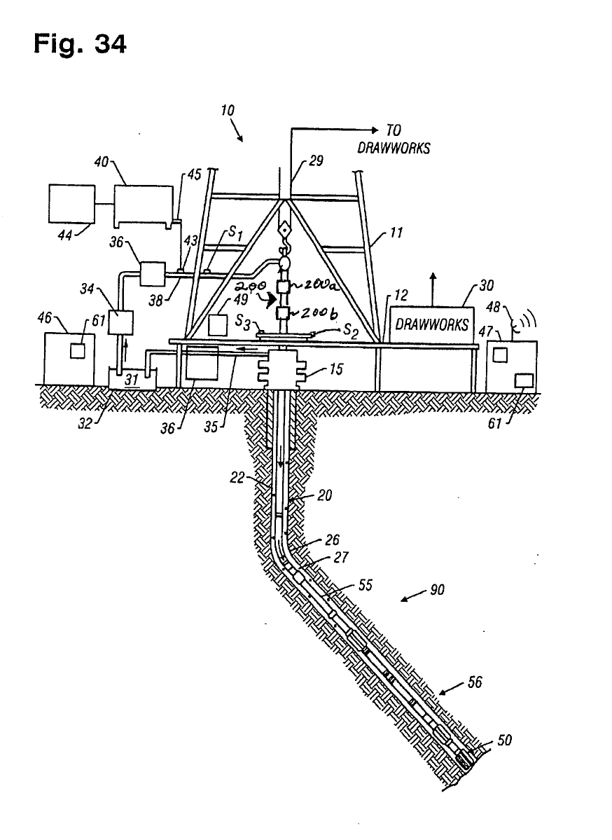

As shown in FIG. 34, in a schematic diagram, an exemplary drilling system 10 having a dual top drive system 200 with top drives 200a, 200b has a drilling assembly 90 shown conveyed in a borehole 26 for drilling the wellbore. The drilling system 10 includes a conventional derrick 11 having a floor 12 which supports the dual top drive system. The drill string 20 includes a drill pipe 22 extending downward through a pressure control device 15 into the borehole 26. The pressure control device 15 is commonly hydraulically powered and may contain sensors (not shown) for detecting operating parameters and controlling the actuation of the pressure control device 15. A drill bit 50, attached to the drill string end, disintegrates the geological formations when it is rotated to drill the borehole 26. The drill string 20 is coupled to a drawworks 30 via a line 29 through a pulley (not shown). During the drilling operation the drawworks 30 is operated to control the weight on bit, which is an important parameter that affects the rate of penetration. The operation of the drawworks 30 is well known in the art and is thus not described in detail herein. The previous description is drawn to a land rig, but the invention as disclosed herein is also equally applicable to any offshore drilling systems.

During drilling operations a suitable drilling fluid 31 from a mud tank (source) 32 is circulated under pressure through the drill string 20 by a mud pump 34. The drilling fluid 31 passes from the mud pump 34 into the drill string 20 via a desurger 36 and fluid line 38. The drilling fluid 31 is discharged at the borehole bottom 51 through an opening in the drill bit 50. The drilling fluid 31 circulates uphole through the annular space 27 between the drill string 20 and the borehole 26 and returns to the mud tank 32 via a solids control system 36 and then through a return line 35. The solids control system may comprise shale shakers, centrifuges, and automated chemical additive systems (not shown), that may contain sensors for controlling various operating parameters, for example centrifuge rpm. Much of the particular equipment is case dependent and is easily determinable for a particular well plan, by one skilled in the art, without undue experimentation.

Various sensors are installed for monitoring the rig systems. For example, a sensor S1 preferably placed in the line 38 provides information about the fluid flow rate. A surface torque sensor S2 and a sensor S3 associated with the drill string 20 respectively provide information about the torque applied by either or by both top drives and the rotational speed of the drill string. Additionally, a sensor (not shown) associated with line 29 is used to provide the hook load of the drill string 20. Additional sensors (not shown) are associated with the motor drive systems to monitor proper drive system operation. These may include, but are not limited to, sensors for detecting such parameters as motor rpm, winding voltage, winding resistance, motor current, and motor temperature. Other sensors (not shown) are used to indicate operation and control of the various solids control equipment. Still other sensors (not shown) are associated with the pressure control equipment to indicate hydraulic system status and operating pressures of the blow out preventer and choke associated with pressure control device 15.

The rig sensor signals, including signals related to operation of the top drives, are input to a control system processor 60 commonly located in the toolpusher's cabin 47 or the operator's cabin 46. Alternatively, the processor 60 may be located at any suitable location on the rig site. The processor 60 may be a computer, mini-computer, or microprocessor for performing programmed instructions. The processor 60 has memory, permanent storage device, and input/output devices. Any memory, permanent storage device, and input/output devices known in the art may be used in the processor 60. The processor 60 is also operably interconnected with the drawworks 30 and other mechanical or hydraulic portions of the drilling system 10 for control of particular parameters of the drilling process. In one exemplary embodiment, the processor 60 comprises an autodriller assembly, of a type known in the art for setting a desired WOB, and other parameters, including parameters related to the operation of the top drives. The processor 60 interprets the signals from the rig sensors and other input data from service contractors and displays various interpreted, status, and alarm information on both tabular and graphical screens on displays 60, 61, and 49. These displays may be adapted to allow user interface and input at the displays 60, 61, 49. A typical interactive graphical user display that can be adapted for use with this system. Multiple display screens, depicting various rig operations, may be available for user call up. Each display console 60, 61, 49 may display a different screen from the other display consoles at the same time. The interpreted and status information may be compared to well plan models to determine if any corrective action is necessary to maintain the current well plan. The models may suggest the appropriate corrective action and request authorization to implement such corrective actions. The interpreted and status information may also be telemetered using hardwired or wireless techniques 48 to remote locations off the well site. For example, the data from the rig site may be monitored from a company home office.

In some applications the drill bit 50 is rotated by only rotating the drill pipe 22, using either or both top drives, in any mode or manner disclosed herein. However, in many other applications, a downhole motor 55 (mud motor) is disposed in the drilling assembly 90 to rotate the drill bit 50 and the drill pipe 22 is rotated by one or by both top drives, e.g., to supplement the rotational power, if required, and to effect changes in the drilling direction. The mud motor 55 rotates the drill bit 50 when the drilling fluid 31 passes through the mud motor 55 under pressure. In either case, the rate of penetration (ROP) of the drill bit 50 into the borehole 26 for a given formation and a drilling assembly largely depends upon the weight on bit and the drill bit rotational speed.

Drilling assembly 90 may contain an MWD and/or LWD assembly that may contain sensors for determining drilling dynamics, directional, and/or formation parameters. The sensed values are commonly transmitted to the surface via a mud pulse transmission scheme known in the art and received by a sensor 43 mounted in line 38. The pressure pulses are detected by circuitry in receiver 40 and the data processed by a receiver processor 44. Alternatively, any suitable telemetry scheme known in the art may be used.

In certain aspects, the present invention discloses methods and apparatuses for drilling directional wellbores using a casing string as a drill stem and a dual top drive system to rotate the drill stem. A retrievable bit is mounted at an end of the casing string and either a mud motor with a bent housing and/or bent sub or a rotary steerable tool is used to direct the bit to drill directionally. The present invention provides improvements to the subject matter of U.S. Pat. No. 6,705,413.

In certain embodiments, the present invention provides methods for directionally drilling a well with a well casing as an elongated tubular drill string, the drill string rotated by one or by both top drives of a dual top drive system (any suitable system according to the present invention) and a drilling assembly retrievable from the lower distal end of the drill string without withdrawing the drill string from a wellbore being formed by the drilling assembly, the method including: providing the casing as the drill string; providing a drilling assembly connected at the distal end of the drill string and being retrievable through the longitudinal bore of the drill string, the drilling assembly including a primary bit and, optionally, a hole enlargement tool; providing a directional borehole drilling assembly connected to the drilling assembly and positioned to act in the well bore below the drill string and including biasing means for applying a force to the drilling assembly to drive it laterally relative to the wellbore, the directional borehole drilling assembly being at least in part retrievable from the wellbore through the longitudinal bore of the drill string; inserting the drill string, the directional borehole drilling assembly and the drilling assembly into the wellbore and driving the drilling assembly with either or both top drives to operate to form a wellbore to a diameter greater than the diameter of the drill string; operating the biasing means to drive the drilling assembly laterally relative to the wellbore; removing at least the primary bit and the hole enlargement tool of the drilling assembly from the distal end of the drill string and moving the at least the primary bit and the hole enlargement tool of the drilling assembly with at least a part of the directional borehole drilling assembly connected thereto out of the wellbore through the drill string without removing the drill string from the wellbore; and leaving the drill string in the wellbore.

In certain aspects, the present invention provides an apparatus for drilling a wellbore in an earth formation having: a drill string having a longitudinal bore therethrough; a dual top drive system for rotating the drill string; a drilling assembly connected at the lower end of the drill string, the drilling assembly selected to be operable to form a borehole and including a primary bit and, optionally, an optional hole enlargement tool, the hole enlargement tool acting to enlarge the wellbore diameter behind the primary bit and the primary bit and the hole enlargement tool being retrievable through the longitudinal bore of the drill string; and a directional borehole drilling assembly connected to the drilling assembly and including biasing means for applying a force to the drilling assembly selected to drive it laterally relative to the wellbore, the directional borehole drilling assembly selected at least in part to be retrievable through the longitudinal bore of the drill string.

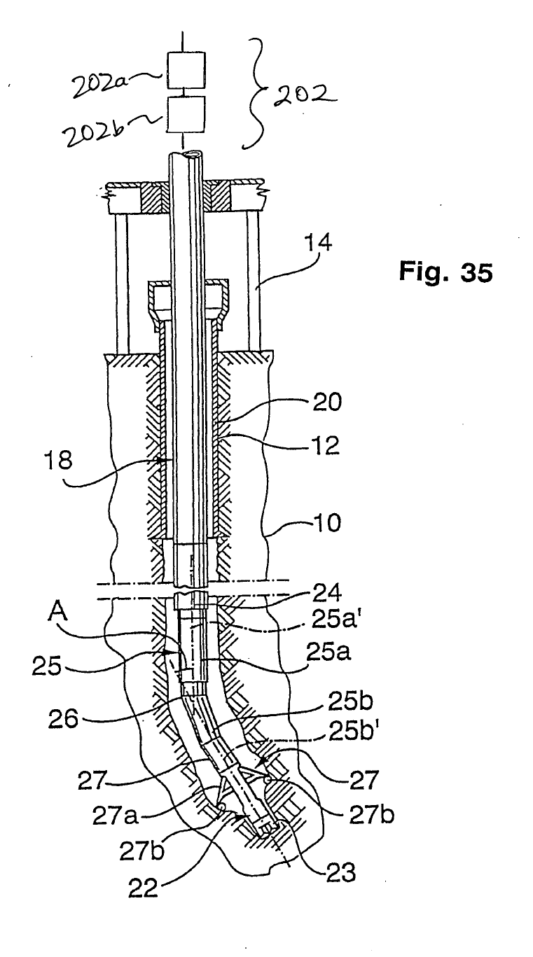

As shown in FIG. 35, in an earth formation 10 a wellbore 12 is being formed by a casing drilling assembly and using a method in accordance with the present invention. Wellbore 12 is formed by a rig 14 (only shown in part) including a top drive system 202 with top drives 202a, 202b (indicating any suitable dual top drive system according to the present invention) and a casing string, generally indicated at 18. Casing string 18 is made up of joints of pipe threaded together end to end using, for example, conventional casing threads or high strength threads. Wellbore 12 is shown with a larger diameter casing string 20 cemented to the earth formation 10. The smaller diameter casing string 18 extends through casing string 20 and is used for drilling the wellbore. Wellbore 12 is being formed in accordance with the present invention by a bit assembly 22 and a mud motor 25 connected at the lower end 24 of casing string 18. Bit assembly 22 is driven to rotate by mud motor 25 and/or by either or both top drives. The mud motor is preferably a progressive cavity pump, as is known. Mud motor 25 has a bent housing including an upper portion 25a having an axis 25a′ and a lower portion 25b having an axis 25b′. The housing upper portion is set out of axial alignment with the lower portion by a bend 26 formed in the motor housing. The angle of the bend, and therefore the deviation A of axis 25a′ from axis 25b′, is selected to be typically up to about 40 degree. This degree of deviation determines the radius of borehole curvature which will be drilled using the mud motor. A larger angle of deflection causing a shorter radius of curvature in the borehole.

In particular, the axial deviation of lower portion 25b relative to upper portion 25a causes the bit assembly to be biased to drill a curved borehole section in the direction of axis 25b′. The direction of the resulting wellbore 12 can be directed by slightly rotating the casing string 18 while drilling using either or both top drives. The orientation and direction of the casing is measured by a conventional measurement while drilling (MWD) device in the bit assembly 22.

Bit assembly 22 and mud motor 25 are releasably mounted at the lower end of the casing string by an expandable/retractable packer (not shown) mounted on upper portion 25a of the mud motor housing. Bit assembly 22 and mud motor 25 are adapted and sized to be retrievable from wellbore 12 through the interior of casing string 18, without removing casing string 18 from the wellbore. Retrieval of the bit assembly and the motor is by a wireline carrying a retrieval tool. The retrieval tool acts to latch onto the upper portion of motor housing and manipulates the motor such that the packer is retracted from engagement against the casing interior. Bit assembly 22 includes, optionally, a pilot bit 23 and an underreaming assembly 27. Pilot bit 23 can be, for example, a tri cone, polycrystalline diamond compact (PDC) or any other type of bit for use in drilling wellbores. Pilot bit 23 is trailed by underreaming assembly 27 which serves to enlarge the wellbore to a diameter larger than the outer diameter of casing string 18 so as to allow the casing string to advance into the earth formation. Underreaming assembly 27 includes arms 27a carrying cutters 27b. Arms 27a are pivotally retractable and expandable. Thus, arms 27a can be retracted to permit bit assembly 22 to be passed down through the interior of casing string 18. Upon reaching the bottom of the casing string, the arms can be expanded to permit hole enlargement behind the pilot bit. The arms are again retractable to permit the bit assembly to be retrieved to surface through the casing interior for maintenance, replacement or other operations.

The casing is rotated by either or by both top drives in order to cause the bit assembly to rotate to effect drilling. In one embodiment, directional drilling is achieved using a rotary steerable tool (RST) with a bit is attached at the lower end of RST. The bit can any one of several types including, for example, a PDC or tri cone. The bit may be attached to the lower end of RST by a MWD tool, although a short length of pipe or other connectors can alternately be used. An underreaming assembly may be mounted above the RST. The RST may include a top section and a bottom section and be disposed therebetween a ball type joint, which allows the bottom section to flex out of axial alignment with top section. The ball type joint may be modified so that axial rotational force can be transferred therethrough from top section to bottom section. The RST further may include an eccentric sleeve mounted on lower section and disposed to be rotatable thereabout. Eccentric sleeve 40 includes a guiding blade 41 biased outwardly from the surface of the eccentric sleeve. A guiding blade acts as a razor back and is disposed to pressingly engage against the side of the wellbore when the RST is disposed in a wellbore. The RST is rigidly engaged at lower end of casing string to be rotatable therewith, by either or by both top drives. When the top section of the RST is driven to rotate in a wellbore, the eccentric sleeve remains in a fixed position in the wellbore substantially without rotation due to engagement of the guiding blade against wellbore wall while the top and bottom sections rotate freely within the eccentric sleeve. Above the RST may be a centralizer for maintaining the top of the RST in the center of the borehole. The eccentric sleeve forms a fulcrum along the drill string which causes top section and bottom section to flex about ball type joint and out of axial alignment with each other. Thus, the RST provides for drilling of a curved wellbore in the direction corresponding to the direction of the axis of bottom section.

The present invention provides a system with a dual top drive and a pipe running tool for use in an oil drilling system and has a lower drive shaft of the tool adapted to engage a drive shaft of a dual top drive system according to the present invention for rotation therewith. The pipe running tool further includes a lower pipe engagement assembly which is driven to rotate by the lower drive shaft, and is designed to releasably engage a pipe segment in such a manner to substantially prevent relative rotation between the two. Thus, when the lower pipe engagement assembly is actuated to securely hold a pipe segment, the top drive assembly may be actuated, either or both top drives, to rotate the top drive output shaft, which causes the lower drive shaft and lower pipe engagement assembly to rotate, which in turn rotates the pipe segment. The present invention provides improvements to the subject matter of U.S. Pat. No. 6,443,241.

In one aspect, the present invention provides a pipe running tool mountable on a rig and designed for use in handling pipe segments and for engaging pipe segments to a pipe string, the pipe running tool having: a top drive assembly which is a dual top drive system according to the present invention (any suitable system disclosed herein) adapted to be connected to the rig, the top drive assembly including a top drive output shaft, the top drive assembly being operative to rotate the drive shaft using either or both top drives of the dual top drive system; a lower drive shaft coupled to the top drive output shaft and having an adjustable segment that is selectively adjustable to adjust the length of the second drive shaft; a lower pipe engagement assembly including a central passageway sized for receipt of the pipe segment, the lower pipe engagement assembly being operative to releasably grasp the pipe segment, the lower pipe engagement assembly being connected to the second drive shaft, whereby actuation of the top drive assembly (either or both top drives) causes the lower pipe engagement assembly to rotate; and means for applying a force to the second shaft to cause the length of the adjustable segment to be shortened.

In one aspect, the present invention provides a pipe running tool mountable on a rig and designed for use in connection with a top drive assembly which is a dual top drive system according to the present invention adapted to be connected to the rig for vertical displacement of the top drive assembly relative to the rig, the top drive assembly including a drive shaft, the top drive assembly being operative (either or both top drives) to rotate the drive shaft, the pipe running tool having: a lower pipe engagement assembly having: a housing defining a central passageway sized for receipt of a pipe segment, the housing being coupled to the top drive assembly for rotation therewith; a plurality of slips disposed within the housing and displaceable between disengaged and engaged positions; and a powered system connected to the respective slips and operative to selectively drive the slips between the disengaged and engaged positions.

In a system for assembling a pipe string, the system including a top drive assembly which is a dual top drive system according to the present invention, a lower pipe engagement assembly coupled to the top drive assembly for rotation therewith and operative to releasably engage a pipe segment, and a load compensator operative to raise the lower pipe engagement assembly relative to the top drive assembly, a method is provided for threadedly engaging a pipe segment with a pipe string, including the steps of: actuating the lower pipe engagement assembly to releasably engage a pipe segment; lowering the top drive assembly to bring the pipe segment into contact with the pipe string; monitoring the load on the pipe string; actuating the load compensator to raise the pipe segment a selected distance relative to the pipe string, if the load on the pipe string exceeds a predetermined threshold value; and actuating the top drive assembly (either or both top drives) to rotate the pipe segment to threadedly engage the pipe segment and pipe string.

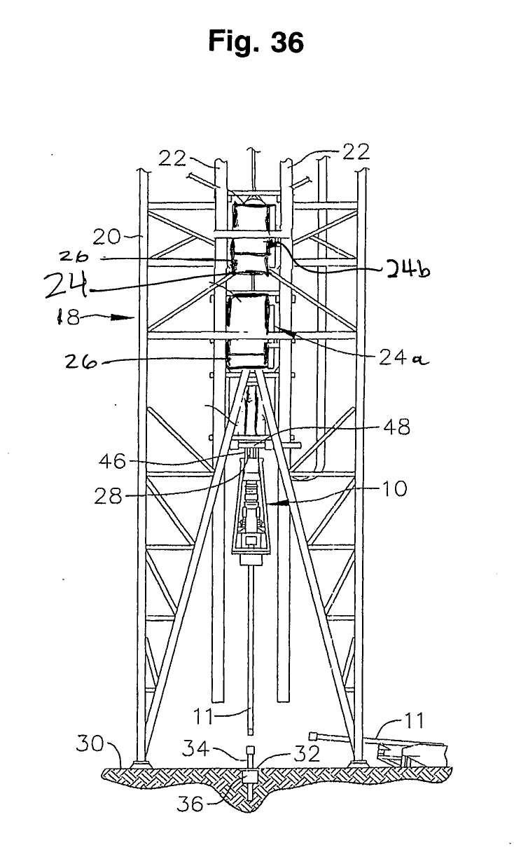

Referring now to FIG. 36, there is shown a pipe running tool 10 depicting one illustrative embodiment of the present invention, which is designed for use in assembling pipe strings, such as drill strings, casing strings, and the like. The pipe running tool 10 comprises, generally, a frame assembly 12, a rotatable shaft, and a lower pipe engagement assembly that is coupled to the rotatable shaft for rotation therewith (see lower shaft and lower pipe engagement assembly of U.S. Pat. No. 6,443,241. The pipe engagement assembly is designed for selective engagement of a pipe segment 11 to substantially prevent relative rotation between the pipe segment and the pipe engagement assembly. The rotatable shaft is designed for coupling with a top drive output shaft from a dual top drive system 24 (which has top drives 24a, 24b), such that the top drive system, which is normally used to rotate a drill string to drill a well hole, may be used to assemble a pipe string, for example, a casing string or a drill string.

The pipe running tool 10 is designed for use, for example, in a well drilling rig 18. A suitable example of such a rig is disclosed in U.S. Pat. No. 4,765,401 which is expressly incorporated herein by reference as if fully set forth herein. As shown in FIG. 36, the rig includes a frame 20 and a pair of guide rails 22 along which the dual top drive assembly system 24 may ride for vertical movement relative to the rig. The each of the two top drives includes a drive motor 26 and a top drive output shaft extending downwardly from the drive motor, with the drive motor being operative to rotate the drive shaft, as is conventional in the art. The rig defines a drill floor 30 having a central opening 32 through which a drill string and/or casing string 34 is extended downwardly into a well hole. The rig 18 also includes a flush-mounted spider 36 that is configured to releasably engage the drill string and/or casing string 34 and support the weight thereof as it extends downwardly from the spider into the well hole. As is well known in the art, the spider includes a generally cylindrical housing which defines a central passageway through which the pipe string may pass. The spider includes a plurality of slips which are located within the housing and are selectively displaceable between disengaged and engaged positions, with the slips being driven radially inwardly to the respective engaged positions to tightly engage the pipe segment and thereby prevent relative movement or rotation of the pipe segment and the spider housing. The slips are preferably driven between the disengaged and engaged positions by means of a hydraulic or pneumatic system, but may be driven by any other suitable means.

The pipe running tool 10 (e.g., see the tool as in FIGS. 1 and 2 of U.S. Pat. No. 6,443,241) includes the frame assembly, which comprises a pair of links extending downwardly from a link adapter. The link adapter defines a central opening through which the top drive output shaft may pass. Mounted to the link adapter on diametrically opposed sides of the central opening are respective upwardly extending, tubular members 46, which are spaced a predetermined distance apart to allow the top drive output shaft 28 to pass therebetween. The respective tubular members connect at their upper ends to a rotating head 48, which is connected to the top drive system 24 for movement therewith. The rotating head defines a central opening (not shown) through which the top drive output shaft may pass, and also includes a bearing (not shown) which engages the upper ends of the tubular members and permits the tubular members to rotate relative to the rotating head body, as is described in greater detail below. The top drive output shaft 28 terminates at its lower end in an internally splined coupler which is engaged to an upper end of the lower drive shaft (not shown) which is formed to complement the splined coupler for rotation therewith. Thus, when the top drive output shaft 28 is rotated by either or both top drive motors 26, the lower drive shaft is also rotated. It will be understood that any suitable interface may be used to securely engage the top and lower drive shafts together. In one illustrative embodiment, the lower drive shaft is connected to a conventional pipe handler, which may be engaged by a suitable torque wrench (not shown) to rotate the lower drive shaft and thereby make and break connections that require very high torque, as is well known in the art.

The lower drive shaft may be formed with a splined segment, which is slidably received in an elongated, splined bushing which serves as an extension of the lower drive shaft. The drive shaft and bushing are splined to provide for vertical movement of the shaft relative to the bushing, as is described in greater detail below. It will be understood that the splined interface causes the bushing to rotate when the lower drive shaft rotates. The pipe running tool 10 may further include the lower pipe engagement assembly, which in one embodiment comprises a torque transfer sleeve which is securely connected to the lower end of the bushing for rotation therewith. The torque transfer sleeve is generally annular and includes a pair of upwardly projecting arms on diametrically opposed sides of the sleeve. The arms are formed with respective horizontal through passageways (not shown) into which are mounted respective bearings (not shown) which serve to journal a rotatable axle 0 therein. The transfer sleeve connects at its lower end to a downwardly extending torque frame in the form of a pair of tubular members which in turn is coupled to a spider/elevator which rotates with the torque frame. It will be apparent that the torque frame may take many, such as a plurality of tubular members, a solid body, or any other suitable structure.

The present invention provides a multi-activity drillship, or the like, method and apparatus having a single derrick, with two dual top drive systems (any suitable ones according to the present invention) and multiple tubular activity stations within the derrick wherein primary drilling activity may be conducted from the derrick and simultaneously auxiliary drilling activity may be conducted from the same derrick (using one or two top drives) to reduce the length of the primary drilling activity critical path. The present invention provides improvements to the subject matter of U.S. Pat. No. 6,056,071.

In certain aspects, the present invention provides a multi-activity drilling assembly operable to be mounted upon a drilling deck of a drillship, semi-submersible, tension leg platform, jack-up platform, or offshore tower and positioned above the surface of a body of water for supporting drilling operations through the drilling deck, to the seabed and into the bed of the body of water, said multi-activity drilling assembly including: an interconnected superstructure operable to be positioned above a drilling deck and extending over an opening in the drilling deck for simultaneously supporting drilling operations and operations auxiliary to drilling operations through the drilling deck; a first dual top drive system positioned within the periphery of said interconnected superstructure; a first drawworks positioned adjacent to said interconnected superstructure and operably connected to a first traveling block positioned within said interconnected superstructure adjacent to said first dual top drive system for conducting drilling operations on a well through the drilling deck; a second dual top drive system positioned within the periphery of said interconnected superstructure; and a second drawworks positioned adjacent to said interconnected superstructure and operably connected to a second traveling block positioned within said interconnected superstructure adjacent to said second dual top drive system for conducting drilling operations or operations auxiliary to said drilling operations for the well, wherein drilling activity can be conducted within said interconnected superstructure with said first or second dual top drive system, said first or second drawworks and said first or second traveling block and auxiliary drilling activity extending to the seabed can be simultaneously conducted within said interconnected superstructure with the other of said first or second dual top drive system, the other of said first or second drawworks and the other of said first or second traveling block.

In certain embodiments, the present invention provides a multi-activity assembly operable to be positioned above the surface of a body of water for conducting at least one of work over and completion operations from a drilling deck, to the seabed and into the bed of the body of water, said multi-activity assembly including: an interconnected superstructure operable to be mounted upon a drilling deck for simultaneously supporting at least one of a work over and completion operation for a well and operations to the seabed auxiliary to said at least one said work over and completion operations for the well; first means connected to said interconnected superstructure for advancing tubular members to the seabed and into a well at the bed of the body of water; second means connected to said interconnected superstructure for advancing tubular members, simultaneously with said first means, to the seabed for deployment into the well at the bed of the body of water, wherein at least one of said work over and completion activity can be conducted for a well from said interconnected superstructure by said first or second means for advancing tubular members and auxiliary activity can be simultaneously conducted to the seabed for the well from said interconnected superstructure by the other of said first or second means for advancing tubular members; wherein said first and second means for advancing tubular members include: a first dual top drive system and a second dual top drive system.

The present invention, in certain aspects, provides multi-activity drilling assembly operable to be supported from a position above the surface of a body of water for conducting drilling operations to the seabed and into the bed of the body of water for a single well, said multi-activity drilling assembly including: an interconnected support superstructure operable to extend above a drilling deck for simultaneously supporting drilling operations for a well and operations auxiliary to drilling operations for a well; first means supported by said interconnected support superstructure for advancing tubular members to the seabed and into the bed of the body of water; and second means supported by said interconnected support superstructure simultaneously with said first means supported by said interconnected support superstructure for selectively advancing tubular members into the body of water to the seabed wherein drilling activity can be conducted for the well from said interconnected support superstructure by said first means for advancing tubular members and auxiliary drilling activity to the seabed can be simultaneously conducted for the well from said interconnected support superstructure by said second means for advancing tubular members; said first means is a first dual top drive system and said second means is a second dual top drive system.

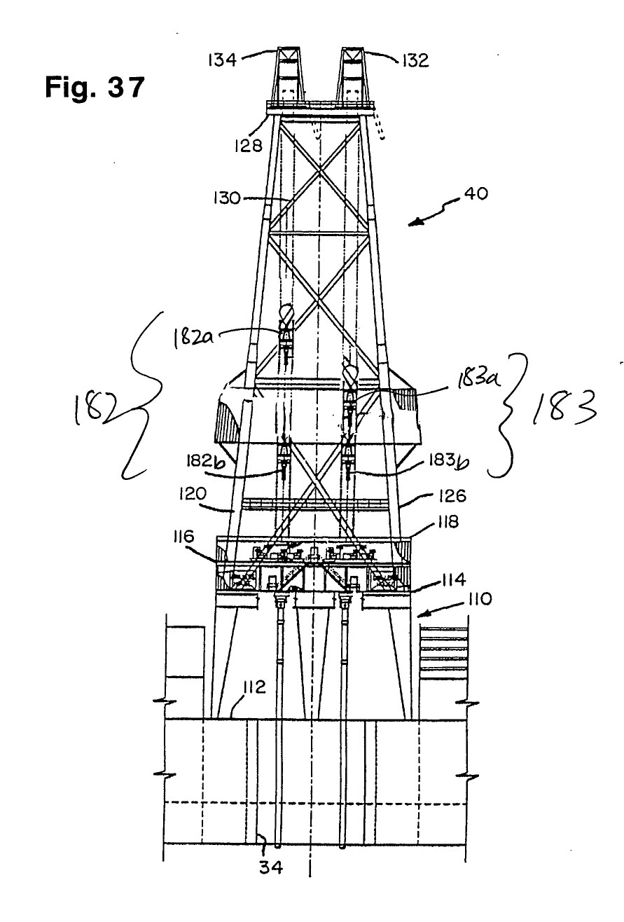

In certain aspects, the present invention includes an offshore drillship (e.g., see U.S. Pat. No. 6,056,071) which is multi-activity drillship with a tanker-type hull which is fabricated with a large moon pool between the bow and stern. A multi-activity derrick (see derrick 40, FIG. 37) is mounted upon the drillship substructure above a moon pool and operable to conduct primary tubular operations and simultaneously operations auxiliary to primary tubular operations from a single derrick through the moon pool. In this patent application the term “tubular” is used as a generic expression for conduits used in the drilling industry and includes relative large riser conduits, casing, strings, and drillstrings of various diameters.

The derrick 40 includes a base 110 which is joined to the drillship substructure 112 symmetrically above the moon pool 34. The base 110 is preferably square and extends upwardly to a drill floor level 114. Above the drill floor level is a drawworks platform 116 and a drawworks platform roof 118. Derrick legs 120,126 (other legs not shown) are composed of graduated tubular conduits and project upwardly and slope inwardly from the drill floor 114. The derrick terminates into a generally rectangular derrick top structure or deck 128. The legs are spatially fixed by a network of struts 130 to form a rigid drilling derrick for heavy duty tubular handling and multi-activity functions in accordance with the subject invention. The derrick top 128 serves to carry a first 132 and second 134 mini-derrick which, guide a sheave and hydraulic motion compensation system.

The tubulars are rotatable by a first dual top drive system 182 (with top drives 182a, 182b) and a second dual top drive system 183 (with top drives 183a, 183b). Each top drive may be the same or they may be different (as is true for any system according to the present invention). The top drive systems are connected to traveling blocks and are, optionally, balanced by hydraulic balancing cylinders and a guide dolly supports a power train which drives a tubular handling assembly above drill floor 114 (e.g., as in U.S. Pat. No. 6,056,071).

It will be appreciated that the multi-activity derrick 40 comprises two dual top drive systems, drawworks, motion compensation and traveling blocks positioned within a single, multi-purpose derrick. Accordingly, the subject invention enables primary drilling activity and auxiliary activity to be conducted simultaneously and thus the critical path of a drilling function to be conducted through the moon pool 34 may be optimized. Alternatively, units are envisioned which will not be identical in size or even function, but are nevertheless capable of handling tubulars and passing tubulars back and forth between tubular advancing stations within a single derrick. Further, in a preferred embodiment, the multi-activity support structure is in the form of a four sided derrick. The subject invention, however, is intended to include other superstructure arrangements such as tripod assemblies or even two adjacent upright but interconnected frames and superstructures that are operable to perform as support function for more than one tubular drilling or activity for conducting simultaneous operations through the deck of a drillship, semi-submersible tension leg platform, or the like.

The present invention provides, in certain aspects, improvements to the subject matter of U.S. Pat. No. 5,713,422 which are, in certain embodiments, a drilling system for drilling a borehole using a dual top drive system (any suitable system according to the present invention). A motor continuously coupled to the drawworks may be utilized to raise and lower a drill stem to continuously control the weight on bit at a desired value. One or both top drives rotate the drill stem (in any mode or manner disclosed herein). A control circuit is coupled to all the motors and receives information from various sensors which includes information about the rate of penetration, weight on bit; hook load, and rotational speed of the drill bit. The control circuit controls the drawworks motor to control the drill stem motion in both directions. In one mode the a desired rate of penetration is maintained by controlling the weight on bit. In another mode, the control circuit causes the drilling to start at an initial rate of penetration and then it starts to vary the rate of penetration according to programmed instructions to optimize the drilling efficiency. Yet, in another mode the control circuit causes the drilling to start at initial rotary speed and the weight on bit values and then varies the weight on bit and/or the rotary speed to obtain the combination of these parameters that yields the most efficient drilling of the borehole.

In one aspect, the present invention provides a system for drilling a borehole, the system including:
(a) a drill stem having a drill bit at one end for drilling the borehole and a dual top drive system for rotating the drill stem (with one or both top drives);
(b) drawworks coupled to the drill stem;
(c) a prime mover engaged continuously to the drawworks during operation to cause the drawworks to move the drill stem upward and downward; and
(d) a control circuit operatively coupled to the prime mover, said control circuit controlling both top drives and operating the prime mover so as to cause the drawworks to automatically move the drill stem in both the upward and downward directions in response to a selected system parameter.

In one aspect, the present invention provides a method of drilling a borehole by utilizing a drill stem having a drill bit at an end thereof, and a dual top drive system for rotating the drill stem (with either or both top drives), said drill stem operable by a drawworks that is continuously engaged to a prime mover, including:
(a) initiating drilling of the borehole by rotating the drill stem using either or both top drives;
(b) determining weight on bit;
(c) determining, as applied by either or both top drives, torque and rotational speed of the drill stem; and
(d) operating the prime mover to reduce the weight on bit when the torque on the drill string is above a predetermined value and the rotational speed is below a predetermined value so as to prevent the drill bit from getting stuck in the borehole.

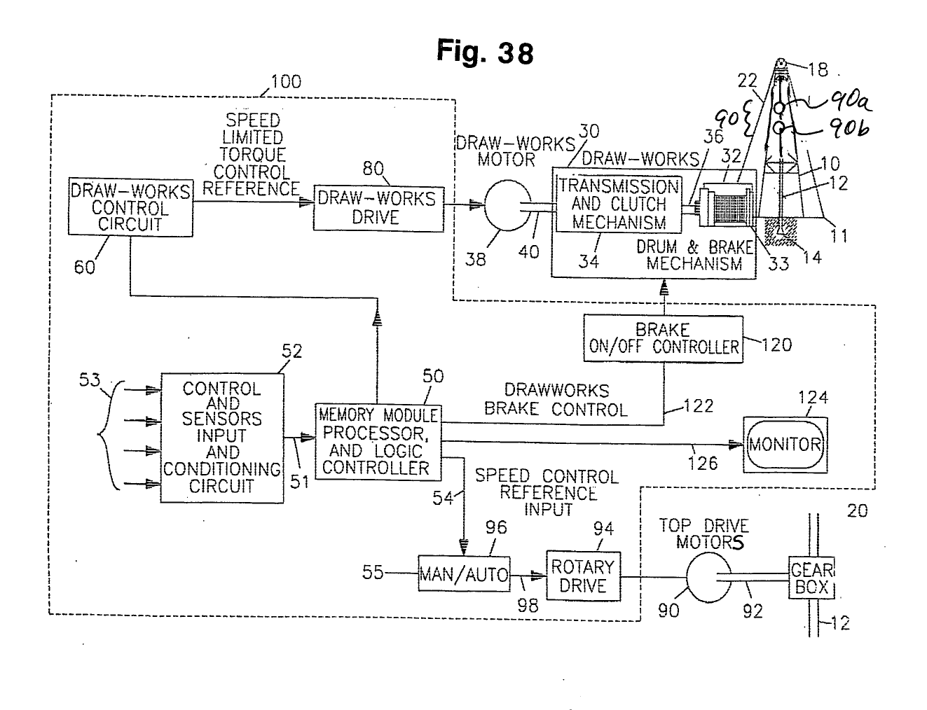

As shown in FIG. 38, a drilling system according to the present invention contains a support structure 10, such as a derrick. A drill stem 12 having a drill bit 14 at its bottom end is coupled to a dual top drive system 90 which has two top drives 90a, 90b each connected via a gear box 20 for rotating the drill stem 12. The system 90 in one aspect uses electric top drive motors. The electric motors may be a d.c. or an a.c. type motor. For simplicity and not as a limitation, the system 90 is hereafter referred to as the “rotary system.” The rotary system 90 is adapted to rotate the drill stem 12 in both the clock-wise and counter clock-wise directions.

The top end of the drill stem 12 is coupled to a cable or line 22 via a system of pulleys 18. One end of the line 22 is anchored at a suitable place 11 on the support structure 10 while the other end of the cable 22 is wound on a drum 32 of a drawworks 30. The drawworks 30 contains the drum 32, which is coupled to a transmission and clutch mechanism 34 via a coupling member 36, and a friction brake 33. The transmission and clutch mechanism 34 contains different levels, wherein the lowest level defines the least rotational speed range for the drum 32 and the highest level defines the highest speed range for the drum 32. The transmission and clutch mechanism 34 engages with the drum 32 via the coupling member 36. During drilling, the clutch and transmission are set at the low clutch and low speed gears. If more than one d.c. motor is used to operate the drawworks, their armature are connected in series.

A prime mover 38 coupled to the transmission and clutch mechanism 34 is adapted to rotate the drum 32 in both the clock-wise and counter clock-wise directions when the clutch and transmission mechanism 34 is engaged with the drum 32. An electric motor (d.c. or a.c. motor) is preferably used as the prime mover 38. For simplicity and not as a limitation the prime mover 38 is hereafter referred to as the “drawworks motor.” When the clutch and the transmission mechanism 34 is disengaged from the drum 32, the drawworks motor 38 has no affect on the drum 32. When the brake 33 is fully engaged with the drum 32, it prevents the drum 32 from rotating. When the drawworks motor 38 is disengaged from the drum 32 and the brake 32 is controllably released, the weight of the drill stem 12 (the hook load) causes the drum 32 to rotate to unwind the cable 22 from the drum, thus lowering the drill stem 12.

Drilling may be accomplished in a number of modes and a control circuit (e.g., see U.S. Pat. No. 5,713,422) controls the operation of the drilling system of FIG. 38 in each of the drilling modes.

In certain aspects the present invention provides automatic drilling systems for drilling with a dual top drive system. The present invention provides improvements to the subject matter of U.S. Pat. No. 5,474,142. In one aspect, the present invention provides an automatic drilling system using a dual top drive system (any suitable system according to the present invention) that regulates the drill string of a drilling rig in response to any one of, any combination of, or all of drilling fluid pressure, bit weight, drill string torque, and drill string RPM to achieve an optimal rate of bit penetration. Such an automatic drilling system can include a drilling fluid pressure sensor, a bit weight sensor, a drill string torque sensor, and a drill string RPM sensor which deliver a drilling fluid pressure signal, a bit weight signal, a drill string torque signal, and a drill string RPM signal to a drilling fluid pressure regulator, a bit weight regulator, a drill string torque regulator, and a drill string RPM regulator. The regulators control a drill string controller in response to the above signals so that it controls one or both top drives of the dual top drive system and manipulates the drilling rig to release the drill string at a rate which maintains the maximum rate of bit penetration.

In one aspect, the present invention provides an automatic drilling system for automatically regulating the release of the drill string of a drilling rig during the drilling of a borehole, the system having: a dual top drive system for rotating a drill string; a drilling fluid pressure sensor; a drilling fluid pressure regulator coupled to said drilling fluid pressure sensor, said drilling fluid pressure regulator measuring changes in drilling fluid pressure and outputting a signal representing those changes; a relay coupled to said drilling fluid pressure regulator, said relay responsive to the output signal of said drilling fluid pressure regulator to supply a drill string control signal at an output thereof; and a drill string controller for controlling the dual top drives and coupled to said relay wherein a decrease in drilling fluid pressure results in said relay supplying a drill string control signal that operates said drill string controller to effect an increase in the rate of release of said drill string and an increase in drilling fluid pressure results in said relay supplying a drill string control signal that operates said drill string controller to effect a decrease in the rate of release of said drill string.

In one aspect, the present invention provides such an automatic drilling system with a dual top drive system which also includes: a bit weight sensor; a bit weight regulator coupled to said bit weight sensor, said bit weight regulator measuring changes in bit weight and outputting a signal representing those changes; a relay coupled to said bit weight regulator, said relay responsive to the output signal of said bit weight regulator to supply a drill string control signal at an output thereof; and said drill string controller coupled to said relay wherein a decrease in bit weight results in said relay supplying a drill string control signal that operates said drill string controller to effect an increase in the rate of release of said drill string and an increase in bit weight results in said relay supplying a drill string control signal that operates said drill string controller to effect a decrease in the rate of release of said drill string; and/or a drill string torque sensor; a drill string torque regulator coupled to said drill string torque sensor, said drill string torque regulator measuring changes in drill string torque and outputting a signal representing those changes; a relay coupled to said drill string torque regulator, said relay responsive to the output signal of said drill string torque regulator to supply a drill string control signal at an output thereof; and a drill strings controller coupled to said relay wherein a decrease in drill string torque results in said relay supplying a drill string control signal that operates said drill strings controller to effect an increase in the rate of release of said drill string and an increase in drill string torque results in said relay supplying a drill strings control signal that operates said drill strings controller to effect a decrease in the rate of release of said drill string.

The present invention provides a method for automatically regulating the release of the drill string of a drilling rig drill, the drilling rig drill including a dual top drive system (any suitable system described herein) including the steps of: measuring drilling fluid pressure; producing a signal in response to changes in drilling fluid pressure, said signal representing the changes in drilling fluid pressure; relaying said signal to a drill string controller; and controlling either or both top drives of the dual top drive system and said drill string controller to increase the rate of release of said drill string when said signal represents a decrease in drilling fluid pressure and to decrease the rate of release of said drill string when said signal represents an increase in drilling fluid pressure.

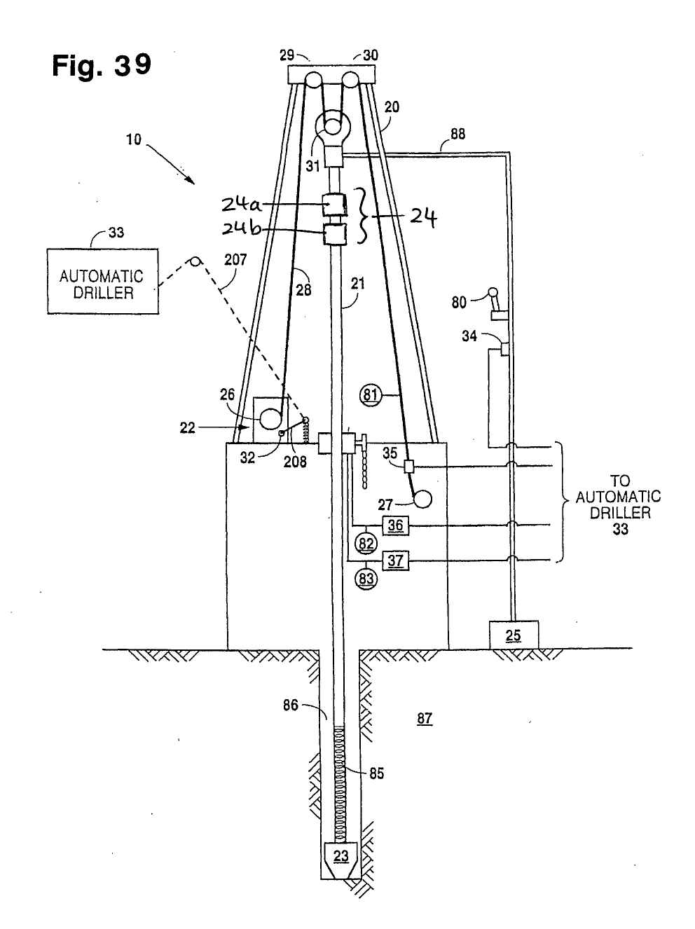

FIG. 39 illustrates a drilling rig 10 according to the present invention with a dual top drive system 24 (with top drives 24a, 24b), the rig and the top drive system controlled by an automatic drilling system. Drilling rig 10 may be utilized to drill vertical, directional, and horizontal boreholes. Derrick 20 supports drill string 21 within borehole 86 utilizing drawworks 22. Drawworks 22 includes drilling cable drum 26 and drilling cable anchor 27 having drilling cable 28 strung therebetween. Rollers 29 and 30 mount onto derrick 20 to wind cable 28 about travelling block 31, thus suspending drill string 21 from derrick 20. Brake 32 controls the release of cable 28 from drum 26 to adjust the vertical position of drill string 21 with respect to derrick 20.

The top drive system 24 (using either or both top drives) drives drill string 21 to rotate drill bit 23, thereby drilling borehole 86. Additionally, drill string 21 can optionally include mud motor 85 which allows directional and horizontal boreholes to be drilled. To drill borehole 86 into formation 87, the top drive system 24 may drive drill string 21 to rotate drill bit 23, or mud motor 85 may rotate drill bit 23, or drill string 21 and mud motor 85 may be used in tandem. However, in one drilling operation, mud motor 85 drives drill bit 23 only at the directionalization point of borehole 86 in order to ensure a precise borehole angle, while drill string 21 (rotated by either or both top drives) drives drill bit 23 during straight line drilling. Pump 25 pumps drilling fluid (i.e. mud) into drill string 21 via drilling fluid line 88, where it travels down drill string 21 to mud motor 85 and drill bit 23. The drilling fluid drives mud motor 85 (when it is used) and provides pressure within drill bit 23 to prevent blowouts, and carries drilled formation materials from borehole 86.

Drawworks 22 adjusts drill string 21 vertically along derrick 20 in order to retain drill bit 23 “on bottom” (i.e. on the bottom of borehole 86) and maintain the progression of borehole 86 through formation 87. As long as drill string 21 maintains sufficient and constant pressure on drill bit 23, drill bit 23 will gouge borehole 86 from formation 87 at an optimal rate of penetration chosen based upon the composition of formation 87. Rates of penetration vary from as little as four feet per hour to as much as one hundred and eighty feet per hour. If, however, drawworks 22 did not adjust drill string 21, drill bit 23 could rise “off bottom” (i.e. off the bottom of borehole 86) and the progression of borehole 86 through formation 87 would cease. Accordingly, brake 32 can be manipulated to permit drum 26 to release cable 28 and adjust drill string 21, thereby providing the constant pressure on drill bit 23 required to maintain the optimal rate of penetration.

To maintain drill bit 23 “on bottom” and, thus, the optimal rate of penetration, automatic driller 33 connects to brake handle 208 via cable 207 to regulate the release of cable 28 from drum 26. Automatic driller 33 senses when drill bit 23 is “off bottom” and manipulates brake 32 to release cable 28 and lower drill string 21 until drill bit 23 is again “on bottom”. Automatic driller 33 determines when drill bit 23 is “off bottom” by measuring drilling fluid pressure, bit weight, drill string torque, and drill string revolutions per minute (RPM). Drilling fluid pressure sensor 34, bit weight sensor 35, torque sensor 36, and RPM sensor 37 mount onto oil drilling rig 20 to provide signals representative of drilling fluid pressure, bit weight, drill string torque, and drill string RPM to automatic driller 33. Additionally, drilling fluid pressure gauge 80, drill string weight gauge 81, drill string torque gauge 82, and drill string RPM gauge 83 mount on drilling rig 10 to register the respective signals produced by drilling fluid pressure sensor 34, bit weight sensor 35, torque sensor 36, and RPM sensor 37 for the drilling rig operator. Automatic driller 33 may be programmed to utilize any one of the above measurements, any combination of the above measurements, or all of the above measurements to regulate brake 32 and, thus, the position of drill bit 23 within borehole 86.

The present invention provides improvements to the subject matter of U.S. Pat. No. 4,875,530. In certain aspects, the present invention provides methods in which maximum rate of drill bit penetration in high speed coring is achieved by precise control of bit weight and bit speed. The automatic drilling system of this invention makes it possible to quickly reach and maintain this optimum combination or “sweet-point” each time the core bit is started. The required speed and weight is input into the system by the operator. A controller electronically senses the bit weight and provides instantaneous feedback to a hydraulically driven drawworks which is capable of maintaining a precise weight on the bit throughout varying penetration modes. The drilling system uses a combination of equipment that includes a hydraulic system for the control of the drawworks; a solid-state strain gauge load cell apparatus built into the swivel assembly for continuously weighing the drill string; an electronic load control circuitry for determining the bit weight, drill string weight, and for maintaining the bit weight control; and, a dual top drive system (any suitable system according to the present invention) for rotation of the string.

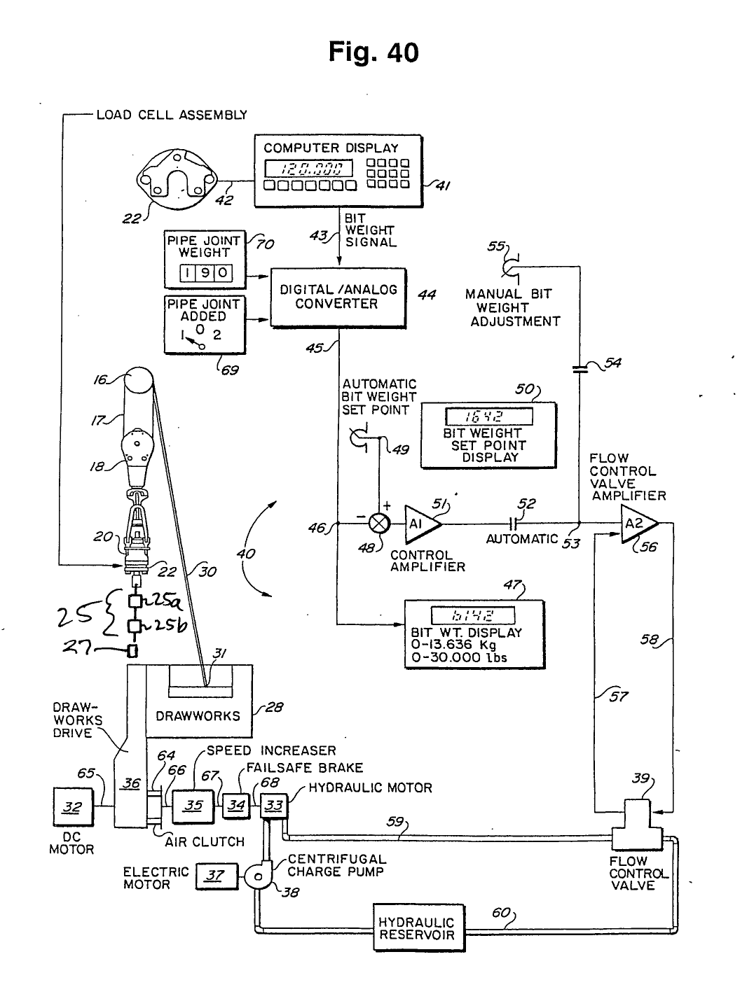

FIG. 40 shows an automatic drilling operation and system 10 according to the present invention. The system is used in conjunction with a drilling rig having a rig floor, derrick 14, crown block 16, strands of a cable 17, by which the traveling block 18 is vertically positioned. A lower end of the traveling block is connected to the upper end of the swivel 20. The swivel has a bale by which it is supported from the connector. A load cell assembly 22 is positioned in underlying relationship respective to the remainder of the swivel 20 so that the load cell assembly is supported from a position immediately below the swivel. This enables the entire weight of the drilling string to be carried by the load cell assembly.

Parallel cable guides are spaced from one another with the opposed ends thereof being connected between the floor and a suitable upper part of the derrick. A dual top drive system 25 (with top drives 25a, 25b) has an output shaft that directly drives a drill string 27. A drawworks drive 28 is positioned to accept the marginal end of support cable 17 about a drawworks drum. A dog house houses control panels and electronic circuitry for controlling the operation of the drilling rig. A fast line 30 extends from drum 31 of draw works 28 and is rove at 17 between the crown block 16 and traveling block 18. A drawworks motor 32, hydraulic motor 33, failsafe brake 34, and speed increaser 35 are all arranged respective the drawworks drive 36 to enable the drawworks drum 31 to be controlled. A motor 37, drives a centrifugal charge pump 38 which discharges into the inlet of hydraulic motor 33. The hydraulic motor is controlled by a flow control valve 39, which throttles flow of hydraulic fluid flowing from motor 33, thereby controlling the rotational speed of motor 33.

Numeral 40 broadly indicates circuitry that is interposed between load cell assembly 22 and flow control valve 39 for throttling the valve in order to maintain a constant WOB. Conductors 42 are interconnected to load cell assembly 22 and provide a signal to a control system 41, e.g., a computer 41, which is related to the weight of the entire drill string 27, as measured at the lower end of the swivel assembly 20.

The computer 41 outputs a bit weight signal which is connected by conductor 43 to a converter 44. The output from the converter is conducted along path 45 to junction 46, to provide a bit weight display 47 with a signal directly related to bit weight. At the same time the signal from converter 44 is summed at 48 with a signal from an automatic bit weight set point 49, to provide an operating signal. The automatic bit weight set point 49 displays its selected value at bit weight set point display 50. This is the desired WOB that is set by manipulating the device 49. The actual WOB that is derived from the measurement at 22 and is displayed at 47. Any difference that may exist between 47 and 50 is calculated at 48, amplified by the amplifier 51, and travels through the automatic switch 52, to junction 53. The indicators 47 and 50 are input instruments that derive their signal from the output at 46 and 49. Manual switch 54 is connected to the illustrated manual bit weight adjustment 55, and provides a means by which manual control can be effected over the flow control valve 39. Both switch 52 and switch 54 are independently actuated from the panel.

The signal continues from junction 53 to the flow control valve amplifier 56 for controlling directional proportional valves with electrical spool position feedback. The signal is treated to make it compatible with the circuitry of control valve 39′. The signal from 56 travels along conductors 57, 58 and controls the action of the electrical components of the flow control valve 39′.

Flow conduits 59 and 60 connect the control valve 39 with the illustrated hydraulic reservoir, centrifugal charge pump 38, and hydraulic motor 33. The flow control valve 39 throttles the flow from the hydraulic motor 33 in accordance with the magnitude of the signal received from the flow control amplifier 56.

The present invention provides a wellbore drilling system, having a dual top drive system according to the present invention for rotating a drillstring and a bit (with either or both top drives of the dual top drive system) (any suitable dual top drive system according to the present invention), the wellbore drilling system having: a weight on bit controller configured to generate a normalized WOB output; a drilling torque controller configured to generate a normalized TOB output; a differential pressure controller configured to generate a normalized Delta P output; and a rate of penetration controller configured to multiply a ROP setpoint with the normalized WOB output, the normalized TOB output, and the normalized Delta P output to generate a ROP output. The present invention provides improvements to the subject matter of U.S. patent application Ser. No. 11/567,488 filed Dec. 6, 2006

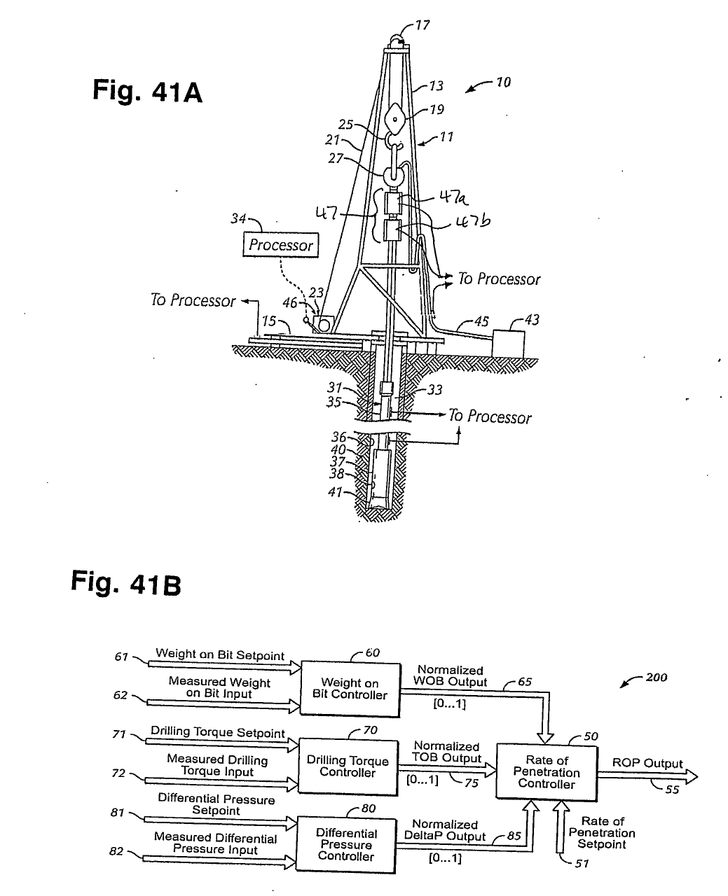

One method according to the present invention to control a wellbore drilling system which includes a dual top drive drilling system includes the steps of: generating a plurality of normalized outputs; multiplying each of the plurality of normalized outputs together; and generating a ROP output by multiplying a product of the plurality of normalized outputs with a ROP setpoint; and one method for controlling a wellbore drilling system which includes a dual top drive system includes the steps of: generating a normalized WOB output; generating a normalized TOB output; generating a normalized Delta P output; and multiplying the normalized WOB, the normalized TOB, and the normalized Delta P outputs together with a ROP setpoint to generate a ROP output. Such systems are like the systems shown in U.S. application Ser. No. 11/567,488. but with a dual top drive system for the apparatus for rotating a drill string, e.g., as shown in FIGS. 41A and 41B which shows schematically the dual top drive system 47 with top drives 47a, 47b (which may be any suitable dual top drive system disclosed herein).

The present invention provides improvements to the subject matter of U.S. application Ser. No. 12/085,705 filed Dec. 4, 2006. In one aspect, the present invention provides a well drilling apparatus with a dual top drive system (any suitable system disclosed herein) with two top drives each on a dolly, suspended from a traveling block with a drawworks and laterally supported as the dollies run with the well drilling apparatus along tracks or rails fixed to a derrick. The well drilling apparatus has two driving motors for each top drive and each top drive has a power transmission powered by at least one of its driving motors. Each top drive (or both; in any mode or manner herein) rotate a drive shaft driven from the power transmission(s) and designed to be connected to a drill string. The apparatus includes load transferring apparatus, and a torque arresting device fixed to and depending from the lower power transmission. At least a number of the above referred components of the well drilling apparatus can be designed and arranged as component modules.

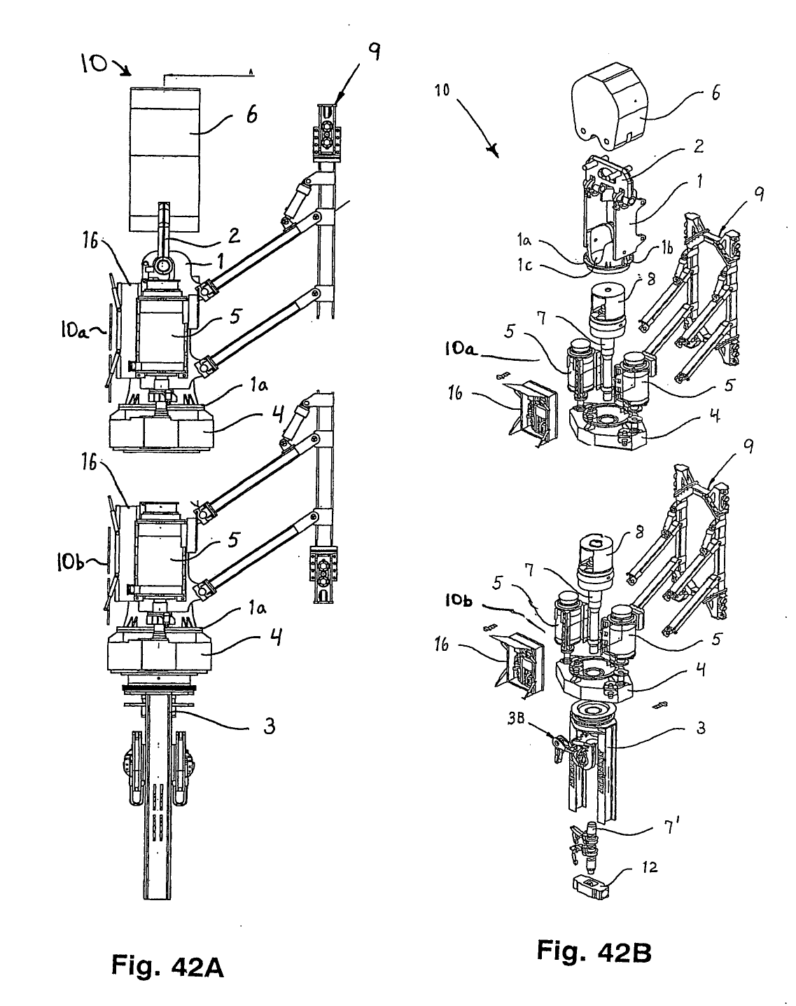

In one aspect, a well drilling apparatus according to the present invention has dual top drive apparatus (10) (see FIGS. 42A and 42B) designed to be suspended from a traveling block (6) in a drawworks and with the top drives laterally supported by dollies (9) running together with the well drilling apparatus along tracks or rails attached to a derrick. Each top drive has two or at least one driving motor (5), one power transmission (4) powered by the at least one driving motor (5), and the top drives, singly or together, rotate a drive shaft (7) driven from the power transmission(s) and designed to be connected to a drill string. The apparatus includes load transferring apparatus, and a torque arresting device (3) attached to and depending from the lower power transmission (4), characterized in that at least a number of the above referred components of the well drilling apparatus are designed/constructed and arranged as component modules, which by means of quick releasable connecting means connect the individual components/modules together.

Examples of the prior machines are shown and described in NO 155553 and NO 840285.

Reference is now made to FIGS. 42A and 42B which shows the drilling machine 10 according to the present which is designed to be suspended in a pulley block 6 in a drawworks arranged in a derrick (not shown), e.g. on land or on board a vessel performing offshore drilling activity. The drilling machine 10 has dual top drives 10a and 10b, one above the other, which are guided by a dollies 9 running along rails attached to the derrick. The drilling machine turns drill pipes around a drilling axis to drill an oil and gas well in the sea bed, using either or both top drives.

An adapter 2 is located uppermost and adjacent to the pulley (traveling) block 6. The adapter 2 is releasable attached to the pulley block 6 at the same time as it also is releasable connected to a below located load frame 1. Valve and instrument cabinets 16 (two shown; either one may be deleted and the functions for both top drives may be accommodated with one cabinet) are attached to the load frame 1 and may be pivotably attached in order to easier get access to a rotary seal behind the cabinet. At the lower end of the apparatus the load frame module 1 is connected to the lower power transmission module 4. Each top drive 10a, 10b has two main driving motors 5 arranged on a power transmission module 4. In one aspect, the driving motors 5 are diametrically located relative to the drilling axis of the drilling machine. By such location they counterbalance each other with regard to forces and torques when both motors 5 are in activity. Optionally a motor 5 of the upper top drive 10a is diametrically opposed to a motor 5 of the lower top drive 10b and, to some extent, when only these two motors are operational, forces and torques are counterbalanced. In one aspect, the driving motors 5 are of such design and of such dimensions that drilling activity can be performed with only one of the driving motors 5 in action. Each driving motor 5 is easily and quick releasable from the power transmission module 4 and the load frame module 1. The two top drives (as is true for any dual top drive system according to the present invention) may be the same; may have the same ratings and part sizes; may be different; or may have different ratings and sizes. Also, the motor or motors of any two top drives may be the same or different, e.g., in size and/or rating. Each driving motor 5 is non-rotatable fixed to respective sides of the vertical parts of the load frame 1. Each driving motor 5 has parts (e.g., gears etc) that cooperate with the drive shaft 7 for rotational power transmission. The transmission structure can provide a reduction power transmission.

The drive shaft 7 is also connected to an above located swivel (not shown on the figure). The swivel is a device for being able to transfer liquid, in this case mud, from a stationary part to a rotating part like the drive shaft 7 in this case. The swivel has an enclosing housing 8 and various seals which will be described in detail later. The lower end of the swivel housing 8 is abutting against a bottom plate 1c in the load frame 1 and is further non-rotatable attached to the load frame 1 as illustrated in the figure and having apertures cut out in the swivel housing 8 and the side wall of the load frame 1. The upper end of the drive shaft 7 is placed within the upper swivel housing. A main bearing is located between a ring flange on the drive shaft 7 and a bottom plate in the load frame 1.

In conclusion, therefore, it is seen that the present invention and the embodiments disclosed herein and those covered by the appended claims are well adapted to carry out the objectives and obtain the ends set forth. Certain changes can be made in the subject matter without departing from the spirit and the scope of this invention. It is realized that changes are possible within the scope of this invention and it is further intended that each element or step recited in any of the following claims is to be understood as referring to the step literally and/or to all equivalent elements or steps. The following claims are intended to cover the invention as broadly as legally possible in whatever form it may be utilized. The invention claimed herein is new and novel in accordance with 35 U.S.C. §102 and satisfies the conditions for patentability in §102. The invention claimed herein is not obvious in accordance with 35 U.S.C. §103 and satisfies the conditions for patentability in §103. The inventors may rely on the Doctrine of Equivalents to determine and assess the scope of their invention and of the claims that follow as they may pertain to apparatus and/or methods not materially departing from, but outside of, the literal scope of the invention as set forth in the following claims. All patents and applications identified herein are incorporated fully herein for all purposes. It is the express intention of the applicant not to invoke 35 U.S.C. §112, paragraph 6 for any limitations of any of the claims herein, except for those in which the claim expressly uses the words ‘means for’ together with an associated function. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

The present invention provides a wellbore operation using a dual top drive system with a first top drive above a second top drive, using either or both top drives, either in unison or independently of each other. In one aspect, the wellbore operation is a tubular rotation operation and the tubular is one of casing, tubing, riser, tubular member, pipe, drill pipe, string of tubulars, drill string; and in other aspects, the wellbore operation is one of drilling, casing, casing while drilling, casing drilling, reaming, underreaming, joint make-up, joint breakout, milling, managed pressure drilling, underbalanced drilling, tubular running, tubular running with continuous circulation, controlling bit face orientation during operations with a bit, conducting well operations based on mechanical specific energy considerations, and automatic drilling. In such systems, the two top drives may be used alternately to rotate a tubular; with either a bottom top drive acting first and then a top top drive acting, or vice-versa. For any such system and any such top drives a control system effects the methods according to the present invention; and, in certain aspects, such a control system includes programmable media with executable instructions for performing the methods.

What is claimed is:

1. A wellbore operation using a dual top drive system with a first top drive above a second top drive, using either or both top drives.

2. A method for a wellbore operation using a dual top drive system with a first top drive above a second top drive for said rotation, using either or both top drives.

3. The method of claim 2 wherein the wellbore operation is a tubular rotation operation and the tubular is one of casing, tubing, riser, tubular member, pipe, drill pipe, string of tubulars, drill string, quill, shaft, drive shaft and hollow shaft.

4. The method of claim 2 wherein the wellbore operation is one of drilling, casing, casing while drilling, casing drilling, reaming, underreaming, joint make-up, joint breakout, milling, managed pressure drilling, underbalanced drilling, tubular running, tubular running with continuous circulation, controlling bit face orientation during operations with a bit, conducting well operations based on mechanical specific energy considerations, and automatic drilling.

5. The method of claim 2 in which the two top drives move independently of each other.

6. The method of claim 2 wherein in which the two top drives move in unison.

7. The method of claim 2 in which the two top drives each simultaneously rotate a tubular.

8. The method of claim 2 in which the two top drives each alternately rotate a tubular.

9. The method of claim 2 wherein the wellbore operation is a tubular rotation operation and the tubular is a first tubular and the first top drive rotates the first tubular in a first direction and the second top drive holds a second tubular or rotates the second tubular in a second direction opposite to the first direction, e.g. in joint make-up or in joint breakout operations.

10. The method of claim 2 wherein in which the two top drives are movable with respect to each other during operation of one or of both top drives.

11. The method of claim 2 wherein the first top drive is on a first carriage movably connected to a derrick and the second top drive is on a second carriage movably connected to the derrick, the first carriage on a first side of the derrick and the second carriage on the first side of the derrick.

12. The method of claim 2 wherein the first top drive is on a first carriage movably connected to a derrick and the second top drive is on a second carriage movably connected to the derrick and the first carriage on a first side of the derrick and the second carriage on a second side of the derrick opposite the first side.

13. The method of claim 2 wherein at least one of or each of the top drives is pivotably connected to the derrick for movement out of the way of the other top drive.

14. The method of claim 2 wherein the two top drives are controlled by one control system or each top drive has its own dedicated control system.

15. The method of claim 2 wherein using the two top drives stabilizes a tubular during rotation thereof.

16. The method of claim 2 wherein using the two top drives counteracts, in whole or in part, forces applied to a tubular during the operation.

17. The method of claim 2 wherein using the two top drives counteracts, in whole or in part, torque reaction produced by one of the top drives or by both top drives.

18. The method of claim 2 wherein the operation is a joint make-up operation for joining two tubulars and, using the two top drives, the first top drive rotates a first tubular member during joint make-up and the second top drive holds or rotates a second tubular member to be made up with the first tubular.

19. The method of claim 18 wherein the first top drive makes up the joint to shouldering of the joint, and the second top drive then makes up the joint past shouldering.

20. The method of claim 18 wherein the first top drive makes up the joint to a point near shouldering, and the second top drive then makes up the joint to and past shouldering.

21. The method of claim 2 wherein the operation is a tubular rotation operation and one of the top drives is rotating the tubular, then upon sensing a need for added torque in the rotation, the other top drive is selectively activated to provide additional torque for the rotation.

22. The method of claim 2 wherein the operation is a tubular rotation operation and both of the top drives are rotating the tubular, then upon sensing that less torque is sufficient, one of the top drives is selectively deactivates.

23. The method of claim 2 wherein the operation is a tubular rotation operation, and during rotation of a tubular member or members, of a tubular multiple, or of a tubular string, the top drives are activated alternately so that torque is applied above by the first top drive, then below by the second top drive, then above by the first top drive, or vice-versa.

24. The method of claim 23 wherein the operation is joint make-up or joint breakout.

25. The method of claim 2 wherein the operation is a drilling operation with rotation of a drill string and drill bit thereon by the top drives, and wherein the top drives are activated alternately so that torque is applied by the first top drive, then by the second top drive, then by the first top drive, or vice-versa.

26. The method of claim 2 wherein the operation is a drilling operation with rotation of a drill string and drill bit thereon by the top drives, and wherein the top drives are activated alternately so that torque is applied by the first top drive, then by the second top drive, then by the first top drive, or vice-versa.

27. The method of any of claim 2-26 wherein the top drives are relatively close together.

28. The method of any of claim 2-26 wherein the top drives are spaced-apart a selected distance.

29. The method of any of claim 2-26 wherein the position of the top drives with respect to each other changes during the operation.

30. Any and each method according to the present invention disclosed herein.

31. A dual top drive system for a wellbore operation, the dual top drive system with a first top drive above a second top drive.

32. A dual top drive system with a first top drive and a second top drive, both top drives mounted to a derrick for a wellbore operation for rotation of a tubular using either or both top drives.

33. The system of claim 32 wherein the operation is the rotation of a tubular and the tubular is one of casing, tubing, riser, tubular member, drill pipe, string of tubulars, drill string, quill, drive shaft, and hollow shaft.

34. The method of claim 32 wherein the wellbore operation is one of drilling, casing, casing while drilling, casing drilling, reaming, underreaming, joint make-up, joint breakout, milling, managed pressure drilling, underbalanced drilling, tubular running, tubular running with continuous circulation, controlling bit face orientation during operations with a bit, conducting well operations based on mechanical specific energy considerations, and automatic drilling.

35. The system of claim 31 in which two top drives are movable independently of each other.

36. The system of claim 31 wherein in which the two top drives are movable in unison.

37. The system of claim 31 in which the two top drives can each simultaneously rotate the tubular.

38. The system of claim 31 in which the two top drives can each alternately rotate a tubular.

39. The system of claim 31 wherein the wellbore operation is a tubular rotation operation and the first top drive is for rotating a first tubular in a first direction and the second top drive is for holding a second tubular or for rotating the second tubular in a second direction opposite to the first direction, e.g. in joint make-up or in joint breakout operations.

40. The system of claim 31 wherein in which the two top drives are movable with respect to each other during operation of one or of both top drives.

41. The system of claim 31 wherein the first top drive is on a first carriage movably connected to a derrick and the second top drive is on a second carriage movably connected to the derrick, the first carriage on a first side of the derrick and the second carriage on the first side of the derrick.

42. The system of claim 31 wherein the first top drive is on a first carriage movably connected to a derrick and the second top drive is on a second carriage movably connected to the derrick and the first carriage is on a first side of the derrick and the second carriage is on a second side of the derrick opposite the first side.

43. The system of claim 31 wherein at least one of or each of the top drives is pivotably connected to the derrick for movement out of the way of the other top drive.

44. The system of claim 31 wherein the two top drives are controlled by one control system or each top drive has its own dedicated control system.

45. The system of claim 31 wherein the two top drives are operatable to stabilize a tubular during rotation thereof.

46. The system of claim 31 wherein the two top drives are operatable to counteract, in whole or in part, forces applied to a tubular during an operation.

47. The system of claim 31 wherein the two top drives are operatable to counteract, in whole or in part, torque reaction produced by one of the top drives or by both top drives.

48. The system of claim 31 wherein the two top drives are usable in a joint make-up operation for joining two tubulars and, the two top drives are usable so that the first top drive rotates a first tubular member during joint make-up and the second top drive holds or rotates a second tubular member to be made up with the first tubular member.

49. The system of claim 48 wherein the first top drive is able to make up the joint to shouldering of the joint, and the second top drive is able to then make up the joint past shouldering.

50. The system of claim 48 wherein the first top drive can make up the joint to a point near shouldering, and the second top drive can then make up the joint to and past shouldering.

51. The system of claim 31 wherein the system includes sensor apparatus and control apparatus, and the operation is a tubular rotation operation, and one of the top drives can rotate the tubular, and the sensor apparatus can sense a need for added torque in the rotation, and the other top drive is selectively activatable by the control apparatus to provide additional torque for the rotation.

52. The system of claim 31 wherein system includes sensor apparatus and control apparatus, and the operation is a tubular rotation operation, and both of the top drives can rotate the tubular, and the sensor apparatus can sense that less torque is sufficient, and the control apparatus can selectively deactivate one of the top drives.

53. The system of claim 31 wherein the operation is a tubular rotation operation during rotation of a tubular member or members, of a tubular multiple, or of a tubular string, and wherein the top drives are activatable alternately so that torque is applied above by the first top drive, then below by the second top drive, then above by the first top drive, or vice-versa.

54. The system of claim 31 wherein the operation is joint make-up or joint breakout.

55. The system of claim 31 wherein the operation is a drilling operation with rotation of a drill string and drill bit thereon by the top drives, and wherein the top drives are activatable alternately so that torque can be applied by the first top drive, then by the second top drive, then by the first top drive, or vice-versa.

56. The system of claim 31 wherein the operation is a drilling operation with rotation of a drill string and drill bit thereon by the top drives, and wherein the top drives are activatable alternately so that torque can be applied by the first top drive, then by the second top drive, then by the first top drive, or vice-versa.

57. The system of any of claim 31-56 wherein the top drives are relatively close together.

58. The system of any of claim 31-56 wherein the top drives are spaced-apart a selected distance.

59. The system of any of claim 31-56 wherein the position of the top drives with respect to each other is changable during the operation.

60. Any and each dual top drive system according to the present invention disclosed herein.
